(19) United States
(12) Patent Application Publication
(10) Pub. No.: US 2017/0050337 A1
(43) Pub. Date: Feb. 23, 2017

(54) FORMATION APPARATUS, SYSTEMS AND METHODS FOR MANUFACTURING POLYMER DERIVED CERAMIC STRUCTURES

(71) Applicant: MELIOR INNOVATIONS, INC., Houston, TX (US)

(72) Inventors: Andrew R. Hopkins, Sylvania, OH (US); Ashish P. Diwanji, Houston, TX (US)

(73) Assignee: MELIOR INNOVATIONS, INC., Houston, TX (US)

(21) Appl. No.: 15/210,590

(22) Filed: Jul. 14, 2016

Related U.S. Application Data
(63) Continuation-in-part of application No. 15/002,773, filed on Jan. 21, 2016.
Application No. 15/002,773 is a continuation-in-part of application No. 14/268,150, filed on May 2, 2014.
Application No. 14/268,150 is a continuation-in-part of application No. 14/324,056, filed on Jul. 3, 2014.
Application No. 14/324,056 is a continuation-in-part of application No. 14/634,814, filed on Feb. 28, 2015.
(60) Provisional application No. 62/193,046, filed on Jul. 15, 2015.
(60) Provisional application No. 62/279,543, filed on Jan. 15, 2016.
(60) Provisional application No. 62/106,094, filed on Jan. 21, 2015.
(60) Provisional application No. 61/818,906, filed on May 2, 2013.
(60) Provisional application No. 61/818,981, filed on May 3, 2013.
(60) Provisional application No. 61/843,014, filed on Jul. 4, 2013.
(60) Provisional application No. 61/946,598, filed on Feb. 28, 2014.

(51) Int. Cl. B28B 3/26; C04B 35/64; B28B 11/24; C08G 77/00; B28B 11/16; C04B 35/626; C04B 35/63

(52) U.S. Cl. CPC B28B 3/2609; C04B 35/6264; C04B 35/64; C04B 35/63; C08G 77/80; B28B 11/16; B28B 11/24; C04B 2235/48; C04B 2235/483; C04B 2235/6021

(57) ABSTRACT

Hybrid underwater mechanical forming systems for making small volumetric shapes of polymer derived ceramics. The volumetric shapes can be spheres, beads, and fibers. The polymer derived ceramics materials are derived from silicon, oxygen and carbon containing precursors.

This application:
(i) claims under 35 U.S.C. §119(e)(1) the benefit of the filing date of U.S. provisional application Ser. No. 62/193,046, filed Jul. 15, 2015;
(ii) claims under 35 U.S.C. §119(e)(1) the benefit of the filing date of U.S. provisional application Ser. No. 62/279,543 filed Jan. 15, 2016;
(iii) is a continuation-in-part of U.S. patent application Ser. No. 15/002,773 filed Jan. 21, 2016, which claims under 35 U.S.C. §119(e)(1) the benefit of the filing date of Jan. 21, 2015 of U.S. provisional application Ser. No. 62/106,094;
(iv) is a continuation-in-part of U.S. patent application Ser. No. 14/268,150 filed May 2, 2014, which claims, under 35 U.S.C. §119(e)(1), the benefit of the filing date of May 2, 2013 of U.S. provisional application Ser. No. 61/818,906 and the benefit of the filing date of May 3, 2013 of U.S. provisional application Ser. No. 61/818,981;
(v) is a continuation-in-part of U.S. patent application Ser. No. 14/324,056 filed Jul. 3, 2014, which claims under 35 U.S.C. §119(e)(1) the benefit of the filing date of Jul. 4, 2013 of U.S. provisional application Ser. No. 61/843,014; and,
(vi) is a continuation-in-part U.S. patent application Ser. No. 14/634,814 filed Feb. 28, 2015, which claims under 35 U.S.C. §119(e)(1) the benefit of the filing date of Feb. 28, 2014 of U.S. provisional application Ser. No. 61/946,598;

the entire disclosures of each of which are incorporated herein by reference.

### BACKGROUND OF THE INVENTION

### Field of the Invention

The present inventions relate to methods and systems for manufacturing polymeric derived ceramic materials in small volumetric shapes.

Polymer derived ceramics (PDC) are ceramic materials that are derived from, e.g., obtained by, the pyrolysis of polymeric materials. These materials are typically in a solid or semi-solid state that is obtained by curing an initial liquid polymeric precursor, e.g., PDC precursor, PDC precursor formulation, precursor batch, and precursor. The cured, but unpyrolized, polymer derived material can be referred to as a preform, a PDC preform, the cured material, and similar such terms. Polymer derived ceramics may be derived from many different kinds of precursor formulations, e.g., starting materials, starting formulations. PDCs may be made of, or derived from, carbosilane or polycarbosilane (Si—C), silane or polysilane (Si—Si), silazane or polysilazane (Si—N—Si), silicon carbide (SiC), carbosilazane or polycarbosilazane (Si—N—Si—C—Si), siloxane or polysiloxanes (Si—O), to name a few.

A preferred PDC is “polysilocarb”, e.g., material containing silicon (Si), oxygen (O) and carbon (C). Polysilocarb materials may also contain other elements. Polysilocarb materials can be made from one or more polysilocarb precursor formulation or precursor formulation. The polysilocarb precursor formulations can contain, for example, one or more functionalized silicon polymers, other polymers, non-silicon based cross linking agents, monomers, as well as, potentially other ingredients, such as for example, inhibitors, catalysts, initiators, modifiers, dopants, fillers, reinforcers and combinations and variations of these and other materials and additives. Silicon oxycarbide materials, SiOC compositions, and similar such terms, unless specifically stated otherwise, refer to polysilocarb materials, and would include liquid materials, solid uncured materials, cured materials, and ceramic materials.

Examples of PDCs, PDC formulations and starting materials, are found in US Patent Application Publication Nos. 2014/0343220, 2014/0274658, 2014/0326453, 2015/0027306, 2015/0175750, Ser. Nos. 62/055,397 and 62/106,094, as well as, US Patent Publication Nos. 2008/0095942, 2008/0093185, 2007/0292690, 2006/0230476, 2006/0069176, 2006/0004169, and 2005/0276961, and U.S. Pat. Nos. 5,153,295, 4,657,991, 7,714,092, 7,087,656 and 8,742,008, and 8,119,057, the entire disclosures of each of which are incorporated herein by reference.

Generally, the term “about” as used herein, unless specified otherwise, is meant to encompass a variance or range of ±10%, the experimental or instrument error associated with obtaining the stated value, and preferably the larger of these.

As used herein, unless specified otherwise the terms %, weight % and mass % are used interchangeably and refer to the weight of a first component as a percentage of the weight of the total, e.g., formulation, mixture, material or product. As used herein, unless specified otherwise “volume %” and “% volume” and similar such terms refer to the volume of a first component as a percentage of the volume of the total, e.g., formulation, material or product.

This Background of the Invention section is intended to introduce various aspects of the art, which may be associated with embodiments of the present inventions. Thus the forgoing discussion in this section provides a framework for better understanding the present inventions, and is not to be viewed as an admission of prior art.

### SUMMARY

Accordingly, there has been a long-standing and increasing need for small polymer derived ceramics and solids, methods of making these volumetric structures, and in particular methods of making predetermined shapes and volumes of these structures. The present inventions, among other things, solve these needs by providing the articles of manufacture, devices and processes taught, disclosed and claimed herein.

Thus, there is provided a hybrid fluid mechanical forming system for making small volumetric cured structures from a polymer derived ceramic precursor, the system having: a polymer derived ceramic precursor delivery apparatus, the delivery apparatus having a delivery in-feed, the delivery in-fluid in fluid communication with a delivery port; wherein the delivery in-feed and the delivery port contain a liquid polymer derived ceramic precursor; a formation head, the formation head having a die assembly and a forming chamber; the forming chamber defining a forming and curing cavity; the die assembly having a channel and a nozzle; the channel defining a inlet opening and a forming opening; the inlet opening in fluid communication with the delivery port; the nozzle in fluid communication with the channel forming opening and the forming and curing cavity; the forming and curing cavity containing a forming fluid; wherein the liquid polymer derived ceramic precursor is contained in the inlet opening, the die assembly channel, the forming opening, and the nozzle; and, the forming fluid contacting liquid polymer derived ceramic and containing a volumetric shape of cured polymer derived ceramic precursor.

There is provided a hybrid fluid mechanical system where the volumetric shapes are formed underwater, and thus the system is a hybrid under-liquid mechanical forming system; and when water is the liquid, the system would be a hybrid underwater mechanical forming system. In an embodiment, the extrusion, and the cutters, and cutting, are located and take place under a liquid, e.g., water.

There is further provided the systems and methods having one or more of the following features: wherein the liquid precursor in the nozzle is partially cured; wherein the die assembly has a plurality of channels and nozzles; wherein the die assembly has at least 100 channels and nozzles; wherein the forming fluid has water; wherein the forming fluid essentially consist of water; wherein the liquid polymer derived ceramic precursor has about 30 weight % to about 60 weight % silicon, from about 5 weight % to about 40 weight % oxygen, and from about 3 weight % to about 35 weight % carbon; wherein the liquid polymer derived ceramic precursor has at least one precursor selected from the group consisting of methyl terminated vinyl polysiloxane, vinyl terminated vinyl polysiloxane, hydride terminated vinyl polysiloxane, vinyl terminated dimethyl polysiloxane, hydroxy terminated dimethyl polysiloxane, phenyl terminated dimethyl polysiloxane, methyl terminated phenylethyl polysiloxane, and tetravinyl cyclosiloxanes; wherein the liquid polymer derived ceramic precursor is a reaction type formulation, wherein the formulation has at least one precursor selected from the group consisting of Phenyltriethoxysilane, Phenylmethyldiethoxysilane, Methyldiethoxysilane, Vinylmethyldiethoxysilane, Trimethyethoxysilane Triethoxysilane, and TES 4; wherein the liquid polymer derived ceramic precursor is a reaction blending type formulation, wherein the formulation has at least one precursor selected from the group consisting of methylhydrogen fluid and DCPD; wherein the liquid polymer derived ceramic precursor is a reaction type formulation; wherein the liquid polymer derived ceramic precursor is a mixing type formulation; wherein the liquid polymer derived ceramic precursor is a reaction blending type formulation; having a cutting assembly; having a plurality of volumetric shapes of cured polymer derived ceramic precursor; wherein the plurality of volumetric shapes are cured to at least 20% of a hard cure; wherein the plurality of volumetric shapes are hard cured; wherein the plurality of volumetric shapes are final cured; having a planar die face, wherein the nozzle is positioned in and opens through the die face; wherein the cutter assembly has a plurality of cutter blades and a cutter force control unit, whereby the location of the cutters with respect to the die face can be predetermined and controlled; wherein the plurality of volumetric shapes are cured to at least 20% of a hard cure; wherein the plurality of volumetric shapes are hard cured; wherein the plurality of volumetric shapes are final cured; wherein the liquid polymer derived ceramic precursor is a reaction blending type formulation, wherein the formulation has at least one precursor selected from the group consisting of methylhydrogen fluid and DCPD; wherein the liquid polymer derived ceramic precursor is a reaction type formulation; wherein the liquid polymer derived ceramic precursor is a mixing type formulation; and, wherein the liquid polymer derived ceramic precursor is a reaction blending type formulation.

Additionally there is provided a hybrid fluid mechanical forming system for making small volumetric cured structures from a polymer derived ceramic precursor, the system having: a polymer derived ceramic precursor delivery apparatus, the delivery apparatus having a delivery in-feed, the delivery in-fluid in fluid communication with a delivery port; wherein the delivery in-feed and the delivery port contain a liquid polymer derived ceramic precursor; the liquid polymer derived ceramic has a first viscosity; a formation head, the formation head having a die assembly and a forming chamber; the forming chamber defining a forming and curing cavity; the die assembly having a channel and a nozzle; the channel defining a inlet opening and a forming opening; the inlet opening in fluid communication with the delivery port; the nozzle in fluid communication with the channel forming opening and the forming and curing cavity; the forming and curing cavity containing a forming fluid; wherein the liquid polymer derived ceramic precursor is contained in the inlet opening, the die assembly channel, the forming opening, and the nozzle; wherein the liquid polymer derived ceramic precursor in the die assembly channel has a second viscosity; and, the forming fluid contacting an extending portion of the liquid polymer derived ceramic precursor extending from and continuous with the liquid polymer derived ceramic in the nozzle; and the forming fluid containing a volumetric shape of cured polymer derived ceramic precursor; whereby the extending portion of the liquid polymer derived ceramic precursor has a third viscosity; wherein, the third viscosity is greater than the second viscosity; wherein the second viscosity is greater than the first viscosity; wherein the second viscosity is greater than the first viscosity; wherein the liquid polymer derived ceramic precursor has a catalyst; wherein the liquid polymer derived ceramic precursor has a catalyst; wherein the liquid polymer derived ceramic precursor has a catalyst; wherein the liquid polymer derived ceramic precursor is selected from the group consisting of a reaction type formulation, a mixing type formulation, and a reaction blending type formulation.

Yet further there is provide a hybrid underwater mechanical forming system for making small volumetric cured structures from a polymer derived ceramic precursor, the system having: a delivery apparatus, the delivery apparatus having a liquid polymer derived ceramic precursor, wherein the liquid polymer derived ceramic precursor consists essentially of carbon, silicon and; a die assembly and a curing chamber; the curing chamber defining a curing cavity; the die assembly having a channel and a nozzle; the channel defining a inlet opening and a outlet opening; the inlet opening in fluid communication with the delivery apparatus; the nozzle in fluid communication with the outlet opening and the curing cavity; the curing cavity containing a curing fluid; wherein the liquid polymer derived ceramic precursor is contained in the inlet opening, the die assembly channel, the outlet opening, and the nozzle; and, the forming fluid contacting an extending portion of the liquid polymer derived ceramic precursor extending from and continuous with the liquid polymer derived ceramic in the nozzle; and the forming fluid containing a volumetric shape of cured polymer derived ceramic precursor.

There is further provided the systems and methods having one or more of the following features: wherein the volumetric shape is selected from the group consisting of hollow spheres, blocks, sheets, coatings, balls, and squares; wherein the volumetric shape is selected from the group consisting of spheres, prolate spheroids, ellipsoids, spheroids, films, skins, and particulates; and wherein the volumetric shape is a proppant; and, wherein the volumetric shape is a fiber.

Moreover there is provided a fiber forming system for making fibers from a polymer derived ceramic precursor, the system having: a polymer derived ceramic delivery apparatus, the apparatus having a liquid polymer derived ceramic precursor, a chamber and a port, wherein the chamber is capable of holding a liquid polymer derived ceramic precursor for delivery by the port into fiber having a predetermined diameter; a precursor solidifying apparatus, the solidifying apparatus having: a cavity; a temperature control apparatus; wherein the cavity is maintained at a predetermined temperature sufficient to cure the polymer derived ceramic precursor fiber to form a preform; the cavity have sufficient depth that the fibers break into sections; and, the port in fluid communication with the cavity; whereby, the system is capable of forming and curing the liquid polymer derived ceramic precursor into fibers.

Furthermore there is provide an extrusion system, preferably an under-liquid and more preferably an underwater system, for making elongate volumetric structures from a polymer derived ceramic precursor material, the system having: a polymer derived ceramic delivery apparatus, the apparatus having a first chamber in fluid communication with a delivery port, and an amount of a liquid polymer derived ceramic precursor; a forming and curing apparatus, the forming and curing apparatus having a forming chamber having an opening; and the chamber defining a cavity, wherein the cavity is in fluid communication with the chamber opening and contains an elongate volumetric shape of a polymer derived ceramic precursor, the chamber having water; the chamber opening in fluid communication with the delivery port; a temperature control source thermally associated with the forming apparatus; wherein the cavity is maintained at a predetermined temperature sufficient to cure the elongate volumetric shape of the polymer derived ceramic precursor; and, whereby, the system is capable of providing a liquid polymer derived ceramic precursor material into the cavity in a predetermined elongate volumetric shape, and wherein the polymer derived ceramic precursor material is cured in the cavity.

Additionally there is provided a hybrid underwater mechanical forming system for making small volumetric structures from a polymer derived ceramic precursor, the system having: a polymer derived ceramic precursor delivery apparatus, the apparatus having a chamber in fluid communication with a delivery port; wherein the chamber is capable of delivering a liquid polymer derived ceramic precursor; a forming apparatus, the forming apparatus having a forming chamber having an opening; the chamber defining a cavity; wherein the cavity is in fluid communication with the chamber opening; the chamber opening in fluid communication with the delivery port; whereby the system is capable of delivering the liquid polymer derived ceramic from the delivery port to the cavity as a liquid; a temperature control apparatus thermally associated with the forming apparatus; wherein the cavity is capable of being maintained at a predetermined temperature; a die assembly; a cutter assembly; and, whereby, the system is capable of providing a liquid polymer derived ceramic precursor to the cavity in a predetermined volumetric shape; and wherein the system is capable of curing the polymer derived ceramic precursor in the cavity.

Moreover there is provided a system for making small volumetric structures from a polymer derived ceramic precursor, the system having: a liquid holding receptacle; the liquid holding receptacle containing a forming liquid; a precursor delivery apparatus, having a precursor, a channel, and a delivery port, the channel in fluid communication with the delivery port, whereby the precursor can be delivered from the delivery port; and, the delivery port in fluid communication with the liquid holding receptacle.

Further there is provided a method for making small volumetric structures from a polymer derived ceramic precursor, the method having: providing a liquid polymer derived ceramic precursor to a delivery apparatus, the apparatus having a chamber in fluid communication with a delivery port; forming the liquid precursor into a predetermined liquid volumetric shape; and delivering the liquid volumetric shape to a chamber defining a cavity, the cavity having a forming fluid; and, curing the liquid volumetric shape in the cavity to form a polymer derived ceramic preform.

There are still further provided the systems and methods having one or more of the following features: wherein the preform is the same shape as the volumetric shape; wherein the preform is substantially the same shape as the volumetric shape; wherein the preform is green cured; wherein the preform is hard cured; wherein the preform is final cured; and pyrolizing the preform to form a ceramic.

In addition there is provided a method for making small volumetric structures from a polymer derived ceramic precursor, the method having: a step for forming a small volumetric shaped structure of polymer derived ceramic precursor by extrusion from a die face into a forming fluid; a step for cutting the polymer derived ceramic precursor at the die face to thereby form an initial shaped volumetric structure; and, a step for curing the initial shaped volumetric structure.

Moreover there are provided the systems and methods having one or more of the following features: wherein the die face is in the forming fluid; whereby the extrusion is directly into the forming fluid, without exposure to air; wherein a plurality of initial shapes are made; wherein the initial shaped volumetric structure is hard cured; wherein the initial shaped volumetric structure is green cured; and, wherein the forming fluid is water; wherein the forming fluid has water.

Yet further there is provided a method for making small volumetric structures from a polymer derived ceramic precursor, the method having: a step for forming an elongate volumetric shaped structure of polymer derived ceramic precursor by extrusion from a die face into a forming fluid; a step for curing the elongate structure; and, a step for sectioning the cured elongate structure.

Moreover there are provided the methods and systems having one or more of the following features: wherein the section occurs by the weight of the elongate structure causing breakage; wherein the volumetric shape has a volume of less than about 0.25 inch³; wherein the volumetric shape has a volume of less than about 500 mm³; wherein the volumetric shape has a volume of less than about 100 mm³; wherein the volumetric shape has a volume of less than about 4,000 microns³; wherein the volumetric shape has a volume of less than about 50 microns³; and, wherein the volumetric shape has a volume of less than about 10 microns³.

There is further provided an fluid pelletizing system, preferably an under-liquid system and more preferably an underwater system, for making volumetric structures from a polymer derived ceramic precursor, the system having: a polymer derived ceramic delivery apparatus, the apparatus having a liquid polymer derived ceramic precursor, a chamber and a port, wherein the chamber is capable of holding a liquid polymer derived ceramic precursor for delivery by the port into a volumetric shape having a predetermined volume; a precursor solidifying apparatus, the solidifying apparatus having: a cavity; a temperature control apparatus; wherein the cavity is maintained at a predetermined temperature sufficient to cure the volumetric shape of polymer derived ceramic precursor to form a preform; a forming and cutting head having a fluid cavity; and the port in fluid communication with the cavity; whereby, the system is capable of forming and curing the liquid polymer derived ceramic precursor into a predetermined volumetric shape structure.

Yet additionally there is provided an extrusion system, preferably an under-liquid system and more preferably an underwater system, for making volumetric structures from a polymer derived ceramic precursor material, the system having: a polymer derived ceramic delivery apparatus, the apparatus having a first chamber in fluid communication with a delivery port, and an amount of a liquid polymer derived ceramic precursor; a forming and curing apparatus, the forming and curing apparatus having a forming chamber having an opening; and the chamber defining a cavity, wherein the cavity is in fluid communication with the chamber opening and contains a volumetric shape of a polymer derived ceramic precursor, the chamber having flowing water; the chamber opening in fluid communication with the delivery port; a temperature control source thermally associated with the forming apparatus; wherein the cavity is maintained at a predetermined temperature sufficient to cure the volumetric shape of the polymer derived ceramic precursor; and, whereby, the system is capable of providing a liquid polymer derived ceramic precursor material into the cavity in a predetermined volumetric shape, and wherein the polymer derived ceramic precursor material is cured in the cavity.

There is further provided the systems and methods having one or more of the following features: wherein the liquid polymer derived ceramic precursor is selected from the group consisting of silanes, polysilanes, silazanes, polysilazanes, carbosilanes, polycarbosilanes, siloxanes, and polysiloxanes; wherein the liquid polymer derived ceramic precursor is a polysilocarb; wherein the liquid polymer derived ceramic precursor is a neat polysilocarb; wherein the liquid polymer derived ceramic precursor has a polysilocarb and contains hydride groups; wherein the liquid polymer derived ceramic precursor has a polysilocarb, is solvent free, and contains hydride groups; wherein the liquid polymer derived ceramic precursor has a polysilocarb and contains vinyl groups; and wherein the liquid polymer derived ceramic precursor has a polysilocarb having hydride and vinyl groups and wherein the molar ratio of hydride groups to vinyl groups is about 1.50 to 1.

Still further there is provided a system for making small volumetric structures from a polymer derived ceramic precursor, the system having: a polymer derived ceramic delivery apparatus, the apparatus having a first chamber in fluid communication with a delivery port; wherein the first chamber is capable of holding a liquid polymer derived ceramic precursor; a means for forming a volumetric shaped structure, the forming means having a forming chamber having an opening; and the chamber defining a cavity, wherein the cavity is in fluid communication with the chamber opening; the chamber opening in fluid communication with the delivery port, whereby the system is capable of delivering the liquid polymer derived ceramic from the delivery port into the cavity, as a liquid; a temperature control source thermally associated with the forming apparatus, wherein the cavity is maintained at a predetermined temperature; and, whereby, the system is capable of providing a liquid polymer derived ceramic precursor material into the cavity in a predetermined volumetric shape, and wherein the polymer derived ceramic precursor material is cured in the cavity.

Additionally there is provided a system for making small volumetric structures from a polymer derived ceramic precursor, the system having: a means for delivering a liquid polymer derived ceramic; a means for forming a volumetric shaped structure, the forming means having a forming chamber having an opening; and the chamber defining a cavity, wherein the cavity is in fluid communication with the chamber opening; the chamber opening in fluid communication with the delivery port, whereby the system is capable of delivering the liquid polymer derived ceramic from the delivery port into the cavity, as a liquid; a temperature control source thermally associated with the forming apparatus, wherein the cavity is maintained at a predetermined temperature; and, whereby, the system is capable of providing a liquid polymer derived ceramic precursor material into the cavity in a predetermined volumetric shape, and wherein the polymer derived ceramic precursor material is cured in the cavity.

Moreover there is provided a system for making small volumetric structures from a polymer derived ceramic precursor, the system having: a means for forming a small volumetric shaped structure of polymer derived ceramic precursor; and, a means for curing the small volumetric shaped structure of polymer derived ceramic precursor material into a volumetric shaped preform.

Furthermore there is provide a system for making small volumetric structures from a polymer derived ceramic precursor, the system having: a means for forming a small volumetric shaped structure of polymer derived ceramic precursor; a means for curing the small volumetric shaped structure of polymer derived ceramic precursor material into a volumetric shaped preform; and, a means for pyrolizing the preform.

In addition there is provided a system for making small volumetric structures from a polymer derived ceramic precursor, the system having: a liquid holding receptacle; the liquid holding receptacle containing a forming liquid; a precursor delivery apparatus, having a precursor, a channel, and a delivery port, the channel in fluid communication with the delivery port, whereby the precursor can be delivered from the delivery port; and, the delivery port in fluid communication with the liquid holding receptacle.

There is further provided a method for making small volumetric structures from a polymer derived ceramic precursor, the method having: providing a liquid polymer derived ceramic precursor to a delivery apparatus, the apparatus having a chamber in fluid communication with a delivery port; forming the liquid precursor into a predetermined liquid volumetric shape; and delivering the liquid volumetric shape to a chamber defining a cavity; and, curing the liquid volumetric shape in the cavity to form a polymer derived ceramic preform.

Still additionally there is provides a method for making small volumetric structures from a polymer derived ceramic precursor, the system having: a step for forming a liquid polymer derived ceramic to a liquid predetermined volumetric shape; and, a step for curing the liquid predetermined volumetric shape into a preform having essentially the same volumetric shape.

Furthermore there is provided a method for making small volumetric structures from a polymer derived ceramic precursor, the system having: a step for forming a small volumetric shaped structure of polymer derived ceramic precursor by extrusion into a water bath and then cutting the extruded member into an initial shape; a step for curing the small volumetric shaped structure of polymer derived ceramic precursor material in a flowing channel in a die to form an initial volumetric shaped preform; cutting the initial volumetric shaped preform from the die face; further curing and shaping the preform in a water bath; and, a step for pyrolizing the preform.

Still additionally there is provided a method for making small volumetric structures from a polymer derived ceramic precursor, the system having: forming a neat small volumetric shaped structure of polymer derived ceramic precursor; curing the neat small volumetric shaped structure of polymer derived ceramic precursor material into a volumetric shaped preform; and, pyrolizing the preform.

Furthermore there is provided a method for making small volumetric structures from a polymer derived ceramic precursor, the system having: providing a polymer derived ceramic precursor to a liquid holding receptacle; the liquid holding receptacle containing a forming liquid; the precursor forming essentially upon contact with the forming liquid a predetermined volumetric shape; and curing the volumetric shape to form a preform.

Still moreover there is provided the methods and systems having one or more of the following features: wherein the volumetric shape is a bead; pyrolizing the preform; wherein the volumetric shape is a sphere and pyrolizing the sphere.

Yet furthermore there is provided a method for making small volumetric shaped polysilocarb preform, the method including initially curing a polysilocarb formulation as it is flowing through a chancel in a die; the initially cured preform being extruded into a liquid bath, the extruded preform being cut off adjacent to the die face, and the liquid bath continuing to cure the preform.

There is still additionally provided the methods and systems having one or more of the following features: wherein the liquid bath shapes the preform; wherein the liquid polymer derived ceramic precursor is selected from the group consisting of silanes, polysilanes, silazanes, polysilazanes, carbosilanes, polycarbosilanes, siloxanes, and polysiloxanes; wherein the liquid polymer derived ceramic precursor is a polysilocarb; wherein the liquid polymer derived ceramic precursor is a neat polysilocarb; wherein the liquid polymer derived ceramic precursor is a reinforced polysilocarb; wherein the liquid polymer derived ceramic precursor is a polysilocarb; wherein the liquid polymer derived ceramic precursor has a polysilocarb and contains hydride groups; wherein the liquid polymer derived ceramic precursor has a polysilocarb, is solvent free, and contains hydride groups; wherein the liquid polymer derived ceramic precursor has a polysilocarb and contains vinyl groups; wherein the liquid polymer derived ceramic precursor has a polysilocarb, is solvent free, and contains vinyl groups; wherein the liquid polymer derived ceramic precursor has a polysilocarb and contains vinyl groups and hydride groups; wherein the liquid polymer derived ceramic precursor has a polysilocarb having hydride and vinyl groups and wherein the molar ratio of hydride groups to vinyl groups is about 1.50 to 1; wherein the liquid polymer derived ceramic precursor has a polysilocarb having hydride and vinyl groups and wherein the molar ratio of hydride groups to vinyl groups is about 3.93 to 1; wherein the liquid polymer derived ceramic precursor has a polysilocarb having hydride and vinyl groups and wherein the molar ratio of hydride groups to vinyl groups is about 0.08 to 1 to about 24.00 to 1; wherein the liquid polymer derived ceramic precursor has a polysilocarb having hydride and vinyl groups and wherein the molar ratio of hydride groups to vinyl groups is about 0.08 to 1 to about 1.82 to 1; wherein the molar ratio of hydride groups to vinyl groups is about 1.12 to 1 to about 2.36 to 1; wherein the molar ratio of hydride groups to vinyl groups is about 1.75 to 1 to about 23.02 to 1; and, wherein the liquid polymer derived ceramic precursor has a polysilocarb having hydride and vinyl groups and wherein the molar ratio of hydride groups to vinyl groups is about 1.26 to 1 to about 4.97 to 1.

There is still additionally provided the methods and systems having one or more of the following features: wherein the cavity has a forming liquid; wherein the cavity has a forming liquid consisting essentially of water and a surfactant; wherein the cavity has a forming liquid and a mixer; wherein the cavity is an extruder cavity; wherein the cure is conducted with a predetermined cure temperature profile; and, wherein the cure is conducted with a predetermined cure temperature profile having a first heating rate, a first hold time, a second heating rate and a second hold time.

Moreover, there is provided a system for making small volumetric structures from a polymer derived ceramic precursor, the system having: a means for forming a small volumetric shaped structure of polymer derived ceramic precursor; a means for curing the small volumetric shaped structure of polymer derived ceramic precursor material into a volumetric shaped preform; and, a means for pyrolizing the preform.

Still additionally there is provided a system for making small volumetric structures from a polymer derived ceramic precursor, the system having: a liquid holding receptacle; the liquid holding receptacle containing a forming liquid; a precursor delivery apparatus, having a precursor, a channel, and a delivery port, the channel in fluid communication with the delivery port, whereby the precursor can be delivered from the delivery port; and, the delivery port in fluid communication with the liquid holding receptacle.

Moreover there is provided a method for making small volumetric structures from a polymer derived ceramic precursor, the method having: providing a liquid polymer derived ceramic precursor to a delivery apparatus, the apparatus having a chamber in fluid communication with a delivery port; forming the liquid precursor into a predetermined liquid volumetric shape; and delivering the liquid volumetric shape to a chamber defining a cavity; and, curing the liquid volumetric shape in the cavity to form a polymer derived ceramic preform.

### BRIEF DESCRIPTION OF THE DRAWINGS

FIG. 1 is a perspective view of an embodiment of a PDC forming system in accordance with the present inventions.

FIG. 2 is a cross section view of an embodiment of a PDC forming system in accordance with the present inventions.

FIGS. 3A to 3D are sequential illustrations of an embodiment of a process for PDC forming in accordance with the present inventions.

FIG. 4 is a cross sectional view of an embodiment of a PDC forming system for forming fibers in accordance with the present inventions.

FIG. 5 is a cross sectional view of a forming apparatus for performing a process for PDC forming in accordance with the present inventions

FIG. 5A is plan view of the cutter assembly of the embodiment of FIG. 5.

FIG. 5B is a cross sectional view taken along line 5B-5B of FIG. 5A.

FIG. 5C is a cross sectional view taken along line 5C-5C of FIG. 5A.

FIG. 5D is a perspective exploded view of the cutter assembly of the embodiment of FIG. 5.

FIG. 6, is a cross sectional view of a forming apparatus for performing a process for PDC forming in accordance with the present inventions. FIG. 6 is a cross sectional view taken along line 6-6 of FIG. 6B.

FIG. 6A is a cross sectional view taken along line 6A-6A of FIG. 6.

FIG. 6B is a phantom line plan view of components of the apparatus of FIG. 6.

FIG. 6C is a cross sectional view of components of the apparatus of FIG. 6.

FIG. 7 is a cross sectional view of a forming apparatus for performing a process for PDC forming in accordance with the present inventions.

FIG. 7A is a cross sectional view taken along line 7A-7A of FIG. 7.

FIG. 7B is a cross sectional view taken along line 7B-7B of FIG. 7.

FIG. 7C is a detailed cross sectional view of a component of the embodiment of FIG. 7.

FIG. 8 is a perspective cross sectional view of a forming apparatus for performing a process for PDC forming in accordance with the present inventions.

FIG. 8A is a phantom line cross sectional view of the embodiment of FIG. 8.

FIG. 8B is a cross sectional view of components of the embodiment of FIG. 8.

FIG. 8C is a cross sectional view taken along line 8C-8C of FIG. 8B.

FIG. 8D is a plan view of components of the embodiment of FIG. 8.

FIG. 8E is a phantom line plan view of components of the embodiment of FIG. 8.

FIG. 8F is a phantom line plan view of components of the embodiment of FIG. 8.

FIG. 9 is a schematic view of an embodiment of a solution formation system and process in accordance with the present inventions.

FIG. 10 is a schematic view of an embodiment of a solution formation system and process in accordance with the present inventions.

FIG. 11 is a perspective view of an embodiment of a solution forming system and process in accordance with the present inventions.

FIG. 12 is a process flow diagram of an embodiment of solution forming system and processes in accordance with the present inventions.

### DESCRIPTION OF THE PREFERRED EMBODIMENTS

In general, the present inventions relate to methods, systems, apparatus, and process for making small volumetric shapes from PDC precursors, and to provide small volumetric shaped PDC preforms and polymer derived ceramics. In particular, among other things, embodiments of the present inventions make small shapes from PDC precursors with, good, high, and exceeding high uniformity and reproducibility. Embodiments of the present inventions, among other things, make volumetric shapes of PDC precursors, PDC preforms, and polymer derived ceramics, at high rates of production, in large quantities, and with long run times.

In general the volumetric shapes made by embodiments of the present invention are small, e.g., having cross sections from about 2 inches to 0.01 microns, of less than about 1 inch, less than about ¾ inch, less than about ⅓ inch, less than about 5,000 microns, less than about 4,000 microns, less than about 2,000 microns, less than about 1,000 microns, less than about 500 microns, less than about 100 microns, less than about 10 microns, less than about 1 micron, less than about 0.5 microns and about 0.1 micron. The volumetric shapes may have volumes of from about 4.25 inch³ to about 0.0004 microns³, of less than about 0.25 inch³, of less than about 525 mm³, of less than about 100 mm³, of less than about 50 mm³, of less than about 4,000 microns³, of less than about 2,000 microns³, of less than about 100 microns³, of less than about 50 microns³, of less than about 0.5 microns³ and of less than about 0.00005 microns³. The small volumetric shapes, made by embodiments of the present inventions, may individually weight, less than about 30 grams, less than about 15 grams, less than about 10 grams, less than about 1 gram, less than about 0.5 grams, less than about 0.1 grams, and less than about 0.01 grams, less than about 0.0001 grams, less than about 0.00001 grams, less then about 10⁻⁸ g, less than about 10⁻¹⁰ g, and less than about 10⁻¹⁵ g. The small volumetric shapes, made by embodiments of the present inventions, may be substantially uniform, they may be entirely random, they may be within a predetermined range, for one of more physical property, e.g., shape, size, weight, roughness, density, porosity, strength, electrical, conductivity, optical, thermodynamic, ionic, etc., and combinations and variations of these.

The volumetric shapes may be any shape, including for example, spheres, pellets, rings, lenses, disks, panels, cones, frustoconical shapes, squares, rectangles, trusses, angles, channels, hollow sealed chambers, hollow spheres, blocks, sheets, coatings, balls, squares, prolate spheroids, ellipsoids, spheroids, eggs, cones, multifaceted structures, films, skins, particulates, beams, rods, angles, columns, fibers, staple fibers, tubes, cups, pipes, polyhedrons (e.g., octahedron, dodecahedron, icosidodecahedron, rhombic triacontahedron, and prism), and combinations and various of these and other more complex shapes, both engineering and architectural.

Generally, the polymer derived ceramics and their cured preforms may be any volumetric shape, and preferably are any predetermined volumetric shape. The cured preforms may be the same shape, or a different volumetric shape, from the ceramics. Thus, a precursor batch may be shaped into, for example, balls, spheres, squares, prolate spheroids, ellipsoids, spheroids, eggs, cones, rods, boxes, multifaceted structures, and polyhedrons (e.g., octahedron, dodecahedron, icosidodecahedron, rhombic triacontahedron, and prism), as well as, other such structures for, or upon, curing, and pyrolysis. The polymeric derived ceramics may be made into the shape of any particle, that is used as, or suggested to be used as, for example, a pigment, an additive, an abrasive, a filler, and an hydraulic fracturing proppant. Spherical type structures are examples of a presently preferred shape for proppants.

Sphere and spherical shall mean, and include unless expressly stated otherwise, any structure that has at least about 90% of its total volume within a “perfect sphere,” i.e., all points along the surface of the structure have radii of equal distance. An essentially perfect sphere has at least about 98% of its total volume within a perfect sphere. A substantially perfect sphere has at least about 95% of its total volume within a perfect sphere.

This terminology, “known shape”—90% perfect, “substantially perfect shape”—95% of the perfect shape, and “essentially perfect”—98% of the perfect shape, is applicable to other know, defined, geometric shapes (and will be used herein unless stated otherwise). Thus, a “known geometric shape”, e.g., a “cube,” means that at least about 90% of the total volume of the shape is within the perfect known, defined, geometric shape, e.g., for a cube—six sides of equal length, width and height, all connecting at right angles. A “substantially perfect shape,” e.g., a “substantially perfect cube” is at least 95% within the shape of a perfect cube, and an “essentially perfect shape”, e.g., an “essentially perfect cube” is at least 95% within the shape of a perfect cube.

Embodiments of the systems, apparatus and methods provide the ability to make highly random sized particles of the same type, e.g., all shapes are substantially perfect spheres but have random and varied volumes, to make highly random shapes with high random particle sizes, e.g., many different shapes with varied volumes, and combinations and variations of these.

Embodiments of the systems, apparatus and methods, preferably provide the ability to make highly uniform shapes, as to type, as to volume and both. Thus, for example, embodiments of the process produce spheres that are within at least 90% of the targeted size, at least 95% of the targeted size, and at least 99% of the targeted size, or more. For example, embodiments of the process can produce spherical beads, spherical type beads, essentially perfect spherical beads, and substantially perfect spherical beads, each of which can have at least about 90% of their size within a 10 mesh range, at least about 95% of their size within a 10 mesh range, at least about 98% of their size within a 10 mesh range, and at least about 99% of their size within a 10 mesh range. Further, and for example, the process can produce spherical beads, spherical type beads, essentially perfect spherical beads, and substantially perfect spherical beads, each of which can have at least about 90% of their size within a 5 mesh range, at least about 95% of their size within a 5 mesh range, at least about 98% of their size within a 5 mesh range, and at least about 99% of their size within a 5 mesh range. Preferably, these levels of uniformity in the production of the volumetric shapes, both the ceramic and cured preform, is obtained without the need for filtering, sorting or screening the cured shapes, and without the need for filtering, sorting or screening the pyrolized shapes. In addition to having the ability to tightly control size distribution, embodiments of the present processes provide the ability to make a large number of highly uniform predetermined shapes, e.g., at least about 90%, at least about 95% and at least about 99% of the shapes produced meet the targeted or predetermined shape. For example, at least about 98% of the beads, e.g., proppants, made from a precursor batch can be essentially spherical.

Generally, the precursor formulation is initially a liquid, or if not, it is liquefied. This liquid precursor formulation is then cured to form a solid or semi-sold material, e.g., a plastic, which is also called the preform or cured preform. The preform is then pyrolized into a ceramic.

It should be understood that the use of headings in this specification is for the purpose of clarity, reference, and is not limiting in any way. Thus, the processes compositions, and disclosures described under a heading should be read in context with the entirely of this specification, including the various examples. The use of headings in this specification should not limit the scope of protection afford the present inventions.

Hybrid Fluid/Mechanical Forming Systems

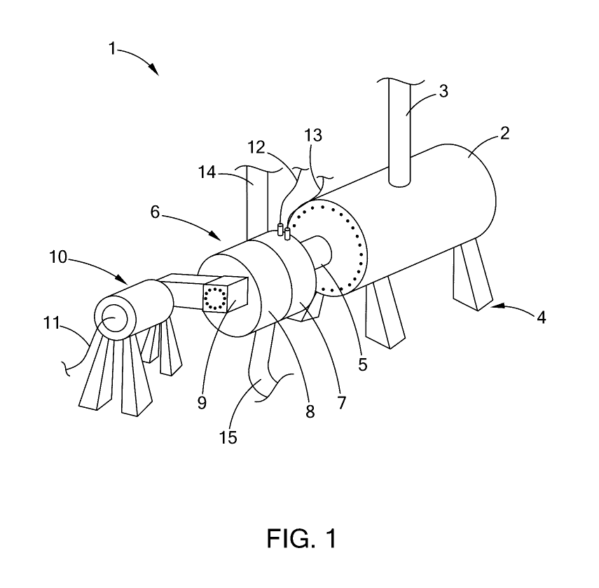

In general hybrid underwater mechanical forming systems, such as underwater pelletizing systems, typically involve the formation of beads, droplets or particles by sectioning while forming a PDC precursor in a fluid environment. Further, and preferably, the fluid environment will further shape the sectioned PDC into a predetermined cured shape, e.g., beads, droplets or particles. Turning to FIG. 1 there is shown a perspective view of an underwater pelletizing system 1. The system 1 has a pumping unit 2 that has a base 4 and a liquid PDC precursor feed line 3. The feed line 3 is connected to a PDC precursor source, e.g., a make up system, tank, etc. (not shown in the figure). A transfer assembly 5, e.g., a line, pipe, pump discharge, etc., provides the PDC precursor to the formation section or formation head 6. The formation section 6 has a die assembly 7 and a cutter assembly 8, and a fluid in-flow line 14, and a fluid out-flow line 15. The formation section 6 has a cutter force unit 9 and a cutter drive system 10. Those units have a power/control line 11. The formation section 6 has a heater powered by line 13 and a temperature sensor having a temperature sensor line 12. Preferably, line 13, line 12 and line 11 are in communication with a control system, that controls the operation of the system.

The volumetric shapes may also be processed to form platelets, flakes and essentially plainer shapes, e.g., where the surface area (e.g., x-y area) is 10 times or more, 20 times or more, and 100 times or more, greater than their thickness (e.g., z direction). Thus, for example, the more rounded or thicker shapes, such as a fiber, bead or sphere, can be flattened. The flattening can take place at any point prior to the point where the cure is so hard as to prevent the shape from deforming without undue breakage, e.g., prior to a hard cure.

In an embodiment the pumping unit 2, the transfer assembly 5, and both, are an extruder. The extruder can further be used to admix, mix, react, blend and other wise combine several different starting materials to provide a PDC precursor batch. In this manner the PDC processor formulation is made at the forming unit. While extrusion and underwater, i.e., in liquid, extrusion and cutting are focused on in this section of the specification, it should be understood that the extrusion can take place in any fluid, including, liquids, water, gases, air, nitrogen, under reduced pressure, under increased pressure, in a flowing fluid environment, and other forming environments disclose and taught in the disclosures that are incorporated into this specification by reference. Additionally, while forming through a die for these types of systems is preferred, the extruder and in particular when used as a blending or reaction device to make a PDC formulation, does not require and in embodiments may not have a die.

In operation the liquid PDC precursor formulation is feed into the pumping unit 2 where it is feed into the die assembly 7. The liquid PDC precursor is feed into the die assembly 7 by pumps, gravity, metering pumps, pressurized tanks etc. The flow rate of the liquid PDC precursor is preferably controlled and preselected to correspond with the die's structure, a particular PDC formulation's cure rate, the cutter speed, the heating rates in the formation section 6, and other factors. The liquid PDC precursor is feed into the die assembly 7 where curing is preferably initiated. As the partially cured PDC precursor exits the die, e.g., is extruded from the die's openings, it is cut off into sectioned partially cured PDC volumetric shapes, e.g., initially cured pellets. The length of the pellets is determined by the rate at which the initially cured PDC leaves the die, e.g., the extrusion rate, and the speed of the cutters. As the initially cured PDC leaves the die it is exposed to a fluid and upon sectioning by the cutters the initially cured PDC is completely surrounded by the fluid, and preferably carried away by the fluid. The fluid can be water, water with a surfactant, and any of the other liquids, types of liquids, and mixtures of liquids discussed in this specification, or otherwise know to the art or later developed. The fluid acts to shape the initially cured PDC sectioned shape into a bead and preferably a perfect sphere, while also preferably continuing to cure the sphere, e.g., to a final cure, or to a hard cure.

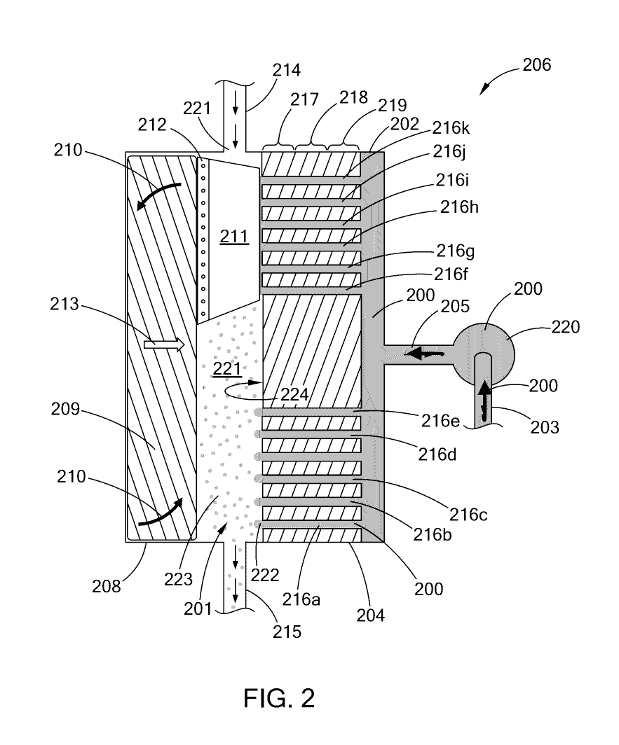

Turning to FIG. 2 there is shown a cross sectional view of a PDC water-pelletizing formation head 206. Liquid polysilocarb precursor 200 is feed into a pump 220 where it is discharged via line 205 into a die assembly 204. The die assembly 204 has a distribution header 202 that is in fluid communication with die plate channels 216a, 216b, 216c, 216d, 261e, 216f, 216g, 216h, 216i, 216j, 216k. The liquid polysilocarb precursor 200 is feed into the distribution header 204 and then into the channels, e.g., 216a etc. The die assembly 204 has heating zones 217, 218, 219. These zones provide heating to the liquid polysilocarb precursor 200 as it flows through the channels 216a, etc. The polysilocarb precursor is at least partially cured and exist the die channel as a fiber or rod like structure, e.g., 222. The polysilocarb precursor exist the die channels 216a, etc., into water 221. The water 221 is flowed through a cutting-curing chamber 223 having water inlet line 214 and water outlet line 215.

The formation head 206 has a cutter assembly 208. The cutter assembly 208 and the die assembly form the cutting-curing chamber 223. The cutter assembly 206 has a cutter wheel 209 that has one, two, three, four or more cutting blades, e.g., 211 (only a single cutting blade is shown in the figure for simplicity and clarity). The cutting blades 211 are mounted to the cutting wheel 209 by cutting blade mount 212. The cutter 211 is pushed against the die face 224, as illustrated by arrow 213. The force of the cutter 211 against the die face 224 is preferably controlled to provide clean cutting of the rod like structures 222, while minimizing, and preferably partially avoiding the wearing of the die face 224. The cutter wheel 209, and the blades 211 rotate as shown by arrows 210.

The rod like structures 222 are cut by the blades, e.g., 211 and are then in, and preferably free floating in, the water as pellets, e.g., 201. These pellets are then further cured and shaped in the water to form preferably perfect spheres. These pellets may also be further processed, prior to further curing, such as by for example, mechanically flattened them to form platelets or flakes.

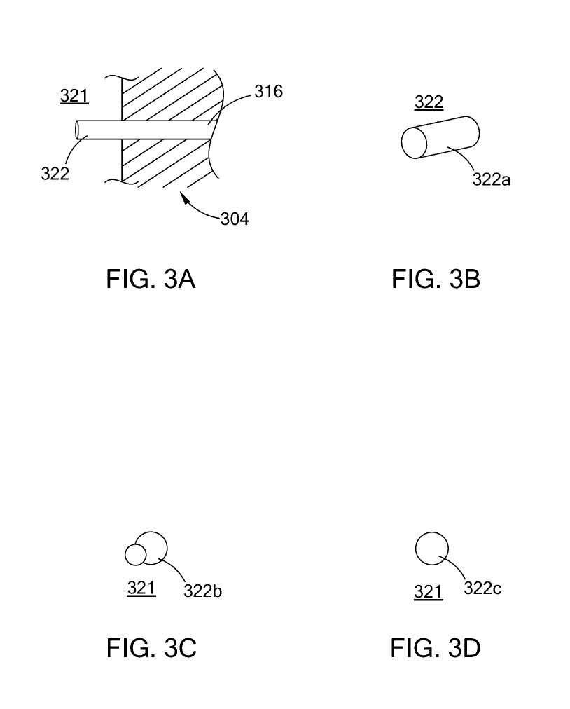

In general, as illustrated in FIGS. 3A to 3D an embodiment of the process provides for the continuous initial curing of a PDC precursor in a die 304 channel 316 to form an initially cured fiber or rod structure 322, which is advanced directly into water 321. The initially cured fiber in the water is then section off, into cylindrical pellet like structures 322a, having a length, and a diameter. The water, the conditions of the water (e.g., temperature, agitation, surfactants, etc.), among other things, then shape 322b the cylindrical pellet into a sphere 322c, while also continuing to cure the material. This process can also be viewed as a hybrid liquid-liquid process, and the subsequent teachings, theories, and discussion regarding bead formation in a liquid-liquid system are applicable to the water pelletization processes and systems.

It should be understood, that none, one, two, three or more heating zones may be associated with the formation head. The heating zones can be electric, steam, water, or any other means to heat the die, and thus the liquid PDC formulation, to provide for preferably a controlled and predetermined cure.

The PDC formulation when it is shaped into the first initial volumetric structure when leaving the die channel and entering the fluid in the cutting-curing chamber can be uncured, partially cured (e.g., from about 0% of hard cure, to about 99% hard cure, less than 90% hard cure, less than 80% hard cure, less than 70% hard cure, less than 60% hard cure, less than 50% hard cure, less than 40% hard cure, less than 30% hard cure, less than 30% hard cure and less than 10% hard cure). The RPM of the cutting blades can vary depending upon the size of the unit and the flow rate of the PDC out of the die channels. The number of channels in the die can be one, tens, hundreds and more. The opening of the die into the cutting-curing, can be tapered inwardly, tapered outwardly, at a sharp right angle, at a right angle with a small radius, curved, and combinations and variations of these and other opening configurations and shapes. Preferably the die openings are all the same, however slight variations may be preferable in larger die faces to accommodate for radial position of the die and the various speed of the cutting blade. Variations in the die openings may also be used to provide different volumetric shapes, from a single die.

The diameter of the channels in the die, e.g., the die orifice diameter or channel internal diameter, can be less than about 2000 μm, from about 100 μm to about 1500 μm, from about 1 to about 1000 μm, from about 200 to about 2,000 μm, from about 210 to about 750 μm. Submicron diameters and diameters larger than 2000 μm may also be used.

The temperature of the water bath can be any of the temperatures at which the PDC formulation can cure. These curing temperatures, conditions and factors are discussed through this specification.

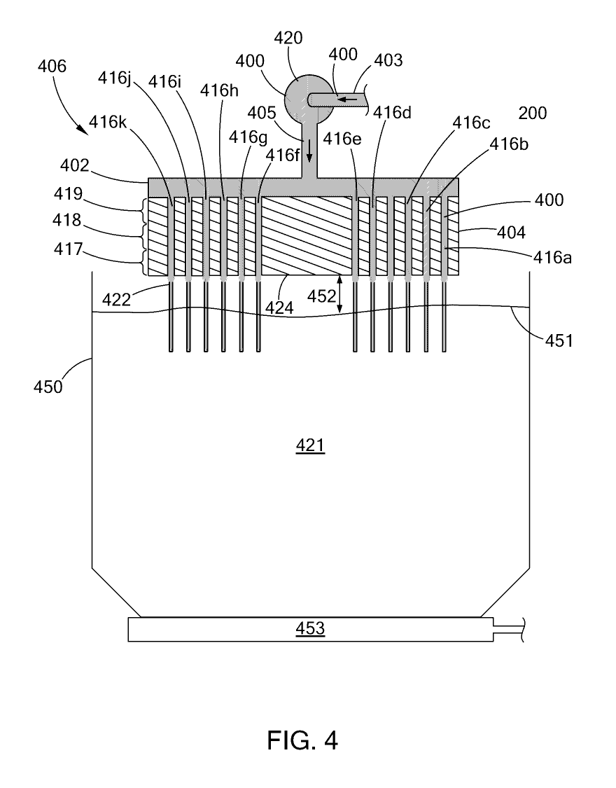

Hybrid underwater mechanical forming systems, can be used to form elongate volumetric shapes, such as fibers, staple fibers, tow, rods, etc. Further, and preferably, the fluid environment will further shape the sectioned PDC into a predetermined cured shape. In an embodiment of this system, the formation head of the under underwater pelletizing system of FIG. 1 is substantially vertical. (It being noted that elongate structures can also be formed by the embodiments of the systems of FIGS. 1 and 4. However the cutters will be eliminated, not operated, or the rotational timing of the cutter slowed to allow for the formation of longer, e.g., elongate structures, instead of beads.)

In an embodiment the fibers or rods can be further mechanically shaped into ribbons, elongate flatten structures, and ribbon like shapes. The flattening can take place at any point prior to the point where the cure is so hard as to prevent the shape from deforming without undue breakage, e.g., prior to a hard cure.

Turning to FIG. 4 there is shown a cross sectional view of a vertical PDC water-fiber formation head 406 and chamber 450 for use with a system such as the embodiment of FIG. 1. Liquid polysilocarb precursor 400 is feed into a pump 420 where it is discharged via line 405 into a die assembly 404. The die assembly 404 has a distribution header 402 that is in fluid communication with die plate channels 416a, 416b, 416c, 416d, 461e, 416f, 416g, 416h, 416i, 416j, 416k. The liquid polysilocarb precursor 400 is feed into the distribution header 404 and then into the channels, e.g., 416a etc. The die assembly 404 has heating zones 417, 418, 419. These zones provide heating to the liquid polysilocarb precursor 400 as it flows through the channels 416a, etc.

The polysilocarb precursor preferably is at least partially, or initially cured and exist the die channel as a fiber or rod like structure, e.g., 422. The polysilocarb precursor exist the die channels 416a, etc., into curing fluid, e.g., water 421, having a surface 451. In the configuration shown in FIG. 4, the die face 424 is above the surface 451 of the water 421. It being understood that this distance 452 can be varied. Thus, the distance 452 above the surface 451 of the water 421 can be about a millimeter, to millimeters to about a meter or more. The atmosphere and environment in this area 452 between the die face 424 of the die and the surface of the water 451 can be controlled, and can have temperatures, energies (e.g., optical, IR, microwave) and gasses (e.g., O₂ rich, inert, carrying additives) and thus designed to have a predetermined effect on the polysicocarb precursor 422 as it initially emerges from the die face. Additionally, and preferably, for some embodiments the die face 424 is submerged under the surface of the water 451.

The water 421 is maintained at a controlled temperature, and is preferably quiescent. In an embodiment, the polysicocarb formulation, die temperatures, extrusion rate and water temperatures are selected so that as the fibers are formed in the water they will break from their own weight at predetermined lengths. In other embodiments, a degree of flow, or agitation, or some other form of mechanical force may be used to break or cut the forming fibers. In other embodiments, the conditions and depth of the tank are such that the fibers do not break and form long continuous fibers.

The chamber 450 has a collection and removal assembly 453 at its bottom. This can either be a continuous, or batch system, that removes the fibers once they have been sufficiently cured.

In an embodiment the formation head 406 is used without the chamber 450. In this manner the fibers are formed and cured in air (or a controlled atmosphere, e.g. N₂, Ar, etc.). The length of the fibers can be determined based upon the viscosity and cure rate of the PDC precursor. The cured fibers can drop to a conveyor, or other collection device, where they will be removed.

In an embodiment of the collection assembly, that assembly can be used to further shape the fibers into ribbons, elongate flatten structures and ribbon like shapes.

In general, an embodiment of the process provides for the continuous initial curing of a PDC precursor in a die channel to form an initially cured fiber or rod structure, which is advanced directly into water. The initially cured fiber or rod is then further cured in the water. The water, the conditions of the water (e.g., temperature, agitation, lack of agitation, surfactants, etc.), among other things, can further shape, or have other effects on, the fiber or rod, while also continuing to cure the material. This process can also be viewed as a hybrid liquid-liquid process, and the subsequent teachings, theories, and discussion regarding formation in a liquid-liquid system are applicable to the water-fiber processes and systems.

It should be understood, that none, one, two, three or more heating zones may be associated with the formation head. The heating zones can be electric, steam, water, or any other means to heat the die, and thus the liquid PDC formulation, to provide for preferably a controlled and predetermined cure.

It should further be noted that the head while preferably being positioned vertical, e.g., may be at any angle from vertical. Further, the fibers may be extracted upward (for example, in an embodiment where the fibers have neutral buoyancy, or are buoyant in the forming fluid).

The PDC formulation when it is shaped into the first initial volumetric structure, e.g. a fiber or rod, when leaving the die channel and entering the fluid in the chamber can be uncured, partially cured (e.g., from about 0% of hard cure, to about 99% hard cure, less than 90% hard cure, less than 80% hard cure, less than 70% hard cure, less than 60% hard cure, less than 50% hard cure, less than 40% hard cure, less than 30% hard cure, less than 30% hard cure and less than 10% hard cure). The number of channels in the die can be one, tens, hundreds and more. The opening of the die into the cure-cutting chamber, can be tapered inwardly, outwardly, at a sharp right angle, at a right angle with a small radius, curved, and combinations of these and other opening configurations and shapes.

The diameter of the channels in the die, e.g., the die orifice diameter or channel internal diameter, can be less than about 2000 μm, from about 100 μm to about 1500 μm, from about 1 to about 1000 μm, from about 200 to about 2,000 μm, from about 210 to about 750 μm, Submicron diameters and diameters larger than 5,000 μm may also be used.

Further, in an embodiment, the orifice of the die channels can be slits, having length (x direction) longer than its height (y direction). The slits can have lengths from about 5 μm to about 4000 μm, and have thickness less than about 1000 μm, less than about 100 μm, less than about 50 μm, less than about 10 μm, less than about 5 μm, less than about 2 μm, about 2 μm, about 1 μm, and less than about 1 μm. Thus, for example, the slits can have x-y dimensions in microns (μm) of about 1-10, 1-100, 1-1000, 2-10, 2, 100, 2-1000, 2-2000, 3-200, and 5-100, to name a few.

The temperature of the water bath can be any of the temperatures at which the PDC formulation can cure. These curing temperatures, conditions and factors are discussed through this specification.

Preferably the conditions are such that the fibers or rod like structures have uniform diameters. It is noted, however, that formation conditions can be such as to produce continuous, or semi-continuous fibers with varying diameters, e.g., bulges, or neck down sections, along their length.

The polymer derived cured elongate structures, e.g., fibers and rod like structures may have diameters from about 1 to about 1000 μm, about 100 to about 5,000 μm, about 200 to about 2000 μm, about 100 to about 1,000 μm, and about 200 to about 750 μm. Submicron diameters and diameters larger than 5,000 μm may also be made.

The polymer derived cured elongate structures, e.g., fibers and rod like structures may have lengths from about 1.5× the structure's diameter to about 10,000× the structure's diameter and longer, about 50 μm to about 5,000 μm, about 500 mm, about 1,000 mm, about 1 mm, about 10 mm, about 10 meters, and lengths longer and shorter.

In a preferred embodiment a batch or collection of these fibers may all have the same, or essentially the same diameter and length, or they may have essentially the same diameter and different lengths.

The cured volumetric structures from this embodiment may be further pyrolized.

Underwater pelletizers for forming PDC pellets by the use of an extrusion die having orifices through which liquid PDC precursor is extruded through a die face for engagement by cutter blades mounted on a rotatable cutter hub and driven by a drive shaft is well known. It is desirable to maintain the cutters and die face in properly aligned relation in order that the cutting edge of the blades on the cutter hub move in very close parallel relation to the face to efficiently cut the extruded PDC into pellets as it is discharged from the orifices in the extrusion die plate. The following U.S. patents relate to underwater pelletizers, cutter hub assemblies and structures for positioning the cutters and cutter hub in desired relation to the die face of the die plate: U.S. Pat. Nos. 4,123,207; 4,621,996; 4,251,198; 4,728,276; 4,500,271; 5,059,103, the entire disclosures of each of which are incorporated herein by reference

Liquid-Liquid Systems

Generally, in the liquid-liquid type systems a liquid precursor is formed into a bead, droplet, ribbon or particle, in a liquid, and then preferably cured in that liquid. The precursor bead, droplet, ribbon or particle, may be initially exposed to a gas before being placed in the liquid; however, for these types of processes, it is preferred that the bead, droplet, ribbon or particle be formed directly in the liquid, with the precursor not being exposed to any gas during formation and initial curing, or being exposed to only a minimal and preferably controlled gas environment, before entry into the liquid. Polymer emulsification, solution polymerization, solution bead forming, nano-emulsification, and similar types of system can be used to make small volumetric shapes from precursor formulations. In these systems a liquid phase—liquid phase process, forms small, and very small, i.e., a few inches, to microns, to submicron, size beads, droplets or particles, of the precursor formulation; and then preferably cures them in the second liquid phase. Thus, these types of systems in general form beads of liquid precursor material in another liquid, e.g., bulk liquid phase, second liquid, continuous phase, or continuum. The beads, upon forming, are then sufficiently cured in the second liquid phase, e.g., the continuous phase, so that their shape, and other predetermined properties, are locked in, to the extent needed for subsequent processing or use, e.g., storage, pyrolysis, machining, etc. Larger and smaller size beads may also be made.

Further, the liquid-liquid techniques can be combined with other forming and curing techniques. Thus, for example a liquid-liquid precursor suspension could be spray-dry to initiate cure and simultaneously drive off the excess H₂O. Similarly, the liquid-liquid precursor suspension could be used in the other forming and curing techniques and technologies, among those provided in this specification and others. Thus, in the liquid-liquid embodiments as well as others, the beads or particles can be formed in the liquid, cured in the liquid, formed in a non-liquid environment, cured in a non-liquid environment and combinations and variations of these.

Beads formed with the first and second liquid phase can be added to a third or fourth liquid phase to coat the particles or beads with another polymer, a surfactant and combinations of these and other materials, as well as to cure the particles.

Embodiments of the present systems control parameters relating to particle size distribution in these liquid-liquid systems, which include among other parameters, surface tension, viscosity, temperature, volume fraction of dispersed phase (e.g., the precursor), polymerization (e.g., curing), process, surfactants, the action of adsorbed surfactants, and the hydrodynamic flow conditions of the system.

In some embodiments it may be thermodynamically more favorable for bulk material separation, over a dispersion, due to the increased surface area (and consequential surface energy) associated with an emulsion. Consequently, energy input is required to generate an emulsion. Thus, it is theorized that the notion of a ‘stable’ emulsion is thermodynamically flawed, but kinetically possible via the addition of surfactants/emulsifying agents to the system, which prohibit coalescence of formed droplets into a bulk phase or agglomeration.

Preferably, in embodiments of the present systems, it is theorized that the ultimate particle size distribution is a result of the steady state formed between droplet break-up and droplet coalescence phenomena. By increasing the ease of droplet break-up and increasing the barrier to droplet coalescence, emulsions can be driven to smaller and smaller average particle sizes.

Generally, higher temperatures, volume fractions of the dispersed phase, and viscosities tend to increase average particle size. Higher surfactant concentrations and more energetic hydrodynamic flow conditions tend to decrease average particle size.

Typically, upon polymerization, e.g., curing, the polymer will exhibit solid colloidal properties that are distinct from the starting material phase, e.g., a monomer precursor, or for polysilocarb precursors a liquid polymer. Consideration should preferably be made of the adsorption and agglomeration properties of the cured precursor with respect to the liquid precursor to preferably ensure that the cured particles do not aggregate. For some embodiments aggregation or agglomeration may not be an undesirable result. Moreover, for some applications, if, for example, the agglomerate can be readily broken apart at a later time, such agglomeration can be very beneficial, both from safety issues, e.g., avoids handing very small particles and dusting issues, and from performance issues, e.g., requires little energy to break the agglomerate down to a smaller particle size preferred or required for use in some application.

While many sizes of particles are contemplated. Particle sizes, preferably obtained via liquid-liquid systems, e.g., emulsion and solution systems, can range from about 0.1 microns (μm) to about 4 mm (5 U.S. Mesh), although large and smaller sized may be obtained. Embodiments of various particle size systems, would include for example: micro-systems (e.g., about 10-100 nm dispersed particle size); mini-systems (e.g., about 100-1000 nm dispersed particle size); macro-systems (e.g., about 0.5-200 μm dispersed particle size; and, about 400 mesh (37 μm) to about 10 mesh (2,000 μm)). It should be noted that this nomenclature is to define a particle size range, and does not necessarily limit the process used to obtain that particle size.

Suspension polymerization type processes, e.g., the initiator of polymerization is soluble in the dispersed monomer phase, and emulsion polymerization type processes, e.g., the initiator is soluble in the continuous phase, can be used to form small volumetric precursor shapes, which can already be cured, or can then be cured, and pyrolized.

The following discussion and theories are provided to further explain and illustrate the liquid-liquid system processes by with PDC precursor volumetric shapes, PDC preforms, and preferably polysilocarb volumetric shapes, are made. It is noted that there is no requirement to provide such explanation or theory underlying the novel and groundbreaking features and properties that are the subject of, or associated with, embodiments of the present liquid-liquid systems for forming volumetric shape PDC preforms. Nevertheless, various theories are provided to further advance the art in this important area. These theories, unless expressly stated otherwise, in no way limit, restrict or narrow, the scope of protection to be afforded the claimed inventions.

Surface tension typically contributes a positive energy to the system, and thus, the free energy is minimized when the surface energy is minimized. It may prove advantageous in determining a system to model the Gibbs Free Energy of the system, and view this as having a number of contributions. Thus, looking at the bulk and surface energy contributions (in a constant temperature and pressure environment):

The bulk energy of the system is volume dependent. In the case of an emulsion, no volume change is occurring—merely the rearrangement of a given volume of liquid into different geometric orientations.

dG=dE_{Bulk}+dE_{Surface}

However, surface energy content of the Gibbs energy does change as a function of geometry according to:

dE_{Bulk}=0

Where y is the surface tension of the interface and A is the area.

It can thus be theorized that in general the minimum free-energy state requires a minimization of the surface area for a constant volume system. However, the presence of a global minimum in the Gibbs Free Energy surface does not preclude the formation of a metastable emulsion if the global minimum condition (i.e. bulk separation) is not kinetically accessible.

In general, there can typically be two types of quasi-stable emulsions,—metastable emulsions and steady state emulsions; although other characterizations and types can exist. In this context, stable means a relatively constant particle size distribution.

The first general type is a metastable emulsion. Via mechanisms that will be discussed below, the free energy of a particle in a continuous medium can have a local minimum. If this minimum is deep enough, the kinetic path to establishing the global minimum condition (or bulk condition) is inaccessible energetically and consequently a local equilibrium condition requiring no additional energy input, or metastable emulsion, can be produced. However, true metastability is rare in practical systems.

The second type of quasi-stable emulsions—steady state emulsions, is more typically observed. Thus, most ‘stable’ emulsions are not in thermodynamic equilibrium at all, but merely systems in a steady state condition where the rates of droplet “break-up” and the rate of droplet “coalescence” are equal. In some embodiments, it is generally sufficient, and preferable, that the emulsion remains in tact for sufficient time to cure the beads, or otherwise prevent their agglomeration prior to subsequent use or processing, e.g., hard curing, further curing, milling, or pyrolysis.

In a typical liquid-liquid emulsion process the to-be-dispersed phase, e.g., the monomer, or the polysilocarb precursor polymer, is introduced into the continuous phase, e.g., an aqueous phase, in bulk or larger than desired particle sizes. In order to achieve emulsification, energy generally should be added to the system to induce the break-up of the to-be-dispersed phase into smaller and smaller droplets due to the increase in surface area associated with smaller droplets. The minimum energy input to achieve a desired particle size can be quantified by the equation:

dE_{Surface}=γdA

for constant surface tension (γ), which is reasonable to assume until typically micro-scales. Thus, achieving very small particle diameters, because of the rapid increase in surface area with decreasing diameters, requires high energy inputs.

The minimum energy shape of a droplet is a sphere due to the local minimization of surface area. Typically, in order to break-up a droplet it generally should first be made into a non-spherical shape, or elongated. The Laplace Pressure

$$Δ P = \frac{4 γ}{D}$$

where D is the particle diameter, resists elongation and is known as the maintenance force. The force applied to elongate the droplet is called the disruptive force and is typically described in terms of shear stresses.

The non-dimensional Weber Number

$$We = \frac{ρ {v}^{2} l}{γ}$$

where ρ is the density, v the velocity, and l the length scale of the system, can be a useful tool for understanding whether a droplet will be broken up when a certain energy input is provided. The Weber Number gives the ratio between disrupting forces and maintaining forces, such that above a certain Weber Number (achieved for a sufficient period of time), droplet breakup is induced.

There are several mechanisms by which disruptive forces can be provided to a droplet. The shear force can be provided in shear laminar flow conditions, turbulent eddies, or convergent/divergent flow systems, to name a few. Different homogenization/emulsification technologies leverage different mechanisms to induce shear-break-up. Various systems and apparatus can be utilized to provide these forces in larger systems, e.g., 100 gallons, 200 gallons, 500, gallons, 1,000 gallons and greater.

Typically, a particle will experience significant shear force if the length scales of the flow conditions are comparable to the diameter of the particle. Consequently, it is theorized that having a bulk flow of substantial energy that does not have short length scale components will not likely break-up droplets. It is thus proposed that a scale-dependent energy parameter is used to relate the magnitude of shear force provided by various technologies. This is the Specific Energy:

$${E}_{v} = \frac{P}{\dot{V}}$$

where P is the power of the system and V is the flow rate.

It has been empirically demonstrated that the mean droplet size is inversely proportional to Eᵥ. However, across different flow conditions (turbulent, convergent, etc.) specific aspects of geometry differentiate particle size beyond Eᵥ. The following figure demonstrates the effect of Eᵥ on particle size for a number of embodiments of processes to form polysilocarb preform droplets.

It should be noted that the presence of sufficient energy density to incite droplet break-up is necessary, but in some embodiments may not be sufficient for droplet break-up to occur. The kinetics of droplet break-up can be complex, but it has been empirically demonstrated that there is a characteristic time scale for break-up to occur, which depends on a number of material and mechanism parameters. Thus, in some embodiments long times (e.g., greater than 30 minutes, greater than 1 hour, greater than 2 hours and more) may be necessary to achieve steady state.

In a theoretical system with no thermodynamic driving force to a bulk condition, an emulsification would proceed via droplet break-up until the minimum length scale at which the minimum Weber Number is exceeded is reached. However, real systems are driven to ‘coalesce’ or agglomerate in order to minimize surface area and hence surface energy.

A system without attractive or repulsive forces would have a flat potential as a function of separation of two particles, with the exception of a point of overlap where the potential would be substantially negative with respect to the non-agglomerated particles (representing coalescence).

In such a system, generally, the driving forces for motion between particles are thermal and hydrodynamic (flow conditions of the medium). If two particles happen to come in contact, they will coalesce and remain in contact in the lower-energy state unless sufficient disruptive force is supplied.

However, real systems have attractive and repulsive forces that modify the Free Energy as a function of Separation.

Van-der-Waals forces (or induced dipole oscillation forces) act over very short distances and serve to attract non-polar particles to each other.

At very short distances, the atomic electron clouds begin to overlap and Born repulsion occurs. The resulting potential, including Van-der-Waals forces, is similar to the classic Lennard-Jones potential. However, in some embodiments this effect is not as great a factor to understanding coalescence for the larger particle sizes, e.g., mini-systems (e.g., hundreds of nm) and greater.

It is thus theorized that without the modification of the system to include additional repulsive forces, the free energy curve monotonically decreases as the particles come together; thus, typically, and inexorably leading to coalescence. In order to achieve metastability or a steady-state equilibrium particle size of desired dimensions, kinetic barriers to coalescence in general should be utilized. There are several sources of kinetic barriers in liquid-liquid systems, e.g., emulsion systems.

If the particles themselves, or more often the surfaces of the particles, are charged, then coulombic forces are present in the system and may act to repel particles. This coulombic repulsion acts over much larger distances than Van-der-Waals forces. Thus, in order for two particles to reach a point of separation where coalescence is energetically favorable, typically, sufficient energy generally should be imparted to the system to overcome ΔG. This energy can come from, for example, hydrodynamic forces or thermal motion.

The source of charged surfaces in the system can be varied. Surface species can be directly ionized resulting in residual charge. This can be brought about via numerous mechanisms, but is typically pH dependent. Thus, modifying the pH of the continuous phase can result in charge-repulsion affects.

The presence of an ion of lower valence in the system can result in a negative charge if said ion is exchanged for the original.

The presence of adsorbed species that are charged can result in charged surface interactions and repulsions. This is one of generally two mechanisms by which emulsifying agents act to facilitate droplet break-up and disrupt droplet coalescence.

It is theorized that the permittivity of the intervening medium (the continuous phase) between particles modifies the effect of the coulomb repulsion in a standard fashion. However, the presence of the continuous phase has the additional impact of generating a charged-double layer. This effect serves to shield the surface charge by proximously locating inversely charged species. Thus, if the surface of the dispersed phase is negatively charged, positive charges in the continuous phase will form a double-layer to counter the negative charge. The thickness of this layer depends on the ionic concentration of the solution—the more ions present in the continuous phase, the thinner the layer due to the greater availability of shielding ions. The thicker the double-layer, the greater the repulsive effect due to charge on the system. Thus, a lower ionic concentration of the continuous phase results in greater electric repulsion and thus enhanced stability of the emulsion. The resulting potential of the double layer is known as the zeta potential.

In general, steric repulsion refers to the barrier imposed by the adsorption of a species onto the surface of a particle that serves to prohibit overlap of particles. There are generally two mechanisms of steric repulsion: modification of Van-der-Waals forces and entropic repulsion. If a thick layer of adsorbed species with properties similar to the continuous medium is present on the surface of the dispersed particle, then typically the Van-der-Waals force is shielded. Further, the compression of a polymer species adsorbed on the surface of a dispersed particle induced by contact with a neighboring particle reduces the entropy of the system from the equilibrium state and thus induces entropic repulsion. Thus, adsorbed species can serve as a shield to coalescence. The steric mechanism of repulsion is typically surfactant/emulsifier concentration dependent and in some embodiments may be highly surfactant/emulsifier concentration dependent.

When two particles are driven to coalesce they typically move through the continuous medium. As they do so they are displacing a liquid, thus resulting in energetic dissipation. Consequently, the energy required to induce coalescence is typically greater than it would be in the absence of a rheologically active continuum. Further, in the case of a liquid-liquid emulsion, the dispersed phase will undergo geometric distortion during the collision of particles, resulting in further rheological dissipation.

It is suggested that the physics of thin films can be used to explain coalescing phenomena, as the kinetic paths through which the surface is disrupted, leading to aggregation, are dictated by thin film phenomena. There is typically a critical film thickness beneath which the film spontaneously is disrupted.

The preceding discussion described theories and mechanisms by which collisional coalescence may be reduced or enhanced. However, additional mechanisms of coalescence may be active in an emulsion system.

For example, one of the additional mechanisms is Ostwald Ripening, or diffusive species transfer. The fundamental driving force of energy minimization due to surface area minimization is still the active motivation for mass transfer. This can be intuitively understood by recognizing that the larger percentage of the volume of a system present in larger diameter particles, the lower the overall surface area. Thus, the growth of a larger particle at the expense of a smaller particle is typically thermodynamically favored and diffusion is allowed to proceed by concentration gradients induced by the curvature of the particles. Diffusive transfer phenomena will tend to occur on longer time scales then collisional coalescence until very small diameters are present in the system. The rate of mass transfer stays roughly constant, and thus the rate of diameter change varies dramatically as a function of diameter.

In general, there can be two primary processes by which bead, droplet, or particle formation, polymerization, crosslinking, or curing, occurs in mini-systems and smaller systems. These processes are emulsion polymerization and suspension polymerization.

In emulsion polymerization type of processes for making PDC beads, droplets and particles, the dispersed phase is typically the precursor formulation and the continuous phase is typically aqueous. To initiate curing, an initiator (e.g., the catalyst, heat, or both) is added to the over all system, or activated. The initiator is preferably soluble in the continuous phase. Thus, it is theorized that, the surfaces of the precursor formulation polymers serve as nucleation sites, but particle polymerization or growth occurs in the continuous phase. The initial emulsion of the precursor formulation polymers serves as both nucleation sites and a reservoir for particle growth. In general, this can have implications for growth kinetics and particle size distribution of the PDC, e.g., polysilocarb, preform particle.

Because there is a set of controllable nucleation events, it is theorized that, nucleation can be initiated simultaneously for nearly all particles resulting in relatively mono-dispersed final particles. However, the growth rate of the particles is diffusively limited, and depending upon the specific embodiment of the system and precursors, the complete formation of the emulsion may take a long time (e.g., greater than 30 minutes, greater than 1 hour, greater than 12 hours, and more than 24 hours).

In suspension polymerization, the initiator, e.g., the catalyst, is soluble in the PDC precursor, e.g., the polysilocarb precursor, itself, and typically is added to, e.g., is already present in, the dispersed phase, prior to emulsification. Thus, curing occurs in-situ for the dispersed phase. The initiator, may be the catalyst, heat, and preferably both. Consequently, it is theorized that the particle size distribution is controlled directly by the dispersed phase distribution in the emulsion—these generally should become the final particles. It is further theorized that because there is no diffusive rate-limiting kinetics in this process, polymerization/cure can occur more rapidly than in emulsion polymerization.

Various embodiments of different systems and precursor formulations are contemplated to provide specific final, e.g., cured to the extent that can be used or subjected to further processing preferably without the risk of deformation and agglomeration, particle sizes and distributions. Several factors that may influence particle size, among others, are further addressed to serve to inform process decisions for various additional embodiments that fall within the ambit of the present systems.

For emulsion polymerization, the final particle size is typically primarily determined by nucleation and growth kinetics and not by the initial emulsion droplet distribution. An aspect, in some embodiments of emulsion polymerization growth is the simultaneous nucleation of particles. Additionally, the achievement of a stable steady state emulsion for the long period of time required for emulsion polymerization to proceed in some embodiments may be challenging. Generally, it is preferred to ensure, e.g., maintain, uniform thermodynamic and kinetic conditions in the reactor during polymerization to have monodisperse particle growth.

Due to the kinetics of particle growth in emulsion polymerization systems, it is theorized that, smaller particle sizes (a few hundred nanometers) tend to require lower yields than larger particle sizes. This can be understood by noting that a finite number of nucleation sites exist in the emulsion from which particles grow. The reaction is typically stopped when the desired particle size is reached, but unless the number of nucleation sites was high enough that this accounts for, uses up all of the total volume of initial precursor formulation polymer, there can I be excess precursor emulsified in the system that is not cured. For liquid-liquid precursor formulations where the curing reaction is taking place entirely, or essentially entirely (accounting for skin effects and surface effects) within the bead or particle, this generally will not be a consideration or factor.

In preferred embodiments, the particle size distribution can be approximately normal, e.g., a Gaussian distribution.

For suspension polymerization, generally the droplet size and distribution of the emulsion will directly correspond to the particle size of the system.

At a high level, it is theorized that, the droplet size and distribution is the result of a steady state between droplet break-up and droplet coalescence. Following are additional descriptions of the affects that various material properties, thermodynamic conditions, and emulsion mechanisms can have on break-up, coalescence, and particle size distribution. The droplet size distribution is in general process dependent, and relates, among other things, to the statistics of energy partition across length scales in a flowing system. The presence of surfactants/emulsifying agents in the system can have an affect on, and in some embodiments critically alters, both droplet break-up and droplet coalescence phenomena.

It is theorized that one of, and in some embodiments the primary contribution of surfactants to droplet break-up is the reduction of surface tension. It is theorized that the entropic impact of adsorption lowers the Free Energy of a system. Thus, the surface tension of the surface of a particle with adsorbed species on it is reduced.

The most common mechanism by which this reduction occurs is a surfactant having a lipophilic and a hydrophilic end. The lipohilic end associates with the precursor polymer and the hydrophilic end with the continuum or the continuous phase, e.g., the aqueous phase. Typically the larger the percentage of the surface of the particle covered with surfactant, the larger the reduction of surface tension.

Generally, the percentage of the surface of a particle adsorbed with surfactant depends on the activity of the surfactant (which is in turn dependent on the concentration) in the continuum. The larger the concentration of surfactant, the more a particle surface will be covered, and the lower the surface tension. Typically this is a nonlinear process with diminishing returns because of the thermodynamics of activity. Further, as will be discussed below, the addition of surfactants can modify the viscosity of the continuous phase further impacting break-up phenomena.

Some surfactants in specific systems have been shown to encourage spontaneous emulsification. This typically results in micro-emulsion character, which is theorized to be thermodynamically possible.

The adsorption of surfactant can also create additional kinetic barriers to coalescence as described above. This has the impact of frustrating coalescence phenomena and stabilizing the emulsion, enabling smaller droplet sizes. These barriers can be steric or electrostatic. Again, high surfactant concentrations can affect the viscosity of the continuous phase and this affect, and in some embodiments strongly impact coalescence phenomena, as will be described below.

Typically solid nanoparticles can be used in lieu of chemical surfactants due to their ability to provide coalescence disruption, though they can be less effective at reducing surface tension.

The appropriate surfactant for a given process is highly dependent upon the material systems in use, the temperature range of the process (described below), the desired particle size distribution, and further steps in the process (i.e. drying/powder formation), among other factors. Typically, and preferably, the surfactant with the greatest surface tension reduction is chosen, as this is a factor, and in some embodiments may be a critical parameter, affecting droplet size and required energy input.

There is typically a concentration of surfactant above which additional drop in droplet diameter is not seen, or is negligible. This is typically due to adverse affects of high-concentration on droplet break-up. It is theorized, based upon empirical demonstration that this concentration is independent of dispersed-phase volume fraction, and thus is related to the thermodynamics of adsorption.

For systems where the surfactant is ionic (inducing charge effects) no such threshold is believed to exist.

Generally, it is normally the case that energy input and emulsifier concentration can be used as independent levers to tune the particle diameter. Energy savings can be made by increasing emulsifier concentration, but can come with the consequences illustrated below.

High concentrations of emulsifiers can change the diffusivity of the continuum to the precursor formulation. This affects, and in some embodiments strongly affects, emulsion polymerization process kinetics, but typically does not impact, in some embodiments, the kinetics of suspension polymerization.

There also may be a minimum stable diameter of particle sizes before the thermodynamic driving force for diffusion is too large to allow the particle to remain metastable. This is influenced by and in some embodiments strongly influenced by the emulsifier concentration, because of the reduction of Free Energy differences between the bulk state and the dispersed state.

Because the introduction of large concentrations of emulsifying agents can be important to achieving a mini-emulsion, the impact of these chemicals on the process steps following polymerization generally should be taken into account. Specifically, certain classes of surfactants can make drying the particles more difficult, and thus can make powder formation processes more complex. It is a factor to choose emulsifying agents with a view toward subsequent process and end use requirements.

Viscosity can be a factor, and in some embodiments a critical parameter, in determining the final particle size distribution. For example, the dispersed phase viscosity, the continuous phase viscosity, and the relative viscosities of the two phases in turn are considered. The viscosity of the dispersed phase can have a direct correlation to particle size. It is noted that the Weber Number did not account for the viscosity of the dispersed phase. Rheological dissipation can occur when the viscosity of the dispersed phase is high. Consequently, additional energy is required to achieve the same droplet diameter as a lower viscosity dispersed phase. However, this same effect can also impact coalescence: rheological dissipation can occur for collisional coalescence, thus, it is theorized reducing the probability of a coalescing event. This effect typically is not as strong as the break-up effect, and is further offset by the presence of additional kinetic paths to coalescence (e.g., Ostwald Ripening).

Several factors can contribute to the viscosity of a system beyond the inherent viscosity of a homogenous medium.

Particle Interactions—For high dispersed-phase concentrations particles tend to interact. Steric repulsion and coulombic interactions lead to modified viscosity. Specifically, viewing this as two spheres in a liquid making contact, it can be theorized that they ‘bump into’ each other, leading to rheological dissipation and momentum transfer increasing the viscosity of the system. If two charged particles pass each other the additional force causes momentum transfer and adds to the viscosity of the system as well.

Emulsifier Concentration—The addition of emulsifier can, impact, and in some embodiments directly impact, the homogenous viscosity of the continuous medium. However, due to electroviscous and steric repulsion, the viscosity can be dependent on emulsifier concentration in different manners.

At large concentrations of dispersed phase, the particle interactions can induce non-Newtonian viscous behavior of the system. This can complicate the hydrodynamics of systems and tends to lead to larger average particle sizes.

In general, the primary independent impact of the viscosity of the continuous phase is in the viscous dissipation of energy input. The viscosity of the continuous phase can have a strong impact on the hydrodynamic conditions of the system, and can lead to modified turbulence and eddy length scales. However, this impact will typically be highly device specific, as convergent flow vs. turbulent mixing technologies have different geometries and flow conditions.

Of importance for some embodiments is the relative viscosity of the dispersed to the continuous phase. When substantially different, larger particle sizes tend to result. This can be due to inefficient communication of shear stress, or dissipation, across phase boundaries.

Temperature, can have an impact, and in some embodiments a significant impact on the kinetics of coalescing and break-up phenomena, and consequently the particle size distribution can depend on temperature, and it is theorized can be temperature depending in several ways.

It should also be noted that temperature can have an effect on cure rate, and the degree of cure, for polysilocarb precursor formulations.

Viscosity is typically a function of temperature, and different materials can have different magnitudes of change in viscosity associated with a given temperature change. Consequently, the independent viscosities, and relative viscosities, of the dispersed and continuous phases can be altered by temperature and impact droplet size.

The temperature reflects an average kinetic energy of the system. Most especially, in some embodiments, e.g., for small particles, this can directly impact Brownian motion of the particles leading to enhanced coalescence rate due to higher average kinetic energies to overcome kinetic barriers established by surfactants. Specifically, per the figure above, if the energy barrier ΔG is larger than a few kT (where k is Boltzmann's constant and T is the temperature), then coalescence in kinetically inhibited. However, as temperature (T) is increased, the magnitude of the required barrier is additionally increased.

The adsorption of surfactants to the surfaces of particles is often temperature dependent (as a consequence of the temperature dependence of activity). Typically, the adsorption is increased for higher temperatures, leading to thicker steric shells, though this can be system dependent. The impact of temperature on surfactants that are electrostatically active tends to be less negative than on systems which rely on steric mechanisms.

Diffusion is also temperature dependent (for thermally activated diffusion mechanisms) and consequently Ostwald Ripening can generally be enhanced with higher temperatures.

Nucleation rate varies with temperature. For emulsion polymerization processes, the nucleation of particles can be greatly enhanced at higher temperatures, thus reducing average particle size.

Because temperature impacts particle sizes in isothermal systems, the effects of temperature variation on particle distribution should be considered.

Generally, in embodiments, an increase in temperature leads to larger average particle sizes. Thus, in some embodiments, this variation as a function of time can result in a less monodisperse batch of particles.

Further, it has been empirically demonstrated that non-isothermal emulsifications tend to have steeper transients when compared to isothermal systems. Higher temperatures reduce the viscosity of the dispersed phase, thus lowering the interfacial tension and enhancing break-up. However, the impact of temperature on coalescent phenomena in general in embodiments, can overwhelm the initial benefits at longer time intervals.

The impact of temperature is highly system dependent, and thus it should be recognized that these temperature effects, as well as, other temperature effects may be present to a greater or lessor extent, in various embodiments of emulsion systems. For example, temperature effects, should be balanced against the effect temperature may have on cure rate, and in particular the cure rate of polysilocarb precursor formulations.

A variety of factors can influence the temperature of a system. For example, some typical factors are the energetic dissipation from the homogenizer and exothermic polymerization reactions. It should be noted that the effect of exothermic reaction generally becomes a greater factor as the concentration of dispersed phase increases.

Volume fraction of the dispersed phase can impact the system, variations of the following can lead to a reverse emulation, in which case the disperse phase and continuous phase are reversed. Typically, large volume fractions can, among other things, induce non-Newtonian viscous effects, enhance viscosity, lead to temperature variation for exothermic systems, increase coalescence probability, reduce the ultimate efficacy of surfactants, and combinations and variations of these. In most embodiments, the impact of volume fraction on particle size tends to be negative—the larger the volume fraction the larger the average particle size.

In general these theories and explanations are applicable to systems of solid and liquid dispersions within a liquid continuous phase. Thus, they find applicability across a wide range of PDC precursors. For polysilocarb precursors, the liquid dispersion is cured into a solid preferably in the liquid continuous phase. Thus, in this transition from liquid to solid, distinctions in some embodiments may arise, and will primarily relate to rheological considerations of the particle during collisional coalescence and particle breakup, among other factors.

As droplets form a skin and are recalculated through the mechanical emulsification mixer they may beak-up and form smaller non uniform particles.

Several aspects of viscosity evolution should be considered in determining the final particle size. As the polymerization or cure proceeds, the viscosity of the droplet increases. Further, it is theorized that in some embodiments an initial skin of cured material is formed first. These, and other changes occurring during curing, (e.g., transition for liquid state to semi-solid or solid state) leads to the modification of break-up and coalescent phenomena under the above principles. And example of one effect that may arise, is seen should the cure-time be substantial, inducing gradual viscous evolution, the steady state particle distribution size may creep. The emulsion may lose stability and coalesce.

The adsorption characteristics of a surfactant on the surface of a dispersed phase may vary between the polymerized solid and the monomer liquid. Consequently, the steric or electrostatic repulsive properties of the surfactant may be modified as a function of the degree of cure. This could potentially result in post-cure agglomeration. Surfactants that function both for the monomer liquid and polymer solid are thus preferred.

Another example, of these effects, relates to the factor that typically solids aggregate by different mechanism than liquids coalesce. Specifically, they adhere without a necessary reduction in surface area. This means that aggregation kinetics can vary, and in some embodiments vary strongly, from the liquid phase. A liquid-liquid emulsion may be stable yet the solid-liquid emulsion may naturally aggregate. Or may aggregate depending on the rate, and degree of cure, e.g., the cohesion of the initially cured solids, or skins on the solids.

Additionally, the tendency of solids to flocculate generally should also be considered. Typically, all other factor being the same, higher-density solid phase will naturally aggregate at the bottom of a reactor due to gravity should insufficient flow be present in the system. Once aggregated, Van-der-Waals forces may adhere the flocculate with enough force to require high shear to achieve the desired powder size distribution. Further, it is noted that in generally, as the size of the suspended liquid is reduced into the submicron range surface energy of the liquid droplet or cured droplet (solid) phases becomes increasingly important, as the surface area/gram increases. Minimization in system energy occurs through reduction in surface area through preferably a mechanism to minimize the particle/solvent surface energy.

Many embodiments and processes in droplet break-up and coalescence are kinetic in nature, and thus, have rates associated with them. As such, the impact that time-dependency has on emulsion systems is a factor that generally should be evaluated, utilized and considered.

Typically, systems have a characteristic time associated with reaching steady state (for static thermodynamic conditions without polymerization). Factors influencing this include, for example, diffusive transfer, eddy formation, break-up kinetics and combinations and variations of these.

In many embodiments, and having all other factors generally constant, the evolution of particle size to the steady state can be, or behave as a time constant.

Surfactant adsorption can also be time dependent. “Quickly Adsorbing” surfactants adsorb readily due to, for example, thermodynamic or kinetic reasons. The impact of having quickly or slowly adsorbing species is a factor in determining the final particle size distribution. This can be understood by recognizing that once adsorbed, surfactant molecules, generally, do not permanently adhere to the surface of the droplet. Rather, they are continuously exchanged with the continuum. This typically occurs during events where the geometry is altered, such as collision or break-up. If the surfactant is not readily readsorbed, coalescence may occur.

For dispersions with diameters less than approximately 1 micron, additional physics can be taken into account that can further impact particle size distribution and polymerization kinetics. At these smaller particle sizes, the curvature is substantial, which has an impact on the Free Energy of the system. This can affect the adsorption probabilities of surfactants, as well as, the polymerization kinetics of the curing reaction, among other things. Both effects typically are dependent upon and may vary with different precursors and systems.

Generally, from lab to large industrial scale production, (e.g., hundreds, thousands, and hundreds of thousands of pounds per day) of proppants, beads, ribbons and particles, of various sizes and shapes, but preferably spherical, can be accomplished with solution forming systems. Systems of this type can, among other things, be used to make cured volumetric shapes, such as beads and particles, which may be used for example as pigments, as proppants in hydraulic fracturing, in hydrocarbon production, to provide high and ultra pure (e.g., >5 nines pure, >6 nines pure) SiOC, for example, as a source material to make high purity SiC and related electronic applications.

Typically, these systems require only minimal components, provide the ability to make large amounts of particles, beads, and proppants having, and if desired having very high uniformity, e.g., size distribution, for example, at least about 70% or more of the particles size distribution is within 5% size range, at least about 80% or more of the particles size distribution is within a 5% size range, at least about 90% or more of the particle size distribution is within a 5% size range. These narrow distributions can be obtained unfiltered, or unsieved, i.e., without the need for filtering, sieving or post processing.

In general, these systems have a vessel, which preferably is temperature controlled. The vessel can be, for example a tank, vat, trough, channel, and other shapes and types of structures, having a capacity of about 1 gallon or less, to 100 gallons or more, to 1,000 gallons, and larger. The vessels hold a liquid in which the precursor batch is formed into a volumetric shape and then cured. The liquid in the vessel can be any liquid, (this liquid has been referred to as the continuum, continuous phase, and may also be referred to as the forming liquid, unless specified otherwise all such terms are interchangeable) that permits the formation of discrete volumetric shapes of the precursor in the forming liquid. For PDC precursors formulations the forming liquid is preferably water, distilled water, deionized water, but could also be polar liquids, non-polar liquids, alcohols, and combinations and variations of these. Preferably for polysilocarb precursor formulations, an embodiment of the forming liquid is deionized water with reduced oxygen content (e.g., dissolved O₂), for example, preferably less than about O₂, less than about 10 ppm O₂, less than about 5 ppm O₂, less than about 1 ppm O₂, and less than about 0.1 ppm O₂. In some embodiments and for some precursor formulations higher O2 content may be used, such as for example 20 ppm, 50 ppm, 100 ppm, and 300 ppm and more. The forming liquid can also have, and preferably does have, a surfactant. Further, in conjunction with, or independent, from surfactants, other techniques or methodologies can be utilized, such as variations in pH, ionic strength and/or conductivity of the water. As well as, for example, additives to the continuous phase, such as rheology modifiers, thinning agents, defoamers, inhibitors, additional catalysts, reactive diluents, etc., can also be used. The surfactant can be any type of surfactant that has polar and non-polar functionalities. For example, in polysilocarb-water systems the surfactants can be Mono and diglycerides (e.g. ATMOS 300, ARLACEL 165), Sorbitan Fatty Acid Esters (e.g. SPAN 20, Span 80), Polyoxyethylene sorbitan fatty acid esters (e.g. Tween 80, Tween 61), Polyoxyethylene sorbitol esters (ARLATONE T, ATLAS GN-1441), Polyoxyethylene Acids (MYRJ 52, MYRJ 45), Polyoxyethylene alcohols (BRIJ 72, BRIJ 58, Renex 36), and Ionic Surfactants (sodium lauryl sulfate, Atlas GN-263). Generally, for cost and purity reasons, as little surfactant as is need should preferably be utilized. Generally, surfactants can be used in concentrations from about 0.1% surfactant to forming liquid (e.g., water) and more, 0.5% and more, 1% and more, 5% and more and 7.5% and more. The surfactant may also be added into the precursor formulation, be in the forming liquid and both. The same or different surfactants may be used in the precursor and forming liquid.

Surfactant may be added to the continuous phase in a continuous or batch process. The surfactant-continuous phase mixture may be recirculated and as particles or beads cure and are removed, additional surfactant is added to the continuous phase to replace surfactant lost on the cured particles.

Preferably, the forming liquid temperature is controlled, for example, by heating and cooling devices associated with the vessel. The temperature of the liquid should be controlled to address, among other things, any exotherms, and to enhance bead formation, and uniformity. Preferably, the forming liquid is, at atmospheric pressure (and more preferably with the surface being under an inert atmosphere), with its temperature being maintained from about 80° C., to about 90° C., to less than 100° C. Generally, the volumetric shapes, e.g., beads, are formed and cured to a greater or lessor degree in the forming liquid. By way of illustration, beads will be used as the volumetric shape, it being understood that this is without limitation to the forming of other types of volumetric shapes, and that the following is applicable to such other shapes. The beads may only be partially cured in the forming liquid, and later or subsequent curing prior to pyrolysis may take place, or as a preliminary step in pyrolysis. Depending upon the precursor formulation, storage of the partially cured, and cured beads should preferably be under reduced oxygen and held at cooler temperatures.

Mixing preferably is provided to agitate the forming liquid, provide shear to the precursor, and control among other things, particle size, coalescence, temperature uniformity, and size distribution. The precursor can be added to the liquid in various manners, from simple pouring through air, to injection nozzles located under the surface of the atmosphere, sparges, screens, distribution headers, droplets generated in a gas (e.g., the atmosphere) and then falling on to the surface of the continuous phase and combinations and variations of these and other apparatus and methods to introduce the precursor into the forming liquid. There may be a single precursor introduction device, two, three, four, tens, hundreds and more, and each precursor introduction device may have multiple introduction ports or openings, depending upon, among other things, the size of the system, the desired rate of production, rate of cure, intended particle size, intended size distribution, and other factors.

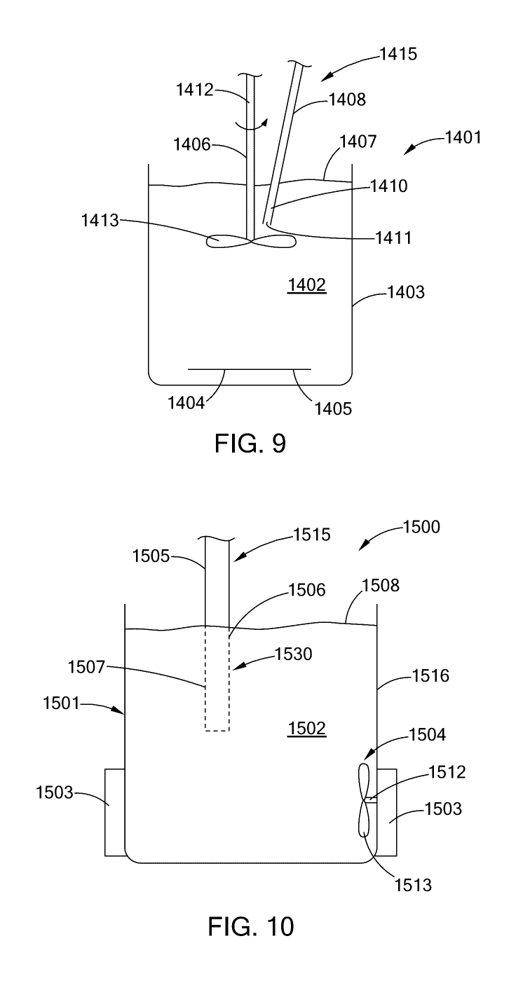

Turning to FIG. 9 there is shown a schematic of an embodiment of a type of solution formation system and process. This system may be used for batch and continuous production of cured beads. The solution formation system 1401 has a vessel 1403 that contains a forming liquid 1402. The forming liquid 1402 has a surface 1407, which as an atmosphere above it. The forming liquid, for example can be deionized water, with at about 1% surfactant, and preferably less than about 15 ppm O₂, less than about 10 ppm O₂, less than about 5 ppm O₂, less than about 1 ppm O₂, and less than about 0.1 ppm O₂.

The vessel 1403 has a temperature control apparatus 1404 having control and power cable 1405. It being understood that the temperature control apparatus can be in the vessel, as shown, located anywhere within the vessel, in the walls of the vessel, external to the vessel, on fluid inlet lines, on storage tanks, and combinations and variations of these. The vessel has an agitator 1406 located within the vessel 1403, the agitator has a drive member 1412, e.g., a drive shaft, and an impeller 1413. The agitator impeller 1413 is located below the surface 1407 of the liquid 1402 and near to the opening 1411 for the nozzle 1410 for the in-feed line 1408, e.g., the precursor introduction device 1415.

The precursor introduction device 1415, can have for example, an in feed line 1408, a nozzle 1410, that forms an opening 1411 for introduction of the precursor into the forming liquid 1402 below the surface 1407. The introduction device can have multiple in feed lines, these lines can be within the walls of the vessel, and thus, in essence form an opening in the walls of the vessel for introduction into the liquid. The vessel wall introduction openings can be on the sidewalls, bottom and both, of the vessel. A single in feed line may have one, two, three or more openings associated with it. The in feed lines are connected to the make up, holding or other handling facilities for the polymer. It should be noted that in general, when the precursor is in the in feed line it has been catalyzed. Although in some embodiments the addition of the catalysis could take place in other locations, such as for example in an inline mixer located in the in feed line.

It being understood that the agitator can be located in other positions relative to the forming liquid surface, the vessel, and the precursor introduction device. There also can be one, two, three or more agitators associated with a vessel. The agitators may be located entirely below the surface of the liquid, and preferably are so located, to minimize the entrainment of gas at the drive shaft surface interface. The agitators may be located at different levels, and when multiple agitators are used, for example, one may positioned adjacent to the precursor introduction device, and others may be removed from that device. The agitators may be operated at different speeds, for different periods of time and combinations and variations of these during a forming process, to facility particle formation, particle size distribution and curing, to name a few parameters and affects.

Turning to FIG. 10 there is shown a schematic of an embodiment of a type of solution formation system and process. The solution formation system 1500 has a vessel 1501 that contains a forming liquid 1502. The forming liquid 1502 has a surface 1508, which as a media above it. (Note that while the media is preferably a gas, it can be a liquid phase, a reduced pressure gas, a high pressure gas, a gas at ambient pressure, and a vacuum.) The forming liquid 1502, for example, can be deionized water, with a surfactant.

The vessel 1501 has a temperature control apparatus 1503 that wraps the wall 1516 of the vessel 1501. It being understood that the temperature control apparatus can be external and on the vessel, as shown, located anywhere within the vessel, in the walls of the vessel, on the forming liquid inlet line, in a storage tank, and combinations and variations of these. The vessel has an agitator assembly 1504 located within the vessel 1501, the agitator assembly 1504 has a drive member 1512, e.g., a drive shaft, and an impeller 1513. The entirety of the agitator assembly 1504 is located below the surface 1508 of the forming liquid 1502. It being understood that the agitator can be located in other positions relative to the forming liquid surface, the vessel, and the precursor introduction device.

The precursor introduction device 1515 has an in-feed line 1505 and a distribution assembly 1530. The distribution assembly 1530 has a screen 1506 that has a large number of openings, e.g., 1507, through which the precursor is feed, e.g., pumped, flowed, gravity feed, etc. The diameters of the openings can be used to size the particles, as well as contribute to, and determine the shape of the particles. For example, circular openings, among others, can be used to from spheres. Preferably the screen 1506 and the screen openings, e.g., 1507 are located below the surface 1508 of the forming liquid 1502.

The introduction device can have multiple in feed lines, these lines can be within the walls of the vessel, and thus, feed into a screen in the wall of the vessel for introduction into the forming liquid. The vessel wall introduction openings can be on the sidewalls, bottom and both, of the vessel. There can be one, two, three, four or more of these screen openings in the vessel walls.

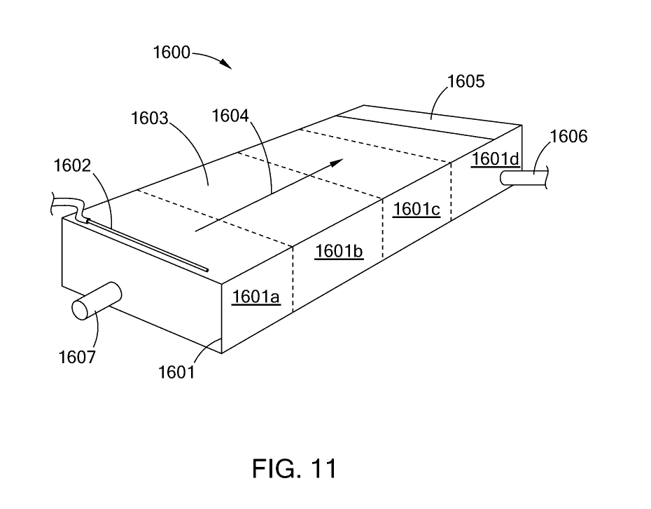

Turning to FIG. 11 there is shown a perspective view of an embodiment of a type of solution formation system and process. This embodiment, preferably, provides for continuous operation. The formation system 1600 has a vessel 1601, which in this case is a rectangular bath. The vessel 1601 has four zones 1601a, 1601b, 1601c, 1601d. The four zones can have the same conditions or different conditions. Thus, the four zones can have different temperatures, surfactant levels, degree of agitation, depth, temperature, flow rate and combinations and variations of these. For example, the first zone 1601a can be set up to have the best conditions for particle formation, and for a predetermined size of particle. The second zone 1601b can have the best conditions for initial curing. The third zone 1601c can have the best conditions to prevent agglomeration during final cure, and the fourth zone 1601d can be a removal or harvesting zone for the cured particles. The vessel 1601 contains a forming fluid 1603 that is flowing in the direction of arrow 1604. The fluid is agitated to a greater or lesser extent depending upon the zone, and the predetermined purpose or function of that zone, as well as other factors. The precursor is added to the forming fluid 1603 via distribution header 1602, which could be a screen, several screens, nozzles, slits, and combinations and variations of these and other devices to introduce precursors. The cured particles are removed from the system by particle removal device 1605, which could be a fine mesh collection system or a screen. A return line 1606 provides for the forming fluid to be returned and feed into the vessel by the inlet line 1607.

In this manner, the particles, e.g., proppant are formed, at or near the distribution header 1602 and are carried by the flowing forming fluid 1603 in the direction of arrow 1604. The various zones of the system 1600 provide the requisite conditions for creating the cured particles, e.g., cured proppant.

If the cured material is to be pyrolized and transitioned into a ceramic, preferably the excess water is removed; and more preferably the material is dry before pyrolysis takes place. To the extent the cured material is stored, it should be stored at less than 150° C., at less than 140° C., and at less than 100° C., preferably it should also be stored in a reduce O₂ atmosphere. Additional curing may also take place after the cured particles are removed from the forming fluid and prior to pyrolysis. This final, or further curing and pyrolysis can take place together, e.g., serially in the same furnace, or can be separate procedures, e.g., different furnaces, storage time between procedures.

Embodiments of the methods that can be practiced using systems like the embodiment of FIGS. 9, 10 and 11, can be used to produce spherical or non-spherical particles from precursors. For aqueous systems it is noted that the temperatures will generally be at, or below the boiling point for water, e.g., 100° C. (at standard temperature and pressure). For higher boiling temperature forming fluids, or increase pressures for aqueous fluids, higher temperatures can be used. In general, these systems can be used with any type precursor that is in liquid form, as long as the precursor does not react with the forming fluid at the processing temperatures, e.g., does not react water at or below 100° C. Typically, embodiments of aqueous systems using polysilocarb precursors can produce particles from about 5 mm diameter down to about 1 micron, although smaller and larger sizes are contemplated. The particles made by these embodiments can have different shapes and would include for example teardrop, spherical, dodecahedral, faceted, as well as other volumetric shapes.

Examples of polysilocarb precursor formulations that can be used in these systems, and in particular aqueous systems, are: 100% MHF; 95% MHF-5% TV; 46% MHF-34% TV-20% VT; 70% MHF-20% TV-10% VT; 75% MHF-15% TV-10% VT; 85/15 MHF/DCPD reaction blend; 70/30 MHF/DCPD reaction blend; and 65/35 MHF/DCPD reaction blend; 60/40 MHF/DCPD reaction blend; and 82/18 MHF/DCPD reaction blend. Additionally, to improve hardness of the cured beads, reduce cure time and both, 1% to 50% TV, 1% to 20% low molecular weight (MW<1000) VT can be added. Catalysis may include, for example 1-20 ppm platinum, dilute base, dilute acid, an amine catalyst, as well as other types of catalysts.

For example to following process parameters can be used to make 500 micron beads, this process can be scaled to larger volumes, which can then be cured to form proppant:
Mix 192 grams of 65/35 HHF/DCPD+8 grams of TV for a minimum of 5 minutes.
Add 1 gram of P01 catalyst and mix thoroughly for a minimum of 10 minutes
Separately, mix 400 grams of De-Ionized water with 4 grams of HLB 9.1 surfactant and stir vigorously with a mechanical stirrer to dissolve the surfactant.
Pour the catalyzed polymer into the water/surfactant mixture and stir with a mechanical stirrer at 100-500 rpm in order to break up the polymer into droplets of the desired size (typically 2-3 minutes of stirring)
Pour the polymer/water/surfactant mixture from above into 1 liter of de-ionized water that has been heated to 63-68° C. and agitate using a low shear agitation method for 45 minutes to 1 hour while keeping the entire batch of material in the range of 45° C. to 50° C.
After the beads have become hard and not sticky, pour off the liquid into a pan or through a set of sieves to separate out the beads and solidified siloxane from the water/surfactant mix
The beads should then be dried and further cured by heating to 50° C.-60° C. for 1-2 hours followed by 80-85° C. for 1-2 hours and a subsequent 1-2 hours at 115° C. to complete the curing.
The beads can then be pyrolized into ceramic.

HLB is the Hydrophile-Lipophile Balance. In general, an HLB number can be assigned to the group of ingredients that are going to be used to form an emulsion, and then a surfactant or blend of surfactants can be selected to match that number. In general, the HLB of an emulsifier is an expression of its Hydrophile-Lipophile Balance, e.g., the balance of the size and strength of the hydrophilic (water-loving or polar) and the lipophilic (oil-loving or non-polar) groups of the emulsifier. Typically, emulsifiers consist of a molecule that combines both hydrophilic and lipophilic groups.

An emulsifier that is lipophilic in character is assigned a low HLB number (below 9.0), and one that is hydrophilic in character is assigned a high HLB number (above 11.0). Those in the range of 9-11 are intermediates.

When two or more emulsifiers are blended, the resulting HLB of the blend is calculated. For example, the HLB value of a blend comprising 70% of TWEEN 80 (HLB=15) and 30% of SPAN 80 (HLB=4.3). The calculation would be:

TWEEN 80 SPAN 80

70%×15.0=10.5

30%×4.3=1.3 HLB of blend=11.8

In general, HLB numbers typically range from 0 to 20 for non-ionic surfactants and can exceed 50 for ionic surfactants. For example in embodiments of the present liquid-liquid systems, surfactants and surfactant combinations or blends can have HLB values from about 2 to about 18, about 5 to about 15, and preferably about 8 to about 12. Other HLP values outside these ranges can be utilized and may be preferred for certain types of precursors.

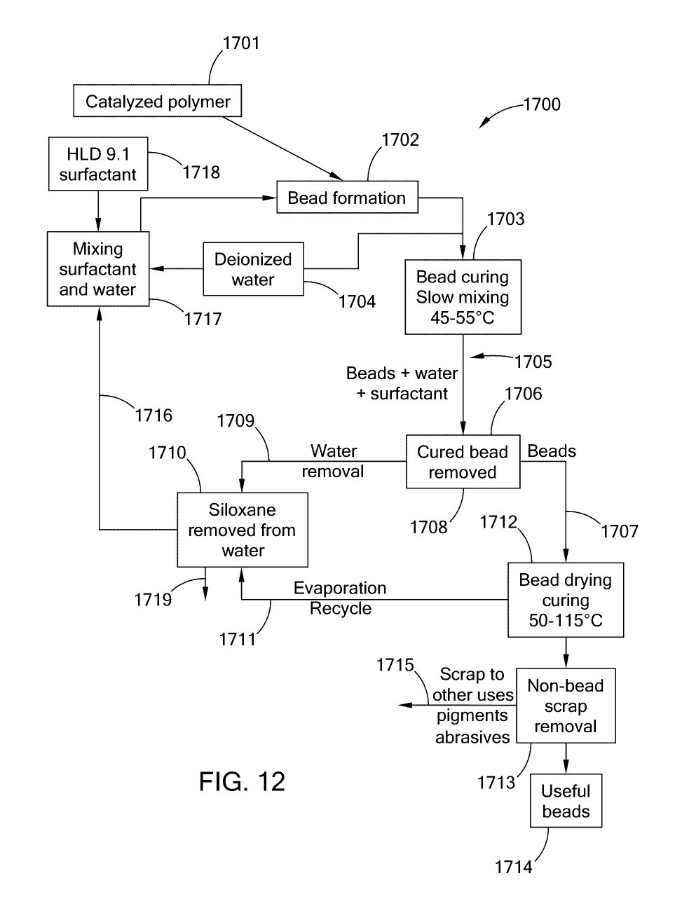

Turning to FIG. 12, there is shown a process flow diagram 1701 for an embodiment of a solution formulation system and process. Thus, the catalyzed precursor 1701 is formed into a bead 1702 the beads are cured 1703 (with slow mixing and a temperature of about 45-55° C.). The beads, water and surfactant are transferred 1705 and the cured beads 1708 are removed 1707. The removed water is transferred 1709, where the siloxane 1719 is removed 1710 from the water, which is returned 1716 to surfactant and water mixing station 1717. The beads are dried and further cured 1712, at about 50-115° C., after which non-bead scrap 1715 (which can be used as or further processed into pigments, abrasives, etc.) is removed 1713, from the use beads 1714. Station 1717 mixes water and surfactant, and has return deionized water 1704 as a water source. Surfactant, for example, HLD 9.1, 1718 is added to the water at station 1717. The water and surfactant are used for bead forming 1702.

The following examples are provided to illustrate various embodiments of polysilocarb precursors formulations, as well as apparatus and methods that can be used to form cured preforms by embodiments of the present forming systems and methods of the present inventions. These examples are for illustrative purposes and should not be viewed as, and do not otherwise limit the scope of the present inventions. The percentages used in the examples, unless specified otherwise, are weight percents of the total batch, preform or structure.

### Example 1

A polysilocarb batch having 75% MH, 15% TV, 10% VT and 1% catalyst (10 ppm platinum and 0.5% Luprox 231 peroxide).

### Example 2

A polysilocarb batch having 70% MH, 20% TV, 10% VT and 1% catalyst (10 ppm platinum and 0.5% Luprox 231 peroxide).

### Example 3

A polysicocarb batch having 50% by volume fly ash is added to a polysilocarb batch having 70% MH, 20% TV, 10% VT and 1% catalyst (10 ppm platinum and 0.5% Luprox 231 peroxide).

### Example 4

40% by volume AL₂O₃ having a diameter of 0.5 μm is added to a polysilocarb batch having 70% MH, 20% TV, 10% VT and 1% catalyst (10 ppm platinum and 0.5% Luprox 231 peroxide).

### Example 5

A polysilocarb batch having 70% of the MH precursor (molecular weight of about 800) and 30% of the TV precursor are mixed together in a vessel and put in storage for later use.

### Example 6

A polysilocarb batch having 70% of the MH precursor (molecular weight of about 800) and 30% of the TV precursor are mixed together in a vessel and put in storage for later use. The polysilocarb batch has good shelf life and room temperature and the precursors have not, and do not react with each other. The polysilocarb batch has a viscosity of about 15 cps. 21% of a silica fume (about 325 mesh) are added to the batch to make a filled polysilocarb batch, which can be kept for later use. Just prior to forming into preform beads by one of the embodiments of the present forming systems, 10 ppm of a platinum catalyst is added to the polysilocarb batch

### Example 7

A polysilocarb batch having 41% MHF and 50% TV with less that 0.1% catalyst.

### Example 8

A polysilocarb batch having 100% TV.

### Example 9

A polysilocarb batch having 10% of the MH precursor (molecular weight of about 800), 73% of the methyl terminated phenylethyl polysiloxane precursor (molecular weight of about 1,000), and 16% of the TV precursor, and 1% of the OH terminated.

### Example 10

A polysilocarb batch having about 70% MH, 20% TV precursor, 10% VT (molecular weight of about 6000), and 1% of the OH terminated precursor.

### Example 11

A polysilocarb batch has 75% MH, 15% TV, 10% VT and a viscosity of about 65 cps. 10 ppm of a platinum and peroxide catalyst mixture is added to this batch prior to forming into preforms.

### Example 12

A polysilocarb batch having 70% of the MH and 30% of the VT having a molecular weight of about 500 and about 42% of a submicron and a 325 mesh silica are mixed together. The polysilocarb batch has a viscosity of about 300 cps.

### Example 13

A polysilocarb batch having 100% TV and less than about 0.5% peroxide catalysis.

### Example 14

A polysilocarb reaction blend batch having 85/15 MHF/DCPD.

### Example 15

A polysilocarb reaction blend batch having 85/15 MHF/DCPD with 1% P01 catalyst and 1% peroxide catalyst.

### Example 16

A polysilocarb reaction blend batch having 85/15 MHF/DCPD with 1% P01 catalyst and 3% TV (which functions as a curie rate accelerator).

### Example 17

A polysilocarb reaction blend batch having 65/35 MHF/DCPD.

### Example 18

A polysilocarb reaction blend batch having 70/30 MHF/DCPD.

### Example 19

A polysilocarb reaction blend batch having 60/40 MHF/DCPD.

### Example 20

A polysilocarb batch having 50-65% MHF; 5-10% Tetravinyl; and 25-40% Diene (Dene=Dicyclopentadiene or Isoprene or Butadiene), preferably catalyzed with P01 or other Platinum catalyst.

### Example 21

A polysilocarb batch having 60-80% MHF and 20-40% Isoprene, preferably catalyzed with P01 or other Platinum catalyst.

### Example 22

A polysilocarb batch having 50-65% MHF and 35-50% Tetravinyl, preferably catalyzed with P01 or other Platinum catalyst.

### Example 23

A polysilocarb reaction blend batch having 85/15 MHF/DCPD, and preferably using P01 and Luperox® 231 catalysts.

### Example 24

A polysilocarb reaction blend batch having 65/35 MHF/DCPD, and preferably using P01 and Luperox® 231 catalysts.

### Example 25

A polysilocarb batch having 46% MHF and 34% TV and 20 VT, with P01 catalyst.

### Example 26

A polysilocarb reaction blend batch having 50/50 MHF/DCPD with 4% TV and 5 ppm Pt catalyst.

### Example 27

Using the reaction type process a precursor formulation was made using the following formulation. The temperature of the reaction was maintained at 61° C. for 21 hours.

| | | | | Moles of | % of Total | | |
|---|---|---|---|---|---|---|---|
| | | % of | | Reactant/ | Moles of | Moles | Moles |
| Reactant or Solvent | Mass | Total | MW | solvent | Silane | of Si | of EtOH |
| Methyltriethoxysilane | 120.00 | 19.5% | 178.30 | 0.67 | 47.43% | 0.67 | 2.02 |
| Phenylmethyldiethoxysilane | 0.00 | 0.0% | 210.35 | — | 0.00% | — | — |
| (FIG. 38) | | | | | | | |
| Dimethyldiethoxysilane | 70.00 | 11.4% | 148.28 | 0.47 | 33.27% | 0.47 | 0.94 |
| Methyldiethoxysilane | 20.00 | 3.3% | 134.25 | 0.15 | 10.50% | 0.15 | 0.30 |
| Vinylmethyldiethoxysilane | 20.00 | 3.3% | 160.29 | 0.12 | 8.79% | 0.12 | 0.25 |
| Trimethyethoxysilane | 0.00 | 0.0% | 118.25 | — | 0.00% | — | — |
| Hexane in hydrolyzer | 0.00 | 0.0% | 86.18 | — | | | |
| Acetone in hydrolyzer | 320.00 | 52.0% | 58.08 | 5.51 | | | |
| Ethanol in hydrolyzer | 0.00 | 0.0% | 46.07 | — | | | |
| Water in hydrolyzer | 64.00 | 10.4% | 18.00 | 3.56 | | | |
| HCl | 0.36 | 0.1% | 36.00 | 0.01 | | | |
| Sodium bicarbonate | 0.84 | 0.1% | 84.00 | 0.01 | | | |

### Example 28

Using the reaction type process a precursor formulation was made using the following formulation. The temperature of the reaction was maintained at 72° C. for 21 hours.

| | | | | Moles of | % of Total | | |
|---|---|---|---|---|---|---|---|
| | | % of | | Reactant/ | Moles of | Moles | Moles |
| Reactant or Solvent | Mass | Total | MW | solvent | Silane | of Si | of EtOH |
| Phenyltriethoxysilane | 234.00 | 32.0% | 240.37 | 0.97 | 54.34% | 0.97 | 2.92 |
| Phenylmethyldiethoxysilane | 90.00 | 12.3% | 210.35 | 0.43 | 23.88% | 0.43 | 0.86 |
| Dimethyldiethoxysilane | 0.00 | 0.0% | 148.28 | — | 0.00% | — | — |
| Methyldiethoxysilane | 28.50 | 3.9% | 134.25 | 0.21 | 11.85% | 0.21 | 0.42 |
| Vinylmethyldiethoxysilane | 28.50 | 3.9% | 160.29 | 0.18 | 9.93% | 0.18 | 0.36 |
| Trimethyethoxysilane | 0.00 | 0.0% | 118.25 | — | 0.00% | — | — |
| Acetone in hydrolyzer | 0.00 | 0.0% | 58.08 | — | | | |
| Ethanol in hydrolyzer | 265.00 | 36.3% | 46.07 | 5.75 | | | |
| Water in hydrolyzer | 83.00 | 11.4% | 18.00 | 4.61 | | | |
| HCl | 0.36 | 0.0% | 36.00 | 0.01 | | | |
| Sodium bicarbonate | 0.84 | 0.1% | 84.00 | 0.01 | | | |

### Example 29

Using the reaction type process a precursor formulation was made using the following formulation. The temperature of the reaction was maintained at 61° C. for 21 hours.

| | | | | Moles of | % of Total | | |
|---|---|---|---|---|---|---|---|
| | | % of | | Reactant/ | Moles of | Moles | Moles |
| Reactant or Solvent | Mass | Total | MW | solvent | Silane | of Si | of EtOH |
| Phenyltriethoxysilane | 142.00 | 21.1% | 240.37 | 0.59 | 37.84% | 0.59 | 1.77 |
| Phenylmethyldiethoxysilane | 135.00 | 20.1% | 210.35 | 0.64 | 41.11% | 0.64 | 1.28 |
| Dimethyldiethoxysilane | 0.00 | 0.0% | 148.28 | — | 0.00% | — | — |
| Methyldiethoxysilane | 24.00 | 3.6% | 134.25 | 0.18 | 11.45% | 0.18 | 0.36 |
| Vinylmethyldiethoxysilane | 24.00 | 3.6% | 160.29 | 0.15 | 9.59% | 0.15 | 0.30 |
| Trimethyethoxysilane | 0.00 | 0.0% | 118.25 | — | 0.00% | — | — |
| Acetone in hydrolyzer | 278.00 | 41.3% | 58.08 | 4.79 | | | |
| Ethanol in hydrolyzer | 0.00 | 0.0% | 46.07 | — | | | |
| Water in hydrolyzer | 69.00 | 10.2% | 18.00 | 3.83 | | | |
| HCl | 0.36 | 0.1% | 36.00 | 0.01 | | | |
| Sodium bicarbonate | 0.84 | 0.1% | 84.00 | 0.01 | | | |

### Example 30

Using the reaction type process a precursor formulation was made using the following formulation. The temperature of the reaction was maintained at 72° C. for 21 hours.

| | | | | Moles of | % of Total | | |
|---|---|---|---|---|---|---|---|
| | | % of | | Reactant/ | Moles of | Moles | Moles |
| Reactant or Solvent | Mass | Total | MW | solvent | Silane | of Si | of EtOH |
| Methyltriethoxysilane | 0.00 | 0.0% | 178.30 | — | 0.00% | — | — |
| Phenylmethyldiethoxysilane | 0.00 | 0.0% | 210.35 | — | 0.00% | — | — |
| Dimethyldiethoxysilane | 56 | 7.2% | 148.28 | 0.38 | 17.71% | 0.38 | 0.76 |
| Methyldiethoxysilane | 182 | 23.2% | 134.25 | 1.36 | 63.57% | 1.36 | 2.71 |
| Vinylmethyldiethoxysilane | 64 | 8.2% | 160.29 | 0.40 | 18.72% | 0.40 | 0.80 |
| Triethoxysilane | 0.00 | 0.0% | 164.27 | — | 0.00% | — | — |
| Hexane in hydrolyzer | 0.00 | 0.0% | 86.18 | — | | | |
| Acetone in hydrolyzer | 0.00 | 0.0% | 58.08 | — | | | |
| Ethanol in hydrolyzer | 400.00 | 51.1% | 46.07 | 8.68 | | | |
| Water in hydrolyzer | 80.00 | 10.2% | 18.00 | 4.44 | | | |
| HCl | 0.36 | 0.0% | 36.00 | 0.01 | | | |
| Sodium bicarbonate | 0.84 | 0.1% | 84.00 | 0.01 | | | |

### Example 31

Using the reaction type process a precursor formulation was made using the following formulation. The temperature of the reaction was maintained at 61° C. for 21 hours.

| | | | | Moles of | % of Total | | |
|---|---|---|---|---|---|---|---|
| | | % of | | Reactant/ | Moles of | Moles | Moles |
| Reactant or Solvent | Mass | Total | MW | solvent | Silane | of Si | of EtOH |
| Phenyltriethoxysilane | 198.00 | 26.6% | 240.37 | 0.82 | 52.84% | 0.82 | 2.47 |
| Phenylmethyldiethoxysilane | 0.00 | 0.0% | 210.35 | — | 0.00% | — | — |
| Dimethyldiethoxysilane | 109.00 | 14.6% | 148.28 | 0.74 | 47.16% | 0.74 | 1.47 |
| Methyldiethoxysilane | 0.00 | 0.0% | 134.25 | — | 0.00% | — | — |
| Vinylmethyldiethoxysilane | 0.00 | 0.0% | 160.29 | — | 0.00% | — | — |
| Trimethyethoxysilane | 0.00 | 0.0% | 118.25 | — | 0.00% | — | — |
| Acetone in hydrolyzer | 365.00 | 49.0% | 58.08 | 6.28 | | | |
| Ethanol in hydrolyzer | 0.00 | 0.0% | 46.07 | — | | | |
| Water in hydrolyzer | 72.00 | 9.7% | 18.00 | 4.00 | | | |
| HCl | 0.36 | 0.0% | 36.00 | 0.01 | | | |
| Sodium bicarbonate | 0.84 | 0.1% | 84.00 | 0.01 | | | |

### Example 32

Using the reaction type process a precursor formulation was made using the following formulation. The temperature of the reaction was maintained at 72° C. for 21 hours.

| | | | | Moles of | % of Total | | |
|---|---|---|---|---|---|---|---|
| | | % of | | Reactant/ | Moles of | Moles | Moles |
| Reactant or Solvent | Mass | Total | MW | solvent | Silane | of Si | of EtOH |
| Phenyltriethoxysilane | 180.00 | 22.7% | 240.37 | 0.75 | 44.10% | 0.75 | 2.25 |
| Phenylmethyldiethoxysilane | 50.00 | 6.3% | 210.35 | 0.24 | 14.00% | 0.24 | 0.48 |
| Dimethyldiethoxysilane | 40.00 | 5.0% | 148.28 | 0.27 | 15.89% | 0.27 | 0.54 |
| Methyldiethoxysilane | 30.00 | 3.8% | 134.25 | 0.22 | 13.16% | 0.22 | 0.45 |
| Vinylmethyldiethoxysilane | 35.00 | 4.4% | 160.29 | 0.22 | 12.86% | 0.22 | 0.44 |
| (FIG. 40) | | | | | | | |
| Trimethyethoxysilane | 0.00 | 0.0% | 118.25 | — | 0.00% | — | — |
| Hexane in hydrolyzer | 0.00 | 0.0% | 86.18 | — | | | |
| Acetone in hydrolyzer | 0.00 | 0.0% | 58.08 | — | | | |
| Ethanol in hydrolyzer | 380.00 | 48.0% | 46.07 | 8.25 | | | |
| Water in hydrolyzer | 76.00 | 9.6% | 18.00 | 4.22 | | | |
| HCl | 0.36 | 0.0% | 36.00 | 0.01 | | | |
| Sodium bicarbonate | 0.84 | 0.1% | 84.00 | 0.01 | | | |

### Example 33

A polysilocarb formulation has 95% MHF and 5% TV.

### Example 34

A polysilocarb formulation has 90% MHF, 5% TV, and 5% VT.

### Example 35

A polysilocarb formulation has 0-20% MHF, 0-30% TV, 50-100% H62 C and 0-5% a hydroxy terminated dimethyl polysiloxane.

### Example 36

A polysilocarb formulation has 40% MHF, 40% TV, and 20% VT and has a hydride to vinyl molar ratio of 1.12:1, and may be used as to form strong ceramic beads, e.g., proppants for use in hydraulically fracturing hydrocarbon producing formations.

### Example 37

A polysilocarb formulation has 42% MHF, 38% TV, and 20% VT and has a hydride to vinyl molar ratio of 1.26:1, and may be used as to form strong ceramic beads, e.g., proppants for use in hydraulically fracturing hydrocarbon producing formations.

### Example 38

A polysilocarb formulation has 55% MHF, 25% TV, and 20% VT and has a hydride to vinyl molar ratio of 2.36:1, and may be used as to form strong ceramic beads, e.g., proppants for use in hydraulically fracturing hydrocarbon producing formations.

### Example 39

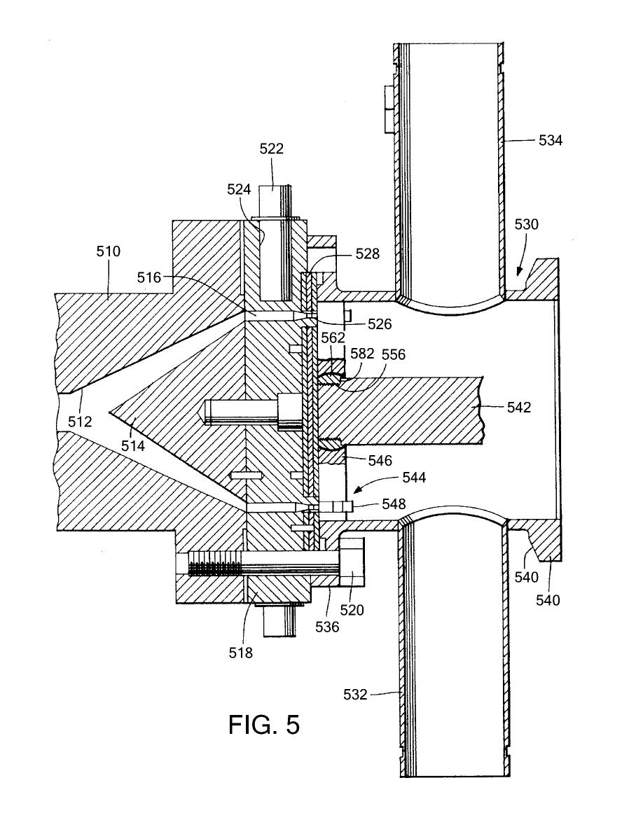

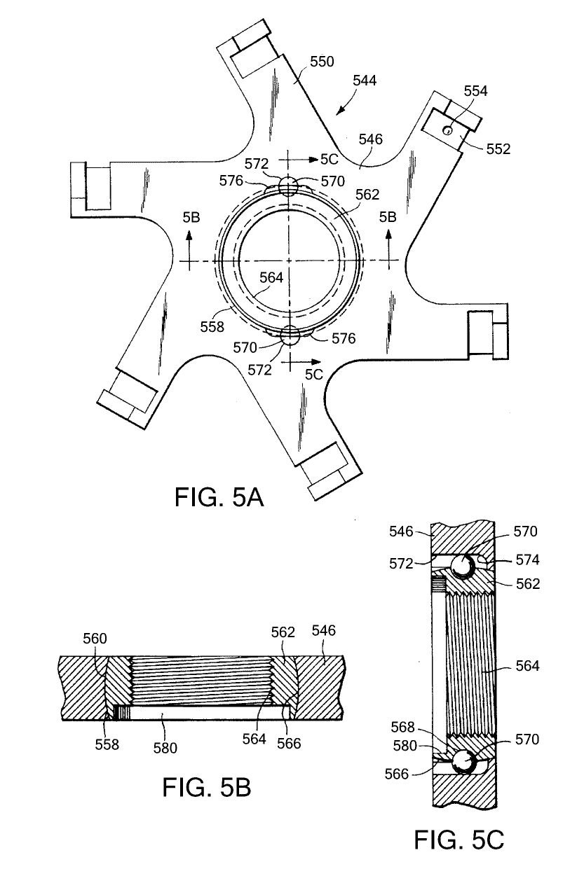

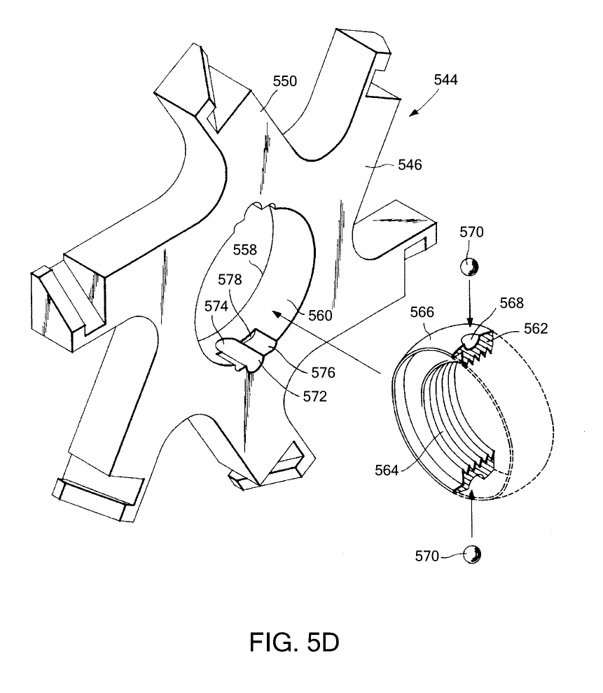

Referring now to the embodiment in FIGS. 5 to 5D, which is an apparatus for use in practicing the present methods of forming PDC materials into volumetric shapes. FIG. 5 illustrates an underwater pelletizer structure with the self-aligning hub. The pelletizer includes an inlet housing 510 including an inlet passageway 512 for receiving liquid PDC precursor from upstream equipment. The liquid PDC precursor is diverted outwardly by a nose cone 514 and enters into a plurality of extrusion orifices 516 in a die plate 518. The die plate 518 is secured to the inlet housing by fastening bolts or the like 520 and is provided with heating elements 522 located in cavities 524 in the die plate. The die plate includes a die face 526 of wear resistant material, which is mounted on the die plate along with heat transfer plates 528, Attached to the housing and die plate is a cutter chamber generally designated by reference numeral 530 which includes a water circulating inlet passageway 532 and a discharge passageway 534 for water and pellets. The cutting chamber includes a flange 536 attached to the die plate and housing and a flange 538 at the opposite end thereof having an inclined surface 540 for association with a similar flange on an adapter connected to a drive unit. A drive shaft 542 extends through the cutter chamber 530 and supports and drives a cutter assembly 544, which includes a hub 546 and a plurality of cutter knives 548 having their cutting edge associated with the die face 526 and the discharge point of the orifices 516. The hub 546 and the manner in which it is attached to the drive shaft 542 and supported therefrom for self-alignment of the hub and thus the cutting elements 548 with the die face 526 is illustrated in the figures.

As illustrated in FIG. 5A, the cutter assembly 544 includes a plurality of arms 550 having notches 552 which receive the cutter blades that are secured by the use of conventional fasteners threaded into threaded bores 554 as is well known in the art. The arms 550 are integral with the central hub 546 which is connected to a reduced externally threaded end portion 556 on the drive shaft 542. The hub 546 is provided with an axial bore 558 extending therethrough and which has an inner face that is partially spherical as indicated by reference numeral 560 and as illustrated in FIGS. 5B and 5D. Positioned in the bore 558 is an adapter 562 having an internally threaded bore 564 extending therethrough for threading onto the threaded reduced end 556 of the shaft 542. The exterior surface of the adapter 562 is partially spherical as indicated by reference numeral 566 and as shown in FIGS. 5B to 5D with the curvature of the partially spherical surfaces 560 and 566 matching or corresponding and closely associated as illustrated in FIG. 5B with the diameter of the partially spherical surfaces at the end edges thereof being less than the diameter at the central portions of the partially spherical surfaces.

The partially spherical exterior surface 566 of the adapter 562 is provided with a pair of diametrically opposed generally semispherical recesses 568 oriented equally distant from the end edges of the partially spherical surface 566 as illustrated in FIGS. 5C and 5D. Received in each of the semispherical recesses 568 is a spherical ball 570.

The hub bore 558 includes a pair of diametrically opposed axial, semicylindrical recesses 572 which terminate at their inner ends in adjacent but spaced relation to the opposite end of the bore 558 and terminate in a partially spherical inner end 574. The recesses 572 receive the balls 570 which provide for torque transfer from the shaft 542 and adapter 562 to the hub 546.

In order to assemble the adapter 562 and balls 570 with respect to the bore 558, the bore 558 includes an axial recess 576, which extends circumferentially a short distance from the edges of the recess 572 and terminates at an inner end 578 spaced from the spherical portion 574 of the recess 572. The recesses 576 are provided to enable the partially spherical surface 566 of the adapter 562 to be inserted into the bore when the adapter 562 is oriented in perpendicular relation to the bore as illustrated in FIG. 5D. The balls 570 being placed and retained in the cavities 568 in a suitable manner by the application of grease or the like are inserted into the recesses 572 when the assembled adapter 562 is moved into the bore 558 until the balls 570 reach a central point between the two ends of the bore 58. At this point, the adapter 62 can be rotated 90° into the bore 558 with the partially spherical surfaces 560 and 566 being in close registry as illustrated in FIG. 5B with the curvature of the surfaces 560 and 566 serving to retain the adapter 562 within the bore 558 and retain the balls 570 in the recesses 568 and 572.

The balls 570 transmit driving torque and the surfaces 560 and 566 enable the hub 546 to pivot in a universal direction with respect to the drive shaft thereby enabling the cutter hub and cutter knives 548 to be oriented in parallel closely spaced relation to the die face for efficient cutting of the extruded PDC into pellets. After the adapter has been assembled into the cutter hub from the position illustrated in FIG. 5D to the position illustrated in FIGS. 5A-50, the cutter hub and adapter can be mounted on the drive shaft 542 by engaging the internal threads 564 with the external threads 556 until the axial recess 580 formed in one end of the adapter 562 receives the shoulder 582 on the end of the shaft with the matching spherical surfaces 560 and 566 being oriented slightly outwardly of the periphery of the drive shaft in view of the distance between the periphery of the internal recess 580 and the periphery of the surfaces 566 and 560 radially outwardly thereof. This enables the cutter hub to pivot universally on the adapter 562. The assembled hub and adapter may be manually screw threaded onto the shaft threads 556 to attach or detach the adapter and hub. If necessary, a wooden hammer may be used to lightly tap the hub to tighten or loosen the hub. Further teachings for the embodiment of this example can be found in U.S. Pat. No. 5,264,688, the entire disclosure of which is incorporated herein by reference.

### Example 39A

The polysilocarb precursors of Examples 1 to 38 are used in the equipment of Example 39 to make volumetric shapes. Preferably spherical beads are made.

### Example 39B

The polysilocarb precursors of Examples 1 to 38 are used in the equipment of Example 39 to make the polysilocarb proppants taught and disclosed in US Patent Publication No. 2014/0326453.

### Example 40

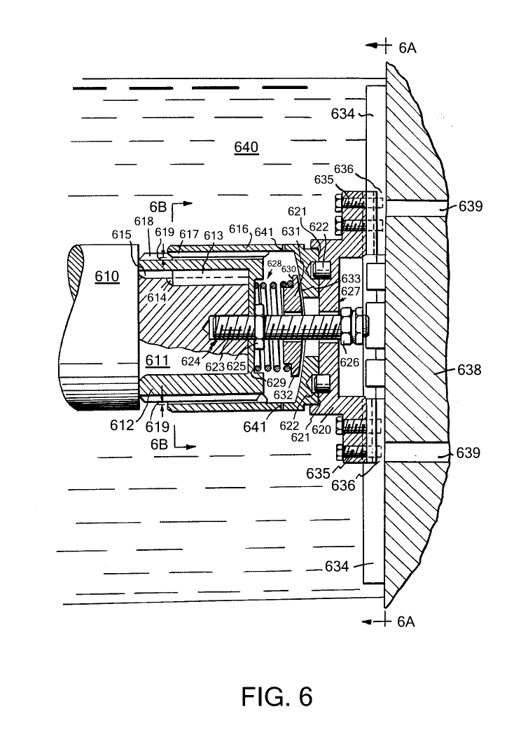

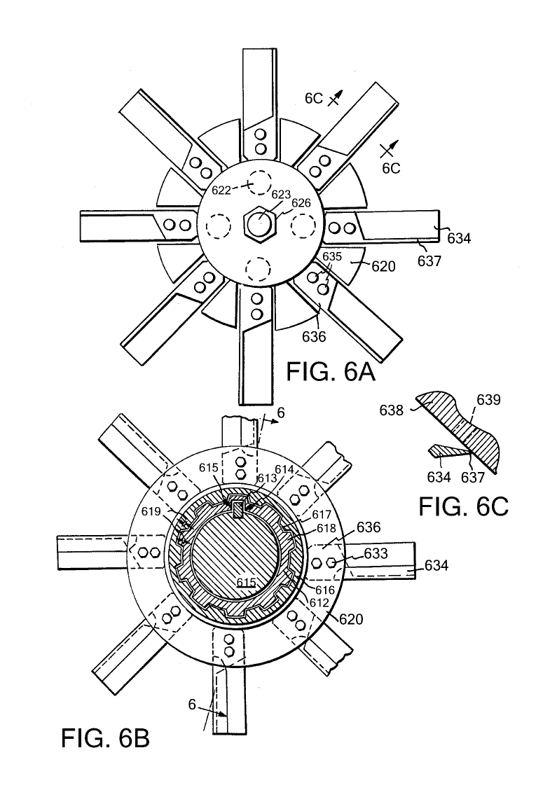

The process for extruding and cutting a partially cured, cured, or liquid PDC formulation into the form of discrete pellets or granules, can be accomplished with the aid of the hybrid liquid-mechanical cutter apparatus of the embodiment shown in FIGS. 6 to 6C. In this embodiment there is provided continuous extrusion of strands of the PDC formulation through one or more orifices, formed in a planar die face, directly into a curing liquid, and cutting the extruded strand(s) within the curing liquid into pellets or granules as the latter are undergoing solidification.

This embodiment of a rotary hybrid liquid-mechanical cutter apparatus can be used for producing pellets from a strand or strands of a partly liquid PDC formulation in cooperation with an extrusion die, having a planar die surface intersected by one or more extrusion orifices. Turning to FIGS. 6-6C there is shown therein a portion of the rotating drive shaft 610 which is provided with a reduced portion 611. The rotational movement of the reduced portion of the drive shaft 611 is transmitted to an inner cap member 612 by means of a connecting key 613, which is positioned in a keyway formed by axially aligned, corresponding slots 614 and 615 in the reduced portion of the drive shaft 611 and in the inner cap member 612, respectively. One alternate structure is to make members 610, 611, and 612 into one integral piece thereby eliminating key 613 and slots 614 and 615. The rotational movement of the inner cap member 612 is in turn transmitted to an outer sleeve member 616 by means of a relatively loose fitting of a plurality of circumferentially spaced and axially extended splines 617 located on the interior periphery of the outer sleeve member 616 with a corresponding plurality of circumferentially spaced and axially extended splines 618 located on the exterior periphery of the inner cap member 612. The looseness of this fit is indicated by radial clearance 619 between the outermost surfaces of the respective splines of one member and the corresponding innermost surfaces of the other member. This splined connection between the members allows axial and angular movement of the outer sleeve member 16 and the knife holder assembly 620. The knife holder assembly 620 is secured to the outer sleeve member 616 by frictional engagement at 621 and by dowel pins 622, thus allowing transmission of the rotational movement from the outer sleeve member 616 as well as the above-mentioned axial and angular movement to the knife holder assembly 620. An alternative structure is to make member 616 and assembly 629 from one integral piece thereby eliminating dowel pins 622. A stud bolt 623, which is threadably received into a recess 624 formed in the reduced part of the drive shaft 611, is provided with two hexagonal nuts 625 and 626. A jam nut 625 holds the inner cap member 612 tightly against the reduced portion of the drive shaft 611. An outer stop nut 626 is positioned against the outer face 627 of the knife holder assembly 618 and can be adjustably positioned to pre-load the helical spring 628. The helical spring 628 is positioned between the flat face of the inner cap member 629 and that of the washer 630. The washer 631 is provided with a convex spherical face 632, which engages with the concave inner face 633 of the outer sleeve member 616. The knife holder assembly 620 which is held firmly against the stop nut 626 by virtue of spring tension transmitted by the washer 630 and the outer sleeve member 616, is mounted around the stud bolt 623 and possesses a number of circumferentially spaced and radially extending knife elements 634. The knife elements 634 are secured in place by any suitable means, e.g. by threaded bolts 635, in the ends 636 of the knife holder assembly 620. The edges 637 of the knife elements 634 are positioned adjacent to the die face 638 and the extrusion orifices 639 and rotate in a plane parallel to the planar die face 638.

FIG. 6 shows the entire hybrid liquid-mechanical cutter assembly submerged in a curing liquid 640 with ports 641 provided in the outer sleeve member for ready flow-through of the curing liquid 640. Before operating the apparatus the helical spring is pre-loaded by tightening the stop nut 626. The drive shaft is then moved toward the die face until knife element-to-die face contact occurs. Further movement of the drive shaft moves the outer face of the knife holder assembly away from the stop nut, thus causing the edges of the knife elements to be held against the die face by the joint action of the spring force and, when a curing liquid is used, the spring force may be complemented by the hydraulic force generated by the rotational movement of knife elements 634, set at an angle to the direction of travel as the elements move through the curing liquid 640. A predetermined amount of knife and die wear is thereby provided before the knife holder assembly again engages the stop nut which prevents further knife movement toward the die. Further teachings for the embodiment of this example can be found in U.S. Pat. No. 3,196,487 the entire disclosure of which is incorporated herein by reference.

### Example 40A

The polysilocarb precursors of Examples 1 to 38 are used in the equipment of Example 40 to make volumetric shapes. Preferably spherical beads are made.

### Example 40B

The polysilocarb precursors of Examples 1 to 38 are used in the equipment of Example 40 to make the polysilocarb proppants taught and disclosed in US Patent Publication No. 2014/0326453.

### Example 41

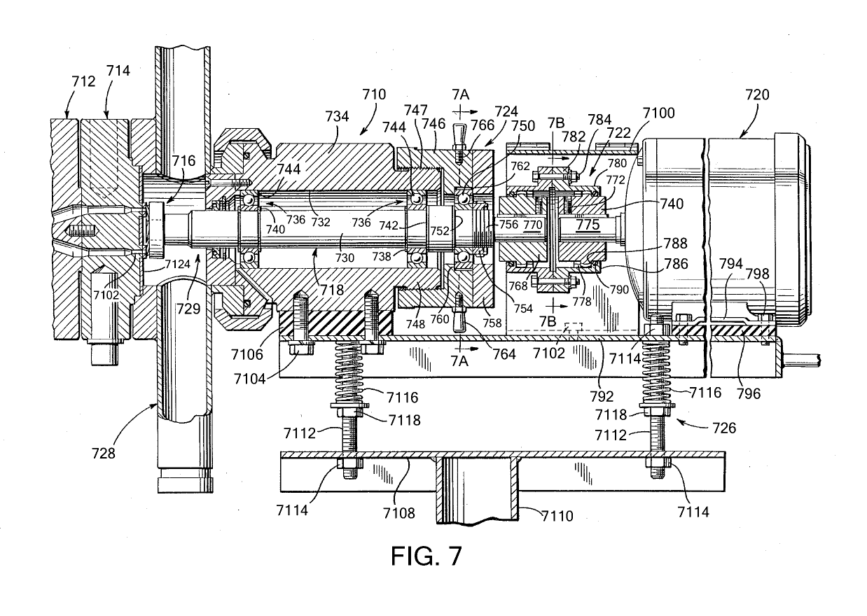

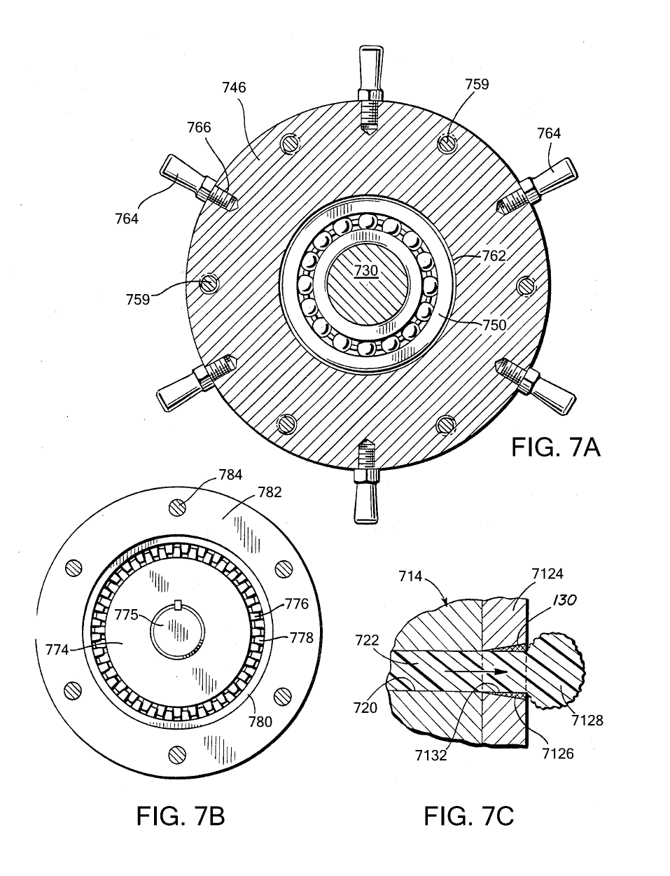

Turning to FIGS. 7 to 7C, there is shown an embodiment of an apparatus for use in practicing the present methods form PDC materials into volumetric shapes. In this embodiment the underwater pelletizer is generally designated by reference numeral 710 and includes a transition device 712 including a die plate 714 associated with a cutting blade assembly 716 supported and driven by a shaft assembly 718 drivingly connected to a motor 720 through a coupling 722 with the position of the cutting blade assembly being adjusted by an adjustment mechanism 724 and a support structure 726 is provided for supporting the motor, shaft assembly and cutting blade assembly. A water circulating passageway assembly 728 is provided for supplying water to a water box or container 729 enclosing the cutter blade assembly 16 and the die face on the die plate 714. The shaft assembly 718 includes a generally cylindrical elongated rigid shaft member 730 oriented axially within the hollow interior 732 of a housing 734 with the shaft member 730 being rotatably supported by a pair of longitudinally spaced ball bearing assemblies 736 each of which includes an inner race 738 secured to the shaft member 730 in an immovable manner such as by retaining rings 740 securing the bearing assembly 736 remote from the motor 720 and a retaining ring 740 and shoulder 742 on the shaft member 730 securing the outer bearing assembly 736 to the shaft member 730. The retaining rings 740 and shoulder 742 secure the inner races 738 of the ball bearing assemblies 736 longitudinally on the shaft member 730. However, the outer races 744 of the ball bearing assemblies 736 are axially slidably or movably disposed in the hollow interior 732 of the housing 734 so that the drive shaft assembly including the cutter blade assembly 716 may be adjusted axially of the housing 734 and the die plate 714 to adjust the position of the cutting blade assembly and compensate for wear.

The adjustment assembly 724 for axially adjusting the shaft assembly 718 includes an internally threaded cup-shaped member 746 which is in screw threaded engagement at 747 with an externally threaded reduced end portion 748 on the housing 734. The cup-shaped member 746 encircles the shaft member 730 and a thrust bearing 750 interconnects the cup-shaped member 746 and the shaft member 730 with the inner race of the thrust bearing 750 engaging a shoulder 752 on the shaft member 730 and being retained against the shoulder 752 by a threaded nut 754 threaded onto a threaded portion 756 of the shaft member 730 to prevent axial movement of the thrust bearing 750 on the shaft member 730. A retaining plate 758 is mounted against the end of the cup-shaped member 746 remote from the threaded engagement with the housing by suitable bolts, cap screws 759 or the like with the retaining plate 758 having an inner opening which overlaps and engages the outer race of the thrust bearing 50 so that the outer race of the thrust bearing 750 is precluded from axial movement in relation to the cup-shaped member 746 by engagement with the retaining plate 758 and a forward shoulder 760 formed in the interior surface of the cup shaped member 746.

As illustrated in FIG. 7, the outer race of the thrust bearing 750 is provided with radial clearance 762 between the outer circumference of the outer race of the thrust bearing 750 and the interior of the recess in the cup-shaped member 746 which receives the outer race of the thrust bearing 750. This permits lateral movement of the thrust bearing so that it will not preload the alignment bearings 736 for the shaft assembly 718. The periphery of the cup-shaped member 746 is provided with a plurality of radially extending knobs or handles 764 having a screw threaded connection 766 with internally threaded sockets or recesses formed in the periphery of the cup-shaped member 746 thereby enabling the cup-shaped member to be rotated about the axis of the shaft member 730. In effect, the cup-shaped member 746 is an adjustment nut that retains the thrust bearing 750 captive axially so that axial thrust can be exerted on the shaft assembly 718 in either direction with the radial clearance 762 enabling lateral movement of the thrust bearing 750 so that it will not introduce a preload into the alignment ball bearings 736 which permanently align the shaft member 730 in relation to the die plate and housing.

The coupling 722 includes a hub 768, secured to the reduced end 770 of shaft member 730 by a suitable key-and-set screw arrangement 772. A similar hub 774 is secured to the output shaft 775 of the motor 720 in a similar manner with the reduced end 770 of the shaft member 730 being generally in alignment with the motor output shaft 775 and spaced therefrom with the hubs 768 and 774 also being in spaced aligned relation as illustrated in FIG. 7. The external surface of each of the hubs 768 and 774 has gear teeth 776 thereon for axial sliding engagement with internal gear teeth 778 on coupling members 780 each of which includes an outwardly extending flange 782 with the flanges being secured by fastening bolts 784. This structure permits relative axial movement between the hubs 768 and 774 and the reduced end 770 of shaft member 730 and the output shaft 775 from motor 720 while maintaining a driving connection there between. Each of the sleeve-like coupling members 780 is provided with an inwardly extending flange 786 engaged with a shoulder 788 on the respective hub to limit the outward movement of the hubs in relation to retain the coupling members 780 and an O-ring seal 790 is provided between the inner edge of the flange 786 and the exterior surface of the respective hubs to the coupling lubricant therein. This structure enables limited relative movement between the output shaft 775 of the motor 720 and the shaft member 730 thereby eliminating axial and radial forces from being transmitted to the shaft member 730 from the motor output shaft 775. The structure of the coupling 722 per se is known and is commercially available. However, the concept of employing a coupling which compensates for both parallel and angular misalignment as well as end float is unique in driving the shaft assembly 718 in a pelletizer.

The support assembly 726 includes a support plate 792 which has the motor 720 attached thereto through a base plate 794 on the motor 720, a resilient pad 796 and fastening bolts 798. Also attached to the support plate 792 is a protective housing or enclosure 7100 for the coupling 722 to prevent accidental contact with the rotating components. The protective enclosure or housing 7100 is secured to the support plate 792 by bolts 7102. Also, the housing 734 is secured to the support plate 792 by fastening bolts 7104 with the resilient pad 7106 interposed between the support plate 792 and the housing 734. Positioned below the support plate 792 and supporting the support plate 792 is a support platform or base 7108 supported in any suitable manner such as from a pedestal 7110. The support plate 792 is adjustably supported from the base 7108 by a plurality of externally threaded bolts 7112 having a nut 7114 on each end with one nut being above the plate 792 and the other nut being below the platform or base 7108. A compression coil spring 7116 is positioned on the bolt 7112 with the upper end thereof engaging the under surface of the support plate 92 and the lower end engaged with an adjustment nut 7118 on the bolt 7112. Four or more bolts 7112 are provided between the support plate 792 and the platform or base 7108 so that by adjustment of the nuts 7118, the pelletizer can be supported in a manner that it floats in relation to the end of the extruder barrel to prevent stresses and misalignment due to thermal growth of the extruder barrel supports. The individual adjustment of the springs 7116 by the adjustment nuts 7118 enables proper tensioning of springs 7116. Accurate resilient positioning of the pelletizer components in relation to the die plate 714 and transition 712 is accomplished by adjusting bolts 7112.

FIG. 7C illustrates another feature of the underwater pelletizer of the present embodiment in which the die plate 714 includes passageways 7120 for flow of liquid PDC formulation 7122 in the form of a strand or ribbon. The die plate 714 includes a die face member 7124 having an outwardly tapering exit passageway or hole 7126 from which the PDC formulation 7122 exits and solidifies to form a pellet 7128 which is cut off by the cutting blade assembly. If the exit hole is cylindrical, there may be, depending upon the formulation and cure conditions, a solidification of the PDC formulation on the interior thereof which causes a constriction in the flow path of the PDC formulation with the constriction being at the exit of the die hole which reduces the cross-sectional area of the passageway and forms a constriction at the exit which is believed to cause non-uniform pellets and premature solidification. The outwardly tapered exit hole 7126 of the present embodiment does not prevent the curing of the PDC formulation but the layer 7130, under some conditions can form an insulated die hole so that the final shape of the die hole will be cylindrical as designated by numeral 7132. The solidified PDC formulation 7130 forms an insulating layer of very low thermal conductivity and provides an excellent thermal barrier so that only the tapered portion of the exit hole 7126 will be filled with solidified PDC formulation so that the residual hole 7132 will be substantially cylindrical and will remain substantially cylindrical due to the insulation characteristics of the cured PDC formulation 7130. Thus, the final cylindrical shape hole will produce more uniform pellets and prevent premature curing. Further teachings for the embodiment of this example can be found in U.S. Pat. No. 4,728,276 the entire disclosure of which is incorporated herein by reference.

### Example 41A

The polysilocarb precursors of Examples 1 to 38 are used in the equipment of Example 41 to make volumetric shapes. Preferably spherical beads are made.

### Example 41B

The polysilocarb precursors of Examples 1 to 38 are used in the equipment of Example 41 to make the polysilocarb proppants taught and disclosed in

US Patent Publication No. 2014/0326453.

### Example 41C

The polysilocarb precursors of Examples 1 to 38 are used in the equipment of Example 41 to make one or more of the following volumetric shaped preforms: spheres, pellets, rings, lenses, disks, panels, cones, frustoconical shapes, squares, rectangles, trusses, angles, ribbons, channels, hollow sealed chambers, hollow spheres, blocks, sheets, coatings, balls, squares, prolate spheroids, ellipsoids, spheroids, eggs, cones, multifaceted structures, films, skins, particulates, beams, rods, angles, columns, fibers, staple fibers, tubes, cups, pipes, and polyhedrons (e.g., octahedron, dodecahedron, icosidodecahedron, rhombic triacontahedron, and prism).

### Example 42

The present embodiment relates generally to an improved underwater pelletizer in which a liquid PDC formulation is extruded through die orifices in a die plate in the form of continuous strands that are cut into pellets by a rotating knife holder with knives that engage the die plate. The die plate and the knife assembly are housed within a fluid, e.g., water, housing so that the pelletizing takes place under water. This embodiment of the pelletizer provides a series of heat transfer tubes to transfer heat from the inlet of a transition piece where the liquid PDC formulation enters the extruder die so that heat is transferred more efficiently from the extruder forwardly to the die face and the die plate to thereby facilitate extrusion and controlled predetermined curing of the PDC through the die and die orifices.

It is useful to have the liquid PDC formulation leaving the die orifices at a predetermined temperature so as to provide uniform viscosity, uniform cure, and both, of PDC formulation at the orifice to provide uniform strands and, in turn, uniform pellets. Unlike the molten polymer processes, it is not necessarily the case that the warmer the PDC, the less chance there is of having die plugging when the water contacts the PDC.

The underwater pelletizer of the present embodiment also provides for water to be conducted to the cutter through a hollow shaft that supports the cutter and turns it so that the cutting blades abut the die orifice. Water from the hollow shaft is expelled from the cutter blade holder in advance of each cutter blade through water nozzles formed in the cutter blade holder. This arrangement can prevent cavitation of the water in front of the cutter blades as the cutter blade holder turns to cut the extruded PDC.

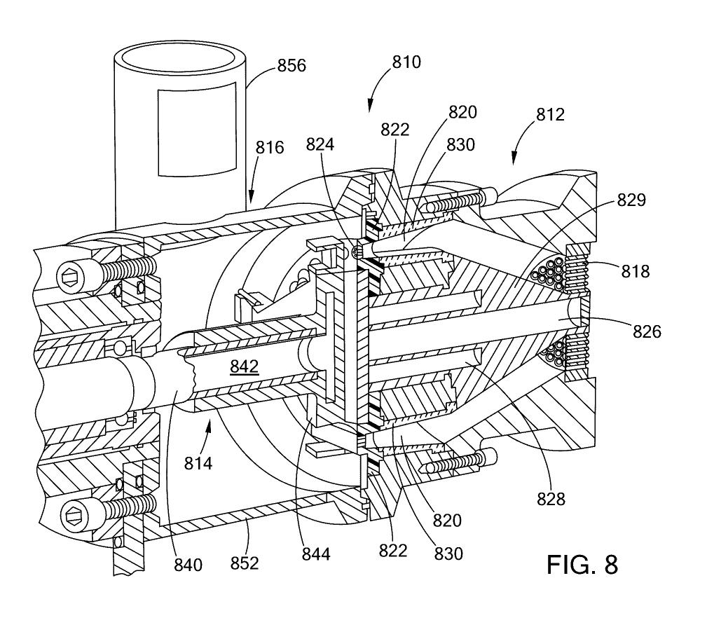

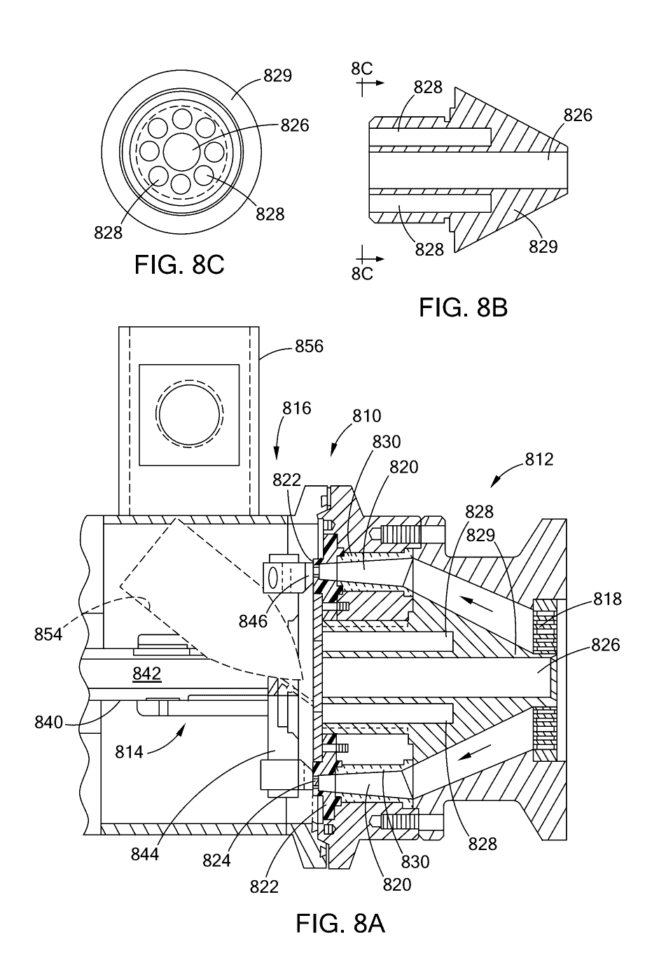

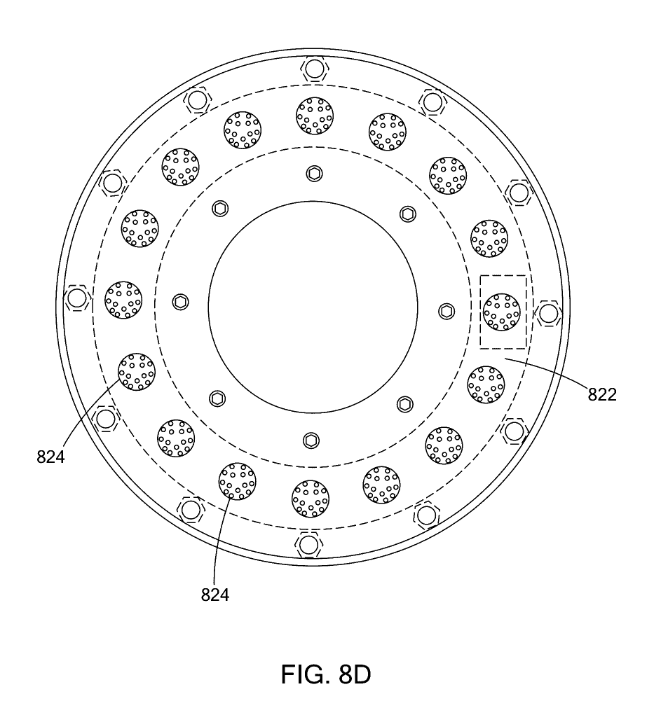

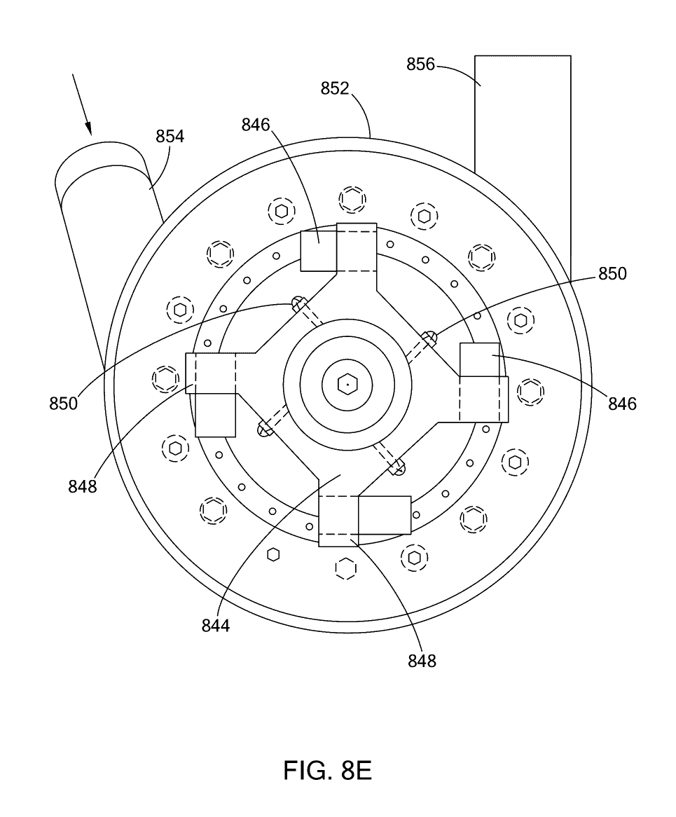

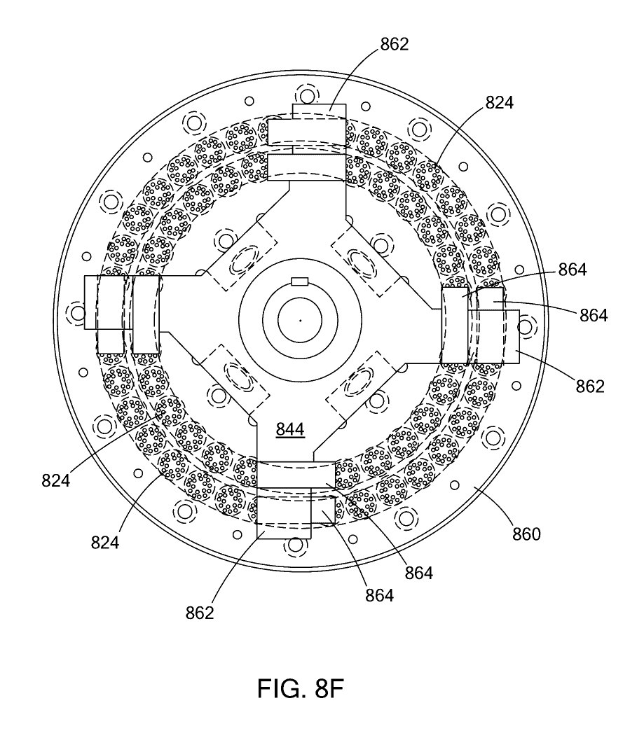

Referring to the drawings, and particularly to FIGS. 8 and 8A there is shown an underwater pelletizer indicated generally at 810. An extruder die 812 receives liquid PDC formulation that is forced through orifices in the extruder die where the strands of PDC are cut by a cutter assembly indicated generally at 814. The cutter assembly is housed within a water housing indicated generally at 816.

At the entry end of the extruder die 812, a breaker plate 818 allows the liquid PDC formulation to pass into the extruder die 812. A plurality of passages 820 conduct the liquid PDC formulation to the die face where a hardened steel die face plate 822 is fixed to the die face. The hardened steel face plate 822 is shown in greater detail in FIG. 8D. The hardened steel face plate 822 has a plurality of small holes 824 formed at the end of each passage 820 (FIG. 8) that feeds liquid PDC formulation to the die face plate 822.

The present embodiment is being described for use in pelletizing small size pellets. The holes 824 in the die face plate 822 are about 300 to 900 μm, 100 to 200 μm and about 0.020 to 0.050 inches in diameter so that the liquid PDC formulation strands are fine. While the present embodiment can be utilized to form thicker strands of PDC and is useful for that purpose, it is particularly suited for forming fine and very fine PDC strands that are pelletized under water. Within the transition piece core 829 (FIGS. 8A, 8B and 8C) a large heat tube 826 and eight smaller heat tubes 828 are positioned as shown in FIGS. 8B and 8C. The large heat tube 826 extends the entire length of extruder die 812 while the smaller heat tubes 828 are parallel axially to the large heat tube 826 and surround it as best seen in FIG. 8C.

The heat tubes of the present embodiment are sealed stainless steel tubes that contain a thermal transfer fluid. The tubes are permanently sealed and they serve to efficiently transfer heat from the inlet end of extruder die 812 to the die face plate 822 where the liquid PDC formulation leaves through the small hole orifices 824 in the die face plate 822. In order to properly form the strands leaving the orifices 824 within the die face plate 822, it is desirable that the strands leave at a predetermined amount of cure when they enter the water housing 816 to be cut by the cutter assembly 814. The transfer of heat from the entering liquid PDC formulation to the die face plate 822 is greatly facilitated by the heat tubes 826 and 828.

The cutter assembly 814 which is housed within the water housing 816 includes a hollow shaft 840 which has a water passage 842 formed longitudinally through the center of the shaft 840. A blade holder 844 (FIG. 8E) has blades 846 secured to spokes 848 that extend from the blade holder 844. A plurality of water nozzles 850 extend between each of the spokes 848. Water is fed through the water passage 842 in shaft 844 into the blade holder 844 from which it is ejected through the nozzles 850. The nozzles 850 help to insure that there is water around the blades at all times as they rotate to cut the PDC extrudate as it leaves the die face plate 822.

The blades 846 bear against the die face plate 822 and cut the strands of liquid PDC formulation as they leave the die face plate 822 and enter the water bath within the water housing body 852. As best seen in FIGS. 8A and 8E, the water within housing body 852 enters through water inlet 854 that is positioned at approximately a 45° angle to the horizontal and enters the housing at the level of the cutter shaft 840. The water outlet 856 from housing body 852 is vertical as shown in FIGS. 8A and 8E. By having water enter a housing body 852 through the inlet 854 as positioned, the water circulates through the housing body 852 and entrains the pellets that are cut as they leave the die face plate 822. The water and entrained pellets leave through outlet 856. By having the water circulate around the housing from inlet 854 to outlet 856, cavitation within the water is eliminated when the arrangement of inlet 854 and outlet 856 is combined with the water nozzles 850 that emit water that enters through the water passage 842 in shaft 840.

FIG. 8F shows an alternative die face plate 860 which has a double concentric row of small orifices 824 formed in a fashion similar to the die face plate 822 shown in FIG. 8D. The die face plate 860 of FIG. 8F is also formed of hardened steel and may be substituted into the structure shown in FIGS. 8 and 8A. When die face plate 860 with the double row of orifices 824 is utilized, the blade holder 844 has elongated spokes 862 that each carry two blades 864. The two blades on each spoke 862 register with the double row of small orifices 824 so that they cut all of the strands being emitted from the die 812 when the die face plate 860 is utilized.

Further teachings for the embodiment of this example can be found in U.S. Pat. No. 5,629,028 the entire disclosure of which is incorporated herein by reference.

### Example 42A

The polysilocarb precursors of Examples 1 to 38 are used in the equipment of Example 42 to make volumetric shapes. Preferably spherical beads are made.

### Example 42B

The polysilocarb precursors of Examples 1 to 38 are used in the equipment of Example 42 to make the polysilocarb proppants taught and disclosed in US Patent Publication No. 2014/0326453.

### Example 42C

The polysilocarb precursors of Examples 1 to 38 are used in the equipment of Example 42 to make one or more of the following volumetric shaped preforms: spheres, pellets, rings, lenses, ribbons, disks, panels, cones, frustoconical shapes, squares, rectangles, trusses, angles, channels, hollow sealed chambers, hollow spheres, blocks, sheets, coatings, balls, squares, prolate spheroids, ellipsoids, spheroids, eggs, cones, multifaceted structures, films, skins, particulates, beams, rods, angles, columns, fibers, staple fibers, tubes, cups, pipes, and polyhedrons (e.g., octahedron, dodecahedron, icosidodecahedron, rhombic triacontahedron, and prism).

### Example 43

The embodiment of FIG. 1 is used to make the polysilocarb proppants taught and disclosed in US Patent Publication No. 2014/0326453, the entire disclosure of which is incorporated herein by reference.

### Example 44

The embodiment of FIG. 1 is used to make one or more of the following volumetric shaped polysilocarb preforms: spheres, pellets, rings, lenses, disks, panels, cones, frustoconical shapes, squares, ribbons, rectangles, trusses, angles, channels, hollow sealed chambers, hollow spheres, blocks, sheets, coatings, balls, squares, prolate spheroids, ellipsoids, spheroids, eggs, cones, multifaceted structures, films, skins, particulates, beams, rods, angles, columns, fibers, staple fibers, tubes, cups, pipes, and polyhedrons (e.g., octahedron, dodecahedron, icosidodecahedron, rhombic triacontahedron, and prism).

### Example 45

The embodiment of FIG. 4 is used to make one or more of the following volumetric shaped polysilocarb preforms: fibers, tubes, ribbons, sheets, films, skins, beams, rods, columns, staple fibers, cups, pipes, and elongate polyhedrons (e.g., octahedron, dodecahedron, icosidodecahedron, rhombic triacontahedron, and prism).

General Processes for Obtaining a Polysilocarb Precursor

Typically polymer derived ceramic precursor formulations, and in particular polysilocarb precursor formulations can generally be made by three types of processes, although other processes, and variations and combinations of these processes may be utilized. These processes generally involve combining precursors to form a precursor formulation. One type of process generally involves the mixing together of precursor materials in preferably a solvent free process with essentially no chemical reactions taking place, e.g., “the mixing process.” The other type of process generally involves chemical reactions, e.g., “the reaction type process,” to form specific, e.g., custom, precursor formulations, which could be monomers, dimers, trimers and polymers. A third type of process has a chemical reaction of two or more components in a solvent free environment, e.g., “the reaction blending type process.” Generally, in the mixing process essentially all, and preferably all, of the chemical reactions take place during subsequent processing, such as during curing, pyrolysis and both.

It should be understood that these terms—reaction type process, reaction blending type process, and the mixing type process—are used for convenience and as a short hand reference. These terms are not, and should not be viewed as, limiting. For example, the reaction process can be used to create a precursor material that is then used in the mixing process with another precursor material.

These process types are described in this specification, among other places, under their respective headings. It should be understood that the teachings for one process, under one heading, and the teachings for the other processes, under the other headings, can be applicable to each other, as well as, being applicable to other sections, embodiments and teachings in this specification, and vice versa. The starting or precursor materials for one type of process may be used in the other type of processes. Further, it should be understood that the processes described under these headings should be read in context with the entirely of this specification, including the various examples and embodiments.

It should be understood that combinations and variations of these processes may be used in reaching a precursor formulation, and in reaching intermediate, end and final products. Depending upon the specific process and desired features of the product the precursors and starting materials for one process type can be used in the other. A formulation from the mixing type process may be used as a precursor, or component in the reaction type process, or the reaction blending type process. Similarly, a formulation from the reaction type process may be used in the mixing type process and the reaction blending process. Similarly, a formulation from the reaction blending type process may be used in the mixing type process and the reaction type process. Thus, and preferably, the optimum performance and features from the other processes can be combined and utilized to provide a cost effective and efficient process and end product. These processes provide great flexibility to create custom features for intermediate, end, and final products, and thus, any of these processes, and combinations of them, can provide a specific predetermined product. In selecting which type of process is preferable, factors such as cost, controllability, shelf life, scale up, manufacturing ease, etc., can be considered.

In addition to being commercially available the precursors may be made by way of an alkoxylation type process, e.g., an ethoxylation process. In this process chlorosilanes are reacted with ethanol in the presences of a catalysis, e.g., HCl, to provide the precursor materials, which materials may further be reacted to provide longer chain precursors. Other alcohols, e.g., methanol may also be used. Thus, for example SiCl₄, SiCl₃H, SiCl₂(CH₃)₂, SiCl₂(CH₃)H, Si(CH₃)3Cl, Si(CH₃)ClH, are reacted with ethanol CH₃CH₂OH to form precursors. In some of these reactions phenols may be the source of the phenoxy group, which is substituted for a hydride group that has been placed on the silicon. One, two or more step reactions may need to take place.

Precursor materials may also be obtained by way of an acetylene reaction route. In general there are several known paths for adding acetylene to Si—H. Thus, for example, tetramethylcyclotetrasiloxane can be reacted with acetylene in the presence of a catalyst to produce tetramethyltetravinylcyclotetrasiloxane. This product can then be ring opened and polymerized in order to form linear vinyl, methylsiloxanes. Alternatively, typical vinyl silanes can be produced by reacting methyl, dichlorosilane (obtained from the direct process or Rochow process) with acetylene. These monomers can then be purified (because there may be some scrambling) to form vinyl, methyl, dichlorosilane. Then the vinyl monomer can be polymerized via hydrolysis to form many cyclic, and linear siloxanes, having various chain lengths, including for example various cyclotetrasiloxanes (e.g., D₄′) and various cyclopentasiloxanes (e.g., D₅′).

The Mixing Type Process

Precursor materials may be methyl hydrogen, and substituted and modified methyl hydrogens, siloxane backbone additives, reactive monomers, reaction products of a siloxane backbone additive with a silane modifier or an organic modifier, and other similar types of materials, such as silane based materials, silazane based materials, carbosilane based materials, phenol/formaldehyde based materials, and combinations and variations of these. The precursors are preferably liquids at room temperature, although they may be solids that are melted, or that are soluble in one of the other precursors. (In this situation, however, it should be understood that when one precursor dissolves another, it is nevertheless not considered to be a “solvent” as that term is used with respect to the prior art processes that employ non-constituent solvents, e.g., solvents that do not form a part or component of the end product, are treated as waste products, and both.)

The precursors are mixed together in a vessel, preferably at room temperature. Preferably, little, and more preferably no solvents, e.g., water, organic solvents, polar solvents, non-polar solvents, hexane, THF, toluene, are added to this mixture of precursor materials. Preferably, each precursor material is miscible with the others, e.g., they can be mixed at any relative amounts, or in any proportions, and will not separate or precipitate. At this point the “precursor mixture” or “polysilocarb precursor formulation” is compete (noting that if only a single precursor is used the material would simply be a “polysilocarb precursor” or a “polysilocarb precursor formulation” or a “formulation”). Although complete, fillers and reinforcers may be added to the formulation. In preferred embodiments of the formulation, essentially no, and more preferably no chemical reactions, e.g., crosslinking or polymerization, takes place within the formulation, when the formulation is mixed, or when the formulation is being held in a vessel, on a prepreg, or over a time period, prior to being cured.

The precursors can be mixed under numerous types of atmospheres and conditions, e.g., air, inert, N₂, Argon, flowing gas, static gas, reduced pressure, elevated pressure, ambient pressure, and combinations and variations of these.

Additionally, inhibitors such as cyclohexane, 1-Ethynyl-1-cyclohexanol (which may be obtained from ALDRICH), Octamethylcyclotetrasiloxane, and tetramethyltetravinylcyclotetrasiloxane, may be added to the polysilocarb precursor formulation, e.g., an inhibited polysilocarb precursor formulation. It should be noted that tetramethyltetravinylcyclotetrasiloxane may act as both a reactant and a reaction retardant (e.g., an inhibitor), depending upon the amount present and temperature, e.g., at room temperature it is a retardant and at elevated temperatures it is a reactant. Other materials, as well, may be added to the polysilocarb precursor formulation, e.g., a filled polysilocarb precursor formulation, at this point in processing, including fillers such as SiC powder, carbon black, sand, polymer derived ceramic particles, pigments, particles, nano-tubes, whiskers, or other materials, discussed in this specification or otherwise known to the arts. Further, a formulation with both inhibitors and fillers would be considered an inhibited, filled polysilocarb precursor formulation.

A catalyst or initiator may be used, and can be added at the time of, prior to, shortly before, or at an earlier time before the precursor formulation is formed or made into a structure, prior to curing. The catalysis assists in, advances, and promotes the curing of the precursor formulation to form a preform.

The catalyst can be any platinum (Pt) based catalyst, which can, for example, be diluted to a ranges of: about 0.01 parts per million (ppm) Pt to about 250 ppm Pt, about 0.03 ppm Pt, about 0.1 ppm Pt, about 0.2 ppm Pt, about 0.5 ppm Pt, about 0.02 to 0.5 ppm Pt, about 1 ppm to 200 ppm Pt and preferably, for some applications and embodiments, about 5 ppm to 50 ppm Pt. The catalyst can be a peroxide based catalyst with, for example, a 10 hour half life above 90 C at a concentration of between 0.1% to 3% peroxide, and about 0.5% and 2% peroxide. It can be an organic based peroxide. It can be any organometallic catalyst capable of reacting with Si—H bonds, Si—OH bonds, or unsaturated carbon bonds, these catalysts may include: dibutyltin dilaurate, zinc octoate, peroxides, organometallic compounds of for example titanium, zirconium, rhodium, iridium, palladium, cobalt or nickel. Catalysts may also be any other rhodium, rhenium, iridium, palladium, nickel, and ruthenium type or based catalysts. Combinations and variations of these and other catalysts may be used. Catalysts may be obtained from ARKEMA under the trade name LUPEROX, e.g., LUPEROX 231; and from Johnson Matthey under the trade names: Karstedt's catalyst, Ashby's catalyst, Speier's catalyst.

Further, custom and specific combinations of these and other catalysts may be used, such that they are matched to specific formulations, and in this way selectively and specifically catalyze the reaction of specific constituents. Moreover, the use of these types of matched catalyst-formulations systems may be used to provide predetermined product features, such as for example, pore structures, porosity, densities, density profiles, high purity, ultra high purity, and other morphologies or features of cured structures and ceramics.

In this mixing type process for making a precursor formulation, preferably chemical reactions or molecular rearrangements only take place during the making of the starting materials, the curing process, and in the pyrolizing process. Chemical reactions, e.g., polymerizations, reductions, condensations, substitutions, take place or are utilized in the making of a starting material or precursor. In making a polysilocarb precursor formulation by the mixing type process, preferably no and essentially no, chemical reactions and molecular rearrangements take place. These embodiments of the present mixing type process, which avoid the need to, and do not, utilize a polymerization or other reaction during the making of a precursor formulation, provides significant advantages over prior methods of making polymer derived ceramics. Preferably, in the embodiments of these mixing type of formulations and processes, polymerization, crosslinking or other chemical reactions take place primarily, preferably essentially, and more preferably solely during the curing process.

The precursor may be a siloxane backbone additive, such as, methyl hydrogen (MH), which formula is shown below.

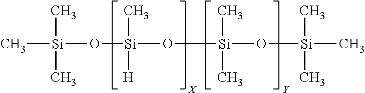

The MH may have a molecular weight (“mw” which can be measured as weight averaged molecular weight in amu or as g/mol) from about 400 mw to about 10,000 mw, from about 600 mw to about 3,000 mw, and may have a viscosity preferably from about 20 cps to about 60 cps. The percentage of methylsiloxane units “X” may be from 1% to 100%. The percentage of the dimethylsiloxane units “Y” may be from 0% to 99%. This precursor may be used to provide the backbone of the cross-linked structures, as well as, other features and characteristics to the cured preform and ceramic material. This precursor may also, among other things, be modified by reacting with unsaturated carbon compounds to produce new, or additional, precursors. Typically, methyl hydrogen fluid (MHF) has minimal amounts of “Y”, and more preferably “Y” is for all practical purposes zero.

The precursor may be a siloxane backbone additive, such as vinyl substituted polydimethyl siloxane, which formula is shown below.

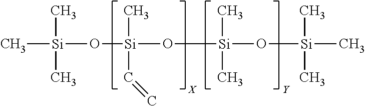

This precursor may have a molecular weight (mw) from about 400 mw to about 10,000 mw, and may have a viscosity preferably from about 50 cps to about 2,000 cps. The percentage of methylvinylsiloxane units “X” may be from 1% to 100%. The percentage of the dimethylsiloxane units “Y” may be from 0% to 99%. Preferably, X is about 100%. This precursor may be used to decrease cross-link density and improve toughness, as well as, other features and characteristics to the cured preform and ceramic material.

The precursor may be a siloxane backbone additive, such as vinyl substituted and vinyl terminated polydimethyl siloxane, which formula is shown below.

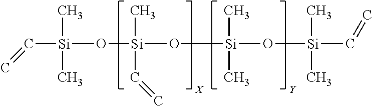

This precursor may have a molecular weight (mw) from about 500 mw to about 15,000 mw, and may preferably have a molecular weight from about 500 mw to 1,000 mw, and may have a viscosity preferably from about 10 cps to about 200 cps. The percentage of methylvinylsiloxane units “X” may be from 1% to 100%. The percentage of the dimethylsiloxane units “Y” may be from 0% to 99%. This precursor may be used to provide branching and decrease the cure temperature, as well as, other features and characteristics to the cured preform and ceramic material.

The precursor may be a siloxane backbone additive, such as one or more of the following: vinyl substituted and hydrogen terminated polydimethyl siloxane; allyl terminated polydimethyl siloxane; vinyl terminated polydimethyl siloxane; silanol (hydroxy) terminated polydimethyl siloxane; silanol (hydroxy) terminated vinyl substituted dimethyl siloxane; hydrogen (hydride) terminated polydimethyl siloxane; diphenyl terminated siloxane; mono-phenyl terminated siloxane; diphenyl dimethyl polysiloxane; vinyl terminated diphenyl dimethyl polysiloxane; hydroxy terminated diphenyl dimethyl polysiloxane;

A variety of cyclosiloxanes can be used as reactive molecules in the formulation. They can be described by the following nomenclature system or formula: DₓD*_{y}, where “D” represents a dimethyl siloxy unit and “D*” represents a substituted methyl siloxy unit, where the “*” group could be vinyl, allyl, hydride, hydroxy, phenyl, styryl, alkyl, cyclopentadienyl, or other organic group, x is from 0-8, y is >=1, and x+y is from 3-8.

The precursor batch may also contain non-silicon based cross-linking agents, be the reaction product of a non-silicon based cross linking agent and a siloxane backbone additive, and combinations and variation of these. The non-silicon based cross-linking agents are intended to, and provide, the capability to cross-link during curing. For example, non-silicon based cross-linking agents that can be used include: cyclopentadiene (CP), methylcyclopentadiene (MeCP), dicyclopentadiene (“DCPD”), methyldicyclopentadiene (MeDCPD), tricyclopentadiene (TCPD), piperylene, divnylbenzene, isoprene, norbornadiene, vinylnorbornene, propenylnorbornene, isopropenylnorbornene, methylvinylnorbornene, bicyclononadiene, methylbicyclononadiene, propadiene, 4-vinylcyclohexene, 1,3-heptadiene, cycloheptadiene, 1,3-butadiene, cyclooctadiene and isomers thereof. Generally, any hydrocarbon that contains two (or more) unsaturated, C═C, bonds that can react with a Si—H, Si—OH, or other Si bond in a precursor, can be used as a cross-linking agent. Some organic materials containing oxygen, nitrogen, and sulphur may also function as cross-linking moieties.

The precursor may be a reactive monomer. These would include molecules, such as tetramethyltetravinylcyclotetrasiloxane (“TV”), which formula is shown below.

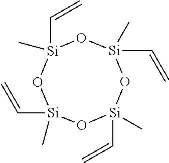 [SMILES: C=C[Si]1(C)O[Si](C)(C=C)O[Si](C)(C=C)O[Si](C)(C=C)O1]

This precursor may be used to provide a branching agent, a three-dimensional cross-linking agent, as well as, other features and characteristics to the cured preform and ceramic material. (It is also noted that in certain formulations, e.g., above 2%, and certain temperatures, e.g., about from about room temperature to about 60° C., this precursor may act as an inhibitor to cross-linking, e.g., in may inhibit the cross-linking of hydride and vinyl groups.)

The precursor may be a reactive monomer, for example, such as trivinyl cyclotetrasiloxane; divinyl cyclotetrasiloxane; trivinyl monohydride cyclotetrasiloxane; divinyl dihydride cyclotetrasiloxane; and hexamethyl cyclotetrasiloxane.

The precursor may be a silane modifier, such as vinyl phenyl methyl silane, diphenyl silane, diphenyl methyl silane, and phenyl methyl silane (some of which may be used as an end capper or end termination group). These silane modifiers can provide chain extenders and branching agents. They also improve toughness, alter refractive index, and improve high temperature cure stability of the cured material, as well as improving the strength of the cured material, among other things. A precursor, such as diphenyl methyl silane, may function as an end capping agent, that may also improve toughness, alter refractive index, and improve high temperature cure stability of the cured material, as well as, improving the strength of the cured material, among other things.

The precursor may be a reaction product of a silane modifier with a vinyl terminated siloxane backbone additive. The precursor may be a reaction product of a silane modifier with a hydroxy terminated siloxane backbone additive. The precursor may be a reaction product of a silane modifier with a hydride terminated siloxane backbone additive. The precursor may be a reaction product of a silane modifier with TV. The precursor may be a reaction product of a silane. The precursor may be a reaction product of a silane modifier with a cyclosiloxane, taking into consideration steric hindrances. The precursor may be a partially hydrolyzed tetraethyl orthosilicate, such as TES 40 or Silbond 40. The precursor may also be a methylsesquisiloxane such as SR-350 available from General Electric Company, Wilton, Conn. The precursor may also be a phenyl methyl siloxane such as 604 from Wacker Chemie AG. The precursor may also be a methylphenylvinylsiloxane, such as H62 C from Wacker Chemie AG.

The precursors may also be selected from the following: SiSiB® HF2020, TRIMETHYLSILYL TERMINATED METHYL HYDROGEN SILICONE FLUID 63148-57-2; SiSiB® HF2050 TRIMETHYLSILYL TERMINATED METHYLHYDROSILOXANE DIMETHYLSILOXANE COPOLYMER 68037-59-2; SiSiB® HF2060 HYDRIDE TERMINATED METHYLHYDROSILOXANE DIMETHYLSILOXANE COPOLYMER 69013-23-6; SiSiB® HF2038 HYDROGEN TERMINATED POLYDIPHENYL SILOXANE; SiSiB® HF2068 HYDRIDE TERMINATED METHYLHYDROSILOXANE DIMETHYLSILOXANE COPOLYMER 115487-49-5; SiSiB® HF2078 HYDRIDE TERMINATED POLY(PHENYLDIMETHYLSILOXY) SILOXANE PHENYL SILSESQUIOXANE, HYDROGEN-TERMINATED 68952-30-7; SiSiB® VF6060 VINYLDIMETHYL TERMINATED VINYLMETHYL DIMETHYL POLYSILOXANE COPOLYMERS 68083-18-1; SiSiB® VF6862 VINYLDIMETHYL TERMINATED DIMETHYL DIPHENYL POLYSILOXANE COPOLYMER 68951-96-2; SiSiB® VF6872 VINYLDIMETHYL TERMINATED DIMETHYL-METHYLVINYL-DIPHENYL POLYSILOXANE COPOLYMER; SiSiB® PC9401 1,1,3,3-TETRAMETHYL-1,3-DIVINYLDISILOXANE 2627-95-4; SiSiB® PF1070 SILANOL TERMINATED POLYDIMETHYLSILOXANE (OF1070) 70131-67-8; SiSiB® OF1070 SILANOL TERMINATED POLYDIMETHYSILOXANE 70131-67-8; OH-ENDCAPPED POLYDIMETHYLSILOXANE HYDROXY TERMINATED OLYDIMETHYLSILOXANE 73138-87-1; SiSiB® VF6030 VINYL TERMINATED POLYDIMETHYL SILOXANE 68083-19-2; and, SiSiB® HF2030 HYDROGEN TERMINATED POLYDIMETHYLSILOXANE FLUID 70900-21-9.

Thus, in additional to the forgoing type of precursors, it is contemplated that a precursor may be a compound of the following general formula.

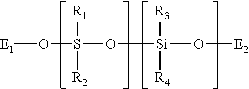

Wherein end cappers E₁ and E₂ are chosen from groups such as trimethyl silicon (—Si(CH₃)₃), dimethyl silicon hydroxy (—Si(CH₃)₂OH), dimethyl silicon hydride (—Si(CH₃)₂H), dimethyl vinyl silicon (—Si(CH₃)₂(CH═CH₂)), (—Si(CH₃)₂(C₆H₅)) and dimethyl alkoxy silicon (—Si(CH₃)₂(OR). The R groups R₁, R₂, R₃, and R₄ may all be different, or one or more may be the same. Thus, for example, R₂ is the same as R₃, R₃ is the same as R₄, R₁ and R₂ are different with R₃ and R₄ being the same, etc. The R groups are chosen from groups such as hydride (—H), methyl (Me)(-C), ethyl (—C—C), vinyl (—C═C), alkyl (—R)(CₙH₂ₙ₊₁), allyl (—C—C═C), aryl (′R), phenyl (Ph)(—C₆H₅), methoxy (—O—C), ethoxy (—O—C—C), siloxy (—O—Si—R₃), alkoxy (—O—R), hydroxy (—O—H), phenylethyl (—C—C—C₆H₅) and methyl, phenyl-ethyl (—C—C(—C)(—C₆H₅).

In general, embodiments of formulations for polysilocarb formulations may for example have from about 0% to 50% MH, about 20% to about 99% MH, about 0% to about 30% siloxane backbone additives, about 1% to about 60% reactive monomers, about 30% to about 100% TV, and, about 0% to about 90% reaction products of a siloxane backbone additives with a silane modifier or an organic modifier reaction products.

In mixing the formulations sufficient time should be used to permit the precursors to become effectively mixed and dispersed. Generally, mixing of about 15 minutes to an hour is sufficient. Typically, the precursor formulations are relatively, and essentially, shear insensitive, and thus the type of pumps or mixing are not critical. It is further noted that in higher viscosity formulations additional mixing time may be required. The temperature of the formulations, during mixing should preferably be kept below about 45° C., and preferably about 10° C. (It is noted that these mixing conditions are for the pre-catalyzed formulations.)

The Reaction Type Process

In the reaction type process, in general, a chemical reaction is used to combine one, two or more precursors, typically in the presence of a solvent, to form a precursor formulation that is essentially made up of a single polymer that can then be, catalyzed, cured and pyrolized. This process provides the ability to build custom precursor formulations that when cured can provide plastics having unique and desirable features such as high temperature, flame resistance and retardation, strength and other features. The cured materials can also be pyrolized to form ceramics having unique features. The reaction type process allows for the predetermined balancing of different types of functionality in the end product by selecting functional groups for incorporation into the polymer that makes up the precursor formulation, e.g., phenyls which typically are not used for ceramics but have benefits for providing high temperature capabilities for plastics, and styrene which typically does not provide high temperature features for plastics but provides benefits for ceramics.

In general a custom polymer for use as a precursor formulation is made by reacting precursors in a condensation reaction to form the polymer precursor formulation. This precursor formulation is then cured into a preform through a hydrolysis reaction. The condensation reaction forms a polymer of the type shown below.

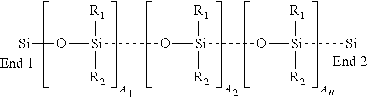

Where R₁ and R₂ in the polymeric units can be a hydride (—H), a methyl (Me)(-C), an ethyl (—C—C), a vinyl (—C═C), an alkyl (—R)(CₙH₂ₙ₊₁), an unsaturated alkyl (—CₙH₂ₙ₋₁), a cyclic alkyl (—CₙH₂ₙ₋₁), an allyl (—C—C═C), a butenyl (—C₄H₇), a pentenyl (—O₅H₉), a cyclopentenyl (—O₅H₇), a methyl cyclopentenyl (—O₅H₆(CH₃)), a norbornenyl (—CₓH_{y}, where X=7-15 and Y=9-18), an aryl (′R), a phenyl (Ph)(—C₆H₅), a cycloheptenyl (—C₇H₁₁), a cyclooctenyl (—C₈H₁₃), an ethoxy (—O—C—C), a siloxy a methoxy (—O—C), an alkoxy, (—O—R), a hydroxy, (—O—H), a phenylethyl (—C—C—C₆H₅) a methyl, phenyl-ethyl (—C—C(—C)(—C₆H₅)) and a vinylphenyl-ethyl (—C—C(C₆H₄(—C═C))). R₁ and R₂ may be the same or different. The custom precursor polymers can have several different polymeric units, e.g., A₁, A₂, Aₙ, and may include as many as 10, 20 or more units, or it may contain only a single unit, for example, MHF made by the reaction process may have only a single unit.

Embodiments may include precursors, which include among others, a triethoxy methyl silane, a diethoxy methyl phenyl silane, a diethoxy methyl hydride silane, a diethoxy methyl vinyl silane, a dimethyl ethoxy vinyl silane, a diethoxy dimethyl silane. an ethoxy dimethyl phenyl silane, a diethoxy dihydride silane, a triethoxy phenyl silane, a diethoxy hydride trimethyl siloxane, a diethoxy methyl trimethyl siloxane, a trimethyl ethoxy silane, a diphenyl diethoxy silane, a dimethyl ethoxy hydride siloxane, and combinations and variations of these and other precursors, including other precursors set forth in this specification.

The end units, Si End 1 and Si End 2, can come from the precursors of dimethyl ethoxy vinyl silane, ethoxy dimethyl phenyl silane, and trimethyl ethoxy silane. Additionally, if the polymerization process is properly controlled a hydroxy end cap can be obtained from the precursors used to provide the repeating units of the polymer.

In general, the precursors are added to a vessel with ethanol (or other material to absorb heat, e.g., to provide thermal mass), an excess of water, and hydrochloric acid (or other proton source). This mixture is heated until it reaches its activation energy, after which the reaction typically is exothermic. Generally, in this reaction the water reacts with an ethoxy group of the silicon of the precursor monomer, forming a hydroxy (with ethanol as the byproduct). Once formed this hydroxy becomes subject to reaction with an ethoxy group on the silicon of another precursor monomer, resulting in a polymerization reaction. This polymerization reaction is continued until the desired chain length(s) is built.

Upon completion of the polymerization reaction the material is transferred into a separation apparatus, e.g., a separation funnel, which has an amount of deionized water that, for example, is from about 1.2× to about 1.5× the mass of the material. This mixture is vigorously stirred for about less than 1 minute and preferably from about 5 to 30 seconds. Once stirred the material is allowed to settle and separate, which may take from about 1 to 2 hours. The polymer is the higher density material and is removed from the vessel. This removed polymer is then dried by either warming in a shallow tray at 90° C. for about two hours; or, preferably, is passed through a wiped film distillation apparatus, to remove any residual water and ethanol. Alternatively, sodium bicarbonate sufficient to buffer the aqueous layer to a pH of about 4 to about 7 is added. It is further understood that other, and commercial, manners of mixing, reacting and separating the polymer from the material may be employed.

Preferably a catalyst is used in the curing process of the polymer precursor formulations from the reaction type process. The same polymers, as used for curing the precursor formulations from the mixing type process can be used. It is noted that, generally unlike the mixing type formulations, a catalyst is not necessarily required to cure a reaction type polymer. Inhibitors may also be used. However, if a catalyst is not used, reaction time and rates will be slower. The curing and the pyrolysis of the cured material from the reaction process is essentially the same as the curing and pyrolysis of the cured material from the mixing process and the reaction blending process.

The reaction type process can be conducted under numerous types of atmospheres and conditions, e.g., air, inert, N₂, Argon, flowing gas, static gas, reduced pressure, ambient pressure, elevated pressure, and combinations and variations of these.

The Reaction Blending Type Process

In the reaction blending type process precursor are reacted to from a precursor formulation, in the absence of a solvent. For example, an embodiment of a reaction blending type process has a precursor formulation that is prepared from MHF and Dicyclopentadiene (“DCPD”). Using the reactive blending process a MHF/DCPD polymer is created and this polymer is used as a precursor formulation. (It can be used alone to form a cured or pyrolized product, or as a precursor in the mixing or reaction processes.) MHF of known molecular weight and hydride equivalent mass; “P01” (P01 is a 2% Pt(0) tetravinylcyclotetrasiloxane complex (e.g., tetramethyltetravinylcyclotetrasiloxane) in tetravinylcyclotetrasiloxane, diluted 20× with tetravinylcyclotetrasiloxane to 0.1% of Pt(0) complex. In this manner 10 ppm Pt is provided for every 1% loading of bulk cat.) catalyst 0.20 wt % of MHF starting material (with known active equivalent weight), from 40 to 90%; and Dicyclopentadiene with 83% purity, from 10 to 60% are utilized. In an embodiment of the process, a sealable reaction vessel, with a mixer, can be used for the reaction. The reaction is conducted in the sealed vessel, in air; although other types of atmosphere can be utilized. Preferably, the reaction is conducted at atmospheric pressure, but higher and lower pressures can be utilized. Additionally, the reaction blending type process can be conducted under numerous types of atmospheres and conditions, e.g., air, inert, N₂, Argon, flowing gas, static gas, reduced pressure, ambient pressure, elevated pressure, and combinations and variations of these.

In an embodiment, 850 grams of MHF (85% of total polymer mixture) is added to reaction vessel and heated to about 50° C. Once this temperature is reached the heater is turned off, and 0.20% by weight P01 Platinum catalyst is added to the MHF in the reaction vessel. Typically, upon addition of the catalyst bubbles will form and temp will initially rise approximately 2-20° C.

When the temperature begins to fall, about 150 g of DCPD (15 wt % of total polymer mixture) is added to the reaction vessel. The temperature may drop an additional amount, e.g., around 5-7° C.

At this point in the reaction process the temperature of the reaction vessel is controlled to, maintain a predetermined temperature profile over time, and to manage the temperature increase that may be accompanied by an exotherm. Preferably, the temperature of the reaction vessel is regulated, monitored and controlled throughout the process.

In an embodiment of the MHF/DCPD embodiment of the reaction process, the temperature profile can be as follows: let temperature reach about 80° C. (may take ˜15-40 min, depending upon the amount of materials present); temperature will then increase and peak at ˜104° C., as soon as temperature begins to drop, the heater set temperature is increased to 100° C. and the temperature of the reaction mixture is monitored to ensure the polymer temp stays above 80° C. for a minimum total of about 2 hours and a maximum total of about 4 hours. After 2-4 hours above 80° C., the heater is turned off, and the polymer is cooled to ambient. It being understood that in larger and smaller batches, continuous, semi-continuous, and other type processes the temperature and time profile may be different.

In larger scale, and commercial operations, batch, continuous, and combinations of these, may be used. Industrial factory automation and control systems can be utilized to control the reaction, temperature profiles and other processes during the reaction.

Curing and Pyrolysis

Precursor formulations, including the polysilocarb precursor formulations from the above types of processes, as well as others, can be cured to form a solid, semi-sold, or plastic like material. Typically, the precursor formulations are spread, shaped, or otherwise formed into a preform, which would include any volumetric structure, or shape, including thin and thick films. In curing, the polysilocarb precursor formulation may be processed through an initial cure, to provide a partially cured material, which may also be referred to, for example, as a preform, green material, or green cure (not implying anything about the material's color). The green material may then be further cured. Thus, one or more curing steps may be used. The material may be “end cured,” i.e., being cured to that point at which the material has the necessary physical strength and other properties for its intended purpose. The amount of curing may be to a final cure (or “hard cure”), i.e., that point at which all, or essentially all, of the chemical reaction has stopped (as measured, for example, by the absence of reactive groups in the material, or the leveling off of the decrease in reactive groups over time). Thus, the material may be cured to varying degrees, depending upon its intended use and purpose. For example, in some situations the end cure and the hard cure may be the same. Curing conditions such as atmosphere and temperature may affect the composition of the cured material.

The forming step, the curing steps, and the pyrolysis steps may be conducted in batch processes, serially, continuously, with time delays (e.g., material is stored or held between steps), and combinations and variations of these and other types of processing sequences. Further, the precursors can be partially cured, or the cure process can be initiated and on going, prior to the precursor being formed into a volumetric shape. These steps, and their various combinations may be, and in some embodiments preferably are, conducted under controlled and predetermined conditions (e.g., the material is exposed to a predetermined atmosphere, and temperature profile during the entirely of its processing, e.g., reduced oxygen, temperature of cured preform held at about 140° C. prior to pyrolysis). It should be further understood that the system, equipment, or processing steps, for forming, curing and pyrolizing may be the same equipment, continuous equipment, batch and linked equipment, and combinations and variations of these and other types of industrial processes. Thus, for example, a spray drying technique could form cured particles that are feed directly into a fluidized bed reactor for pyrolysis.

The polysilocarb precursor formulations can be made into neat, non-reinforced, non-filled, composite, reinforced, and filled structures, intermediates, end products, and combinations and variations of these and other compositional types of materials. Further, these structures, intermediates and end products can be cured (e.g., green cured, end cured, or hard cured), uncured, pyrolized to a ceramic, and combinations and variations of these (e.g., a cured material may be filled with pyrolized material derived from the same polysilocarb as the cured material).

The precursor formulations may be used to form a “neat” material, (by “neat” material it is meant that all, and essentially all of the structure is made from the precursor material or unfilled formulation; and thus, there are no fillers or reinforcements).

The polysilocarb precursor formulations may be used to coat or impregnate a woven or non-woven fabric, made from for example carbon fiber, glass fibers or fibers made from a polysilocarb precursor formulation (the same or different formulation), to from a prepreg material. Sand, or other small particulate like materials may be coated with a precursor material, and then the precursor material cured to a plastic like coating on the sand, or pyrolized to a ceramic coating on the sand. Further a polysilocarb bead could be similarly coated, or coated with another type of resin to provide various features to the bead. The reinforcing material may also be made from, or derived from the same material as the formulation that has been formed into a fiber and pyrolized into a ceramic, or it may be made from a different precursor formulation material, which has been formed into a fiber and pyrolized into a ceramic.

The polysilocarb precursor formulation may be used to form a filled material. A filled material would be any material having other solid, or semi-solid, materials added to the polysilocarb precursor formulation. The filler material may be selected to provide certain features to the cured product, the ceramic product and both. These features may relate to, or be, for example, aesthetic, tactile, thermal, density, radiation, chemical, cost, magnetic, electric, and combinations and variations of these and other features. These features may be in addition to strength. Thus, the filler material may not affect the strength of the cured or ceramic material, it may add strength, or could even reduce strength in some situations. The filler material could impart color, magnetic capabilities, fire resistances, flame retardance, heat resistance, electrical conductivity, anti-static, optical properties (e.g., reflectivity, refractivity and iridescence), aesthetic properties (such as stone like appearance in building products), chemical resistivity, corrosion resistance, wear resistance, reduced cost, abrasions resistance, thermal insulation, UV stability, UV protective, and other features that may be desirable, necessary, and both, in the end product or material. Thus, filler materials could include carbon black, copper lead wires, thermal conductive fillers, electrically conductive fillers, lead, optical fibers, ceramic colorants, pigments, oxides, sand, dyes, powders, ceramic fines, polymer derived ceramic particles, pore-formers, carbosilanes, silanes, silazanes, silicon carbide, carbosilazanes, siloxane, powders, ceramic powders, metals, metal complexes, carbon, tow, fibers, staple fibers, boron containing materials, milled fibers, glass, glass fiber, fiber glass, and nanostructures (including nanostructures of the forgoing) to name a few.

The polysilocarb formulation and products derived or made from that formulation may have metals and metal complexes. Filled materials would include reinforced materials. In many cases, cured, as well as pyrolized polysilocarb filled materials can be viewed as composite materials. Generally, under this view, the polysilocarb would constitute the bulk or matrix phase, (e.g., a continuous, or substantially continuous phase), and the filler would constitute the dispersed (e.g., non-continuous), phase. Depending upon the particular application, product or end use, the filler can be evenly distributed in the precursor formulation, unevenly distributed, distributed over a predetermined and controlled distribution gradient (such as from a predetermined rate of settling), and can have different amounts in different formulations, which can then be formed into a product having a predetermined amounts of filler in predetermined areas (e.g., striated layers having different filler concentration). It should be noted, however, that by referring to a material as “filled” or “reinforced” it does not imply that the majority (either by weight, volume, or both) of that material is the polysilcocarb. Thus, generally, the ratio (either weight or volume) of polysilocarb to filler material could be from about 0.1:99.9 to 99.9:0.1.

The polysilocarb precursor formulations may be used to form non-reinforced materials, which are materials that are made of primarily, essentially, and preferably only from the precursor materials; but may also include formulations having fillers or additives that do not impart strength.

The curing may be done at standard ambient temperature and pressure (“SATP”, 1 atmosphere, 25° C.), at temperatures above or below that temperature, at pressures above or below that pressure, and over varying time periods. The curing can be conducted over various heatings, rate of heating, and temperature profiles (e.g., hold times and temperatures, continuous temperature change, cycled temperature change, e.g., heating followed by maintaining, cooling, reheating, etc.). The time for the curing can be from a few seconds (e.g., less than about 1 second, less than 5 seconds), to less than a minute, to minutes, to hours, to days (or potentially longer). The curing may also be conducted in any type of surrounding environment, including for example, gas, liquid, air, water, surfactant containing liquid, inert atmospheres, N₂, Argon, flowing gas (e.g., sweep gas), static gas, reduced O₂, reduced pressure, elevated pressure, ambient pressure, controlled partial pressure and combinations and variations of these and other processing conditions. For high purity materials, the furnace, containers, handling equipment, atmosphere, and other components of the curing apparatus and process are clean, essentially free from, and do not contribute any elements or materials, that would be considered impurities or contaminants, to the cured material. In an embodiment, the curing environment, e.g., the furnace, the atmosphere, the container and combinations and variations of these can have materials that contribute to or effect, for example, the composition, catalysis, stoichiometry, features, performance and combinations and variations of these in the preform, the ceramic and the final applications or products.

Preferably, in embodiments of the curing process, the curing takes place at temperatures in the range of from about 5° C. or more, from about 20° C. to about 250° C., from about 20° C. to about 150° C., from about 75° C. to about 125° C., and from about 80° C. to 90° C. Although higher and lower temperatures and various heating profiles, (e.g., rate of temperature change over time (“ramp rate”, e.g., A degrees/time), hold times, and temperatures) can be utilized.

The cure conditions, e.g., temperature, time, ramp rate, may be dependent upon, and in some embodiments can be predetermined, in whole or in part, by the formulation to match, for example the size of the preform, the shape of the preform, or the mold holding the preform to prevent stress cracking, off gassing, or other phenomena associated with the curing process. Further, the curing conditions may be such as to take advantage of, preferably in a controlled manner, what may have previously been perceived as problems associated with the curing process. Thus, for example, off gassing may be used to create a foam material having either open or closed structure. Similarly, curing conditions can be used to create or control the microstructure and the nanostructure of the material. In general, the curing conditions can be used to affect, control or modify the kinetics and thermodynamics of the process, which can affect morphology, performance, features and functions, among other things.

Upon curing the polysilocarb precursor formulation a cross linking reaction takes place that provides in some embodiments a cross-linked structure having, among other things, an —R₁—Si—C—C—Si—O—Si—C—C—Si—R₂— where R₁ and R₂ vary depending upon, and are based upon, the precursors used in the formulation. In an embodiment of the cured materials they may have a cross-linked structure having 3-coordinated silicon centers to another silicon atom, being separated by fewer than 5 atoms between silicons.

During the curing process some formulations may exhibit an exotherm, i.e., a self heating reaction, that can produce a small amount of heat to assist or drive the curing reaction, or that may produce a large amount of heat that may need to be managed and removed in order to avoid problems, such as stress fractures. During the cure off gassing typically occurs and results in a loss of material, which loss is defined generally by the amount of material remaining, e.g., cure yield. Embodiments of the formulations, cure conditions, and polysilocarb precursor formulations of embodiments of the present inventions can have cure yields of at least about 90%, about 92%, about 100%. In fact, with air cures the materials may have cure yields above 100%, e.g., about 101-105%, as a result of oxygen being absorbed from the air. Additionally, during curing the material typically shrinks, this shrinkage may be, depending upon the formulation, cure conditions, and the nature of the preform shape, and whether the preform is reinforced, filled, neat or unreinforced, from about 20%, less than 20%, less than about 15%, less than about 5%, less than about 1%, less than about 0.5%, less than about 0.25% and smaller.

Curing of the preform may be accomplished by any type of heating apparatus, or mechanisms, techniques, or morphologies that has the requisite level of temperature and environmental control, for example, heated water baths, electric furnaces, microwaves, gas furnaces, furnaces, forced heated air, towers, spray drying, falling film reactors, fluidized bed reactors, lasers, indirect heating elements, direct heating, infrared heating, UV irradiation, RF furnace, in-situ during emulsification via high shear mixing, in-situ during emulsification via ultrasonication.

The cured preforms, either unreinforced, neat, filled or reinforced, may be used as a stand alone product, an end product, a final product, or a preliminary product for which later machining or processing may be performed on. The preforms may also be subject to pyrolysis, which converts the preform material into a ceramic.

In pyrolizing the preform, or cured structure, or cured material, it is heated to about 600° C. to about 2,300° C.; from about 650° C. to about 1,200° C., from about 800° C. to about 1300° C., from about 900° C. to about 1200° C. and from about 950° C. to 1150° C. At these temperatures typically all organic structures are either removed or combined with the inorganic constituents to form a ceramic. Typically at temperatures in the about 650° C. to 1,200° C. range the resulting material is an amorphous glassy ceramic. When heated above about 1,200° C. the material typically may from nano crystalline structures, or micro crystalline structures, such as SiC, Si3N₄, SiCN, β SiC, and above 1,900° C. an α SiC structure may form, and at and above 2,200° C. α SiC is typically formed. The pyrolized, e.g., ceramic materials can be single crystal, polycrystalline, amorphous, and combinations, variations and subgroups of these and other types of morphologies.

The pyrolysis may be conducted under many different heating and environmental conditions, which preferably include thermo control, kinetic control and combinations and variations of these, among other things. For example, the pyrolysis may have various heating ramp rates, heating cycles and environmental conditions. In some embodiments, the temperature may be raised, and held a predetermined temperature, to assist with known transitions (e.g., gassing, volatilization, molecular rearrangements, etc.) and then elevated to the next hold temperature corresponding to the next known transition. The pyrolysis may take place in reducing atmospheres, oxidative atmospheres, low O₂, gas rich (e.g., within or directly adjacent to a flame), inert, N₂, Argon, air, reduced pressure, ambient pressure, elevated pressure, flowing gas (e.g., sweep gas, having a flow rate for example of from about from about 15.0 GHSV to about 0.1 GHSV, from about 6.3 GHSV to about 3.1 GHSV, and at about 3.9 GHSV), static gas, and combinations and variations of these.

The pyrolysis is conducted over a time period that preferably results in the complete pyrolysis of the preform. For high purity materials, the furnace, containers, handling equipment, and other components of the pyrolysis apparatus are clean, essentially free from, free from and do not contribute any elements or materials, that would be considered impurities or contaminants, to the pyrolized material. A constant flow rate of “sweeping” gas can help purge the furnace during volatile generation. In an embodiment, the pyrolysis environment, e.g., the furnace, the atmosphere, the container and combinations and variations of these, can have materials that contribute to or effect, for example, the composition, stoichiometry, features, performance and combinations and variations of these in the ceramic and the final applications or products.

During pyrolysis material may be lost through off gassing. The amount of material remaining at the end of a pyrolysis step, or cycle, is referred to as char yield (or pyrolysis yield). The formulations and polysilocarb precursor formulations of embodiments of the present formulations can have char yields for SiOC formation of at least about 60%, about 70%, about 80%, and at least about 90%, at least about 91% and greater. In fact, with air pyrolysis the materials may have char yields well above 91%, which can approach 100%. In order to avoid the degradation of the material in an air pyrolysis (noting that typically pyrolysis is conducted in inert atmospheres, reduced oxygen atmosphere, essentially inert atmosphere, minimal oxygen atmospheres, and combinations and variations of these) specifically tailored formulations can be used. For example, formulations high in phenyl content (at least about 11%, and preferably at least about 20% by weight phenyls), formulations high in allyl content (at least about 15% to about 60%) can be used for air pyrolysis to mitigate the degradation of the material.

The initial or first pyrolysis step for SiOC formation, in some embodiments and for some uses, generally yields a structure that is not very dense, and for example, may not reached the density required for its intended use. However, in some examples, such as the use of lightweight spheres, proppants, pigments, and others, the first pyrolysis may be, and is typically sufficient. Thus, generally a reinfiltration process may be performed on the pyrolized material, to add in additional polysilocarb precursor formulation material, to fill in, or fill, the voids and spaces in the structure. This reinfiltrated material may then be cured and repyrolized. (In some embodiments, the reinfiltrated materials is cured, but not pyrolized.) This process of pyrolization, reinfiltration may be repeated, through one, two, three, and up to 10 or more times to obtain the desired density of the final product.

In some embodiments, upon pyrolization, graphenic, graphitic, amorphous carbon structures and combinations and variations of these are present in the Si—O—C ceramic. A distribution of silicon species, consisting of SiOxCy structures, which result in SiO4, SiO3C, SiO2C2, SiOC3, and SiC4 are formed in varying ratios, arising from the precursor choice and their processing history. Carbon is generally bound between neighboring carbons and/or to a Silicon atom. In general, in the ceramic state, carbon is largely not coordinated to an oxygen atom, thus oxygen is largely coordinated to silicon

The pyrolysis may be conducted in any heating apparatus that maintains the request temperature and environmental controls. Thus, for example pyrolysis may be done with gas fired furnaces, electric furnaces, direct heating, indirect heating, fluidized beds, kilns, tunnel kilns, box kilns, shuttle kilns, coking type apparatus, lasers, microwaves, induction, radiation, electrical dissipation, and combinations and variations of these and other heating apparatus and systems that can obtain the request temperatures for pyrolysis.

Custom and predetermined control of when chemical reactions, arrangements and rearrangements, occur in the various stages of the process from raw material to final end product can provide for reduced costs, increased process control, increased reliability, increased efficiency, enhanced product features, increased purity, and combinations and variation of these and other benefits. The sequencing of when these transformations take place can be based upon the processing or making of precursors, and the processing or making of precursor formulations; and may also be based upon cure and pyrolysis conditions. Further, the custom and predetermined selection of these steps, formulations and conditions, can provide enhanced product and processing features through the various transformations, e.g., chemical reactions; molecular arrangements and rearrangements; and microstructure arrangements and rearrangements.

At various points during the manufacturing process, the polymer derived ceramic structures, e.g., polysilocarb structures, intermediates and end products, and combinations and variations of these, may be machined, milled, molded, shaped, drilled, etched, or otherwise mechanically processed and shaped.

Starting materials, precursor formulations, polysilocarb precursor formulations, as well as, methods of formulating, making, forming, curing and pyrolizing, precursor materials to form polymer derived materials, structures and ceramics, are set forth in Published US Patent Applications, Publication Nos. 2015/0175750, 2015/0252171, 2014/0343220, 2014/0326453, and 2014/0274658, and U.S. patent application Ser. No. 15/002,773, 62/193,046, 62/279,543, 61/946,598, 62/055,397 and 62/106,094, the entire disclosures of each of which are incorporated herein by reference.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. The theories put forth in this specification, and unless expressly stated otherwise, in no way limit, restrict or narrow the scope of protection to be afforded the claimed inventions. These theories many not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

It is also noted that although the present specification focuses on small PDC volumetric shapes, to solve the long-standing need for methods and systems to obtain such articles, the systems, technologies and methods of the present specification can have application for larger shapes and structures. Thus, the scope of protection for the present inventions should not be limited to, and extend to and cover larger shapes and volumes, unless specially state otherwise.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and with existing equipment or activities which may be modified, in-part, based on the teachings of this specification. Further, the various embodiments set forth in this specification may be used with each other in different and various combinations. Thus, for example, the configurations provided in the various embodiments of this specification may be used with each other; and the scope of protection afforded the present inventions should not be limited to a particular embodiment, configuration or arrangement that is set forth in a particular embodiment, example, or in an embodiment in a particular figure.

The invention may be embodied in other forms than those specifically disclosed herein without departing from its spirit or essential characteristics. The described embodiments are to be considered in all respects only as illustrative and not restrictive.

What is claimed:

1. A hybrid fluid mechanical forming system for making small volumetric cured structures from a polymer derived ceramic precursor, the system comprising:
a. a polymer derived ceramic precursor delivery apparatus, the delivery apparatus comprising a delivery in-feed, the delivery in-fluid in fluid communication with a delivery port; wherein the delivery in-feed and the delivery port contain a liquid polymer derived ceramic precursor;
b. a formation head, the formation head comprising a die assembly and a forming chamber; the forming chamber defining a forming and curing cavity;
c. the die assembly comprising a channel and a nozzle; the channel defining a inlet opening and a forming opening; the inlet opening in fluid communication with the delivery port; the nozzle in fluid communication with the channel forming opening and the forming and curing cavity; the forming and curing cavity containing a forming fluid;
d. wherein the liquid polymer derived ceramic precursor is contained in the inlet opening, the die assembly channel, the forming opening, and the nozzle; and,
e. the forming fluid contacting liquid polymer derived ceramic and containing a volumetric shape of cured polymer derived ceramic precursor.

2. The system of claim 1, wherein the liquid precursor in the nozzle is partially cured.

3. The system of claim 1, wherein the die assembly comprises a plurality of channels and nozzles.

4. The system of claim 1, wherein the die assembly comprises at least 100 channels and nozzles.

5. The system of claim 1, wherein the forming fluid comprises water.

6. The system of claim 1, wherein the forming fluid essentially consist of water.

7. The systems of claims 1, 2, and 5, wherein the liquid polymer derived ceramic precursor comprises about 30 weight % to about 60 weight % silicon, from about 5 weight % to about 40 weight % oxygen, and from about 3 weight % to about 35 weight % carbon.

8. The systems of claims 1, 2, and 5, wherein the liquid polymer derived ceramic precursor comprises at least one precursor selected from the group consisting of methyl terminated vinyl polysiloxane, vinyl terminated vinyl polysiloxane, hydride terminated vinyl polysiloxane, vinyl terminated dimethyl polysiloxane, hydroxy terminated dimethyl polysiloxane, phenyl terminated dimethyl polysiloxane, methyl terminated phenylethyl polysiloxane, and tetravinyl cyclosiloxanes

9. The systems of claims 1, 2, and 5, wherein the liquid polymer derived ceramic precursor is a reaction type formulation, wherein the formulation comprises at least one precursor selected from the group consisting of Phenyltriethoxysilane, Phenylmethyldiethoxysilane, Methyldiethoxysilane, Vinylmethyldiethoxysilane, Trimethyethoxysilane Triethoxysilane, and TES 40.

10. The systems of claims 1, 2, and 5, wherein the liquid polymer derived ceramic precursor is a reaction blending type formulation, wherein the formulation comprises at least one precursor selected from the group consisting of methylhydrogen fluid and DCPD.

11. The systems of claims 1, 2, and 5, wherein the liquid polymer derived ceramic precursor is a reaction type formulation.

12. The systems of claims 1, 2, and 5, wherein the liquid polymer derived ceramic precursor is a mixing type formulation.

13. The systems of claims 1, 2, and 5, wherein the liquid polymer derived ceramic precursor is a reaction blending type formulation.

14. The system of claim 1, comprising a cutting assembly.

15. The system of claim 1, comprising a plurality of volumetric shapes of cured polymer derived ceramic precursor.

16. The system of claim 15, wherein the plurality of volumetric shapes are cured to at least 20% of a hard cure.

17. The system of claim 15, wherein the plurality of volumetric shapes are hard cured.

18. The system of claim 15, wherein the plurality of volumetric shapes are final cured.

19. The system of claim 14, comprising a planar die face, wherein the nozzle is positioned in and opens through the die face; wherein the cutter assembly comprises a plurality of cutter blades and a cutter force control unit, whereby the location of the cutters with respect to the die face can be predetermined and controlled.

20. The system of claim 19, wherein the plurality of volumetric shapes are cured to at least 20% of a hard cure.

21. The system of claim 19, wherein the plurality of volumetric shapes are hard cured.

22. The system of claim 19, wherein the plurality of volumetric shapes are final cured.

23. The system of claim 19, wherein the liquid polymer derived ceramic precursor is a reaction blending type formulation, wherein the formulation comprises at least one precursor selected from the group consisting of methylhydrogen fluid and DCPD.

24. The system of claim 19, wherein the liquid polymer derived ceramic precursor is a reaction type formulation.

25. The system of claim 19, wherein the liquid polymer derived ceramic precursor is a mixing type formulation.

26. The system of claim 19, wherein the liquid polymer derived ceramic precursor is a reaction blending type formulation.

27. A hybrid fluid mechanical forming system for making small volumetric cured structures from a polymer derived ceramic precursor, the system comprising:
a. a polymer derived ceramic precursor delivery apparatus, the delivery apparatus comprising a delivery in-feed, the delivery in-fluid in fluid communication with a delivery port; wherein the delivery in-feed and the delivery port contain a liquid polymer derived ceramic precursor; the liquid polymer derived ceramic has a first viscosity;
b. a formation head, the formation head comprising a die assembly and a forming chamber; the forming chamber defining a forming and curing cavity;
c. the die assembly comprising a channel and a nozzle; the channel defining a inlet opening and a forming opening; the inlet opening in fluid communication with the delivery port; the nozzle in fluid communication with the channel forming opening and the forming and curing cavity; the forming and curing cavity containing a forming fluid;
d. wherein the liquid polymer derived ceramic precursor is contained in the inlet opening, the die assembly channel, the forming opening, and the nozzle; wherein the liquid polymer derived ceramic precursor in the die assembly channel has a second viscosity; and,
e. the forming fluid contacting an extending portion of the liquid polymer derived ceramic precursor extending from and continuous with the liquid polymer derived ceramic in the nozzle; and the forming fluid containing a volumetric shape of cured polymer derived ceramic precursor; whereby the extending portion of the liquid polymer derived ceramic precursor has a third viscosity.

28. The system of claim 27, wherein, the third viscosity is greater than the second viscosity.

29. The system of claim 27, wherein the second viscosity is greater than the first viscosity.

30. The system of claim 28, wherein the second viscosity is greater than the first viscosity.

31. The system of claim 27, wherein the liquid polymer derived ceramic precursor comprises a catalyst.

32. The system of claim 28, wherein the liquid polymer derived ceramic precursor comprises a catalyst.

33. The system of claim 30, wherein the liquid polymer derived ceramic precursor comprises a catalyst.

34. The system of claim 30, wherein the liquid polymer derived ceramic precursor is selected from the group consisting of a reaction type formulation, a mixing type formulation, and a reaction blending type formulation.

35. A hybrid fluid mechanical forming system for making small volumetric cured structures from a polymer derived ceramic precursor, the system comprising:
a. a delivery apparatus, the delivery apparatus comprising a liquid polymer derived ceramic precursor, wherein the liquid polymer derived ceramic precursor consists essentially of carbon, silicon and;
b. a die assembly and a curing chamber; the curing chamber defining a curing cavity;
c. the die assembly comprising a channel and a nozzle; the channel defining a inlet opening and a outlet opening; the inlet opening in fluid communication with the delivery apparatus; the nozzle in fluid communication with the outlet opening and the curing cavity; the curing cavity containing a curing fluid;
d. wherein the liquid polymer derived ceramic precursor is contained in the inlet opening, the die assembly channel, the outlet opening, and the nozzle; and,
e. the forming fluid contacting an extending portion of the liquid polymer derived ceramic precursor extending from and continuous with the liquid polymer derived ceramic in the nozzle; and the forming fluid containing a volumetric shape of cured polymer derived ceramic precursor.

36. The systems of claims 1, 27 and 35, wherein the volumetric shape is selected from the group consisting of hollow spheres, blocks, sheets, coatings, balls, and squares.

37. The systems of claims 1, 27 and 35, wherein the volumetric shape is selected from the group consisting of spheres, prolate spheroids, ellipsoids, spheroids, films, skins, and particulates.

38. The systems of claims 1, 27 and 35, wherein the volumetric shape is a proppant.

39. The systems of claims 1, 27 and 35, wherein the volumetric shape is a fiber.

40. A fiber forming system for making fibers from a polymer derived ceramic precursor, the system comprising:
a. a polymer derived ceramic delivery apparatus, the apparatus comprising a liquid polymer derived ceramic precursor, a chamber and a port, wherein the chamber is capable of holding a liquid polymer derived ceramic precursor for delivery by the port into fiber having a predetermined diameter;
b. a precursor solidifying apparatus, the solidifying apparatus comprising: a cavity; a temperature control apparatus; wherein the cavity is maintained at a predetermined temperature sufficient to cure the polymer derived ceramic precursor fiber to form a preform;
c. the cavity have sufficient depth that the fibers break into sections; and,
d. the port in fluid communication with the cavity;
e. whereby, the system is capable of forming and curing the liquid polymer derived ceramic precursor into fibers.

41. An under liquid extrusion system for making elongate volumetric structures from a polymer derived ceramic precursor material, the system comprising:
a. a polymer derived ceramic delivery apparatus, the apparatus comprising a first chamber in fluid communication with a delivery port, and an amount of a liquid polymer derived ceramic precursor;
b. a forming and curing apparatus, the forming and curing apparatus comprising a forming chamber having an opening; and the chamber defining a cavity, wherein the cavity is in fluid communication with the chamber opening and contains an elongate volumetric shape of a polymer derived ceramic precursor, the chamber comprising water;
c. the chamber opening in fluid communication with the delivery port;
d. a temperature control source thermally associated with the forming apparatus; wherein the cavity is maintained at a predetermined temperature sufficient to cure the elongate volumetric shape of the polymer derived ceramic precursor; and,
e. whereby, the system is capable of providing a liquid polymer derived ceramic precursor material into the cavity in a predetermined elongate volumetric shape, and wherein the polymer derived ceramic precursor material is cured in the cavity.

42. A hybrid fluid mechanical forming system for making small volumetric structures from a polymer derived ceramic precursor, the system comprising:
a. a polymer derived ceramic precursor delivery apparatus, the apparatus comprising a chamber in fluid communication with a delivery port; wherein the chamber is capable of delivering a liquid polymer derived ceramic precursor;
b. a forming apparatus, the forming apparatus comprising a forming chamber having an opening; the chamber defining a cavity; wherein the cavity is in fluid communication with the chamber opening;
c. the chamber opening in fluid communication with the delivery port; whereby the system is capable of delivering the liquid polymer derived ceramic from the delivery port to the cavity as a liquid;
d. a temperature control apparatus thermally associated with the forming apparatus; wherein the cavity is capable of being maintained at a predetermined temperature;
e. a die assembly;
f. a cutter assembly; and,
g. whereby, the system is capable of providing a liquid polymer derived ceramic precursor to the cavity in a predetermined volumetric shape; and wherein the system is capable of curing the polymer derived ceramic precursor in the cavity.

43. A system for making small volumetric structures from a polymer derived ceramic precursor, the system comprising:
a. a liquid holding receptacle;
b. the liquid holding receptacle containing a forming liquid;
c. a precursor delivery apparatus, comprising a precursor, a channel, and a delivery port, the channel in fluid communication with the delivery port, whereby the precursor can be delivered from the delivery port; and,
d. the delivery port in fluid communication with the liquid holding receptacle.

44. A method for making small volumetric structures from a polymer derived ceramic precursor, the method comprising:
a. providing a liquid polymer derived ceramic precursor to a delivery apparatus, the apparatus comprising a chamber in fluid communication with a delivery port;
b. forming the liquid precursor into a predetermined liquid volumetric shape; and delivering the liquid volumetric shape to a chamber defining a cavity, the cavity comprising a forming fluid; and,
c. curing the liquid volumetric shape in the cavity to form a polymer derived ceramic preform.

45. The method of claim 44, wherein the preform is the same shape as the volumetric shape.

46. The method of claim 44, wherein the preform is substantially the same shape as the volumetric shape.

47. The method of claim 44, wherein the preform is green cured.

48. The method of claim 44, wherein the preform is hard cured.

49. The method of claim 44, wherein the preform is final cured.

50. The method of claim 44, comprising pyrolizing the preform to form a ceramic.

51. A method for making small volumetric structures from a polymer derived ceramic precursor, the method comprising:
a. a step for forming a small volumetric shaped structure of polymer derived ceramic precursor by extrusion from a die face into a forming fluid;
b. a step for cutting the polymer derived ceramic precursor at the die face to thereby form an initial shaped volumetric structure; and,
c. a step for curing the initial shaped volumetric structure.

52. The method of claim 51, wherein the die face is in the forming fluid; whereby the extrusion is directly into the forming fluid, without exposure to air.

53. The method of claim 51, wherein a plurality of initial shapes are made.

54. The method of claim 51, wherein the initial shaped volumetric structure is hard cured.

55. The method of claim 51, wherein the initial shaped volumetric structure is green cured.

56. The method of claim 51, wherein the forming fluid is water.

57. The method of claim 51, wherein the forming fluid comprises water.

58. The method of claim 51, wherein the cured initial shaped volumetric structure is selected from the group consisting of hollow spheres, blocks, sheets, coatings, balls, and squares.

59. The method of claim 51, wherein the cured initial shaped volumetric structure is selected from the group consisting of rods, staple fibers, spheres, and ribbons.

60. The method of claim 51, comprising pyrolizing the cured initial shaped volumetric structure.

61. A method for making small volumetric structures from a polymer derived ceramic precursor, the method comprising:
a. a step for forming an elongate volumetric shaped structure of polymer derived ceramic precursor by extrusion from a die face into a forming fluid;
b. a step for curing the elongate structure; and,
c. a step for sectioning the cured elongate structure.

62. The method of claim 61, wherein the section occurs by the weight of the elongate structure causing breakage.

63. The method of claim 44, wherein the volumetric shape has a volume of less than about 0.25 inch³.

64. The method of claim 51, wherein the volumetric shape has a volume of less than about 500 mm³.

65. The method of claim 44, wherein the volumetric shape has a volume of less than about 100 mm³.

66. The method of claim 51, wherein the volumetric shape has a volume of less than about 4,000 microns³.

67. The method of claim 44, wherein the volumetric shape has a volume of less than about 50 microns³.

68. The method of claim 51, wherein the volumetric shape has a volume of less than about 10 microns³.

69. The system of claim 1, wherein the volumetric shape has a volume of less than about 0.25 inch³.

70. The system of claim 35, wherein the volumetric shape has a volume of less than about 500 mm³.

71. The system of claim 43, wherein the volumetric shape has a volume of less than about 100 mm³.

72. The system of claim 1, wherein the volumetric shape has a volume of less than about 4,000 microns³.

73. The system of claim 35, wherein the volumetric shape has a volume of less than about 50 microns³.

74. The system of claim 43, wherein the volumetric shape has a volume of less than about 10 microns³.

75. An underwater pelletizing system for making volumetric structures from a polymer derived ceramic precursor, the system comprising:
a. a polymer derived ceramic delivery apparatus, the apparatus comprising a liquid polymer derived ceramic precursor, a chamber and a port, wherein the chamber is capable of holding a liquid polymer derived ceramic precursor for delivery by the port into a volumetric shape having a predetermined volume;
b. a precursor solidifying apparatus, the solidifying apparatus comprising: a cavity; a temperature control apparatus; wherein the cavity is maintained at a predetermined temperature sufficient to cure the volumetric shape of polymer derived ceramic precursor to form a preform;
c. a forming and cutting head having a fluid cavity; and
d. the port in fluid communication with the cavity;
e. whereby, the system is capable of forming and curing the liquid polymer derived ceramic precursor into a predetermined volumetric shape structure.

76. An underwater extrusion system for making volumetric structures from a polymer derived ceramic precursor material, the system comprising:
a. a polymer derived ceramic delivery apparatus, the apparatus comprising a first chamber in fluid communication with a delivery port, and an amount of a liquid polymer derived ceramic precursor;
b. a forming and curing apparatus, the forming and curing apparatus comprising a forming chamber having an opening; and the chamber defining a cavity, wherein the cavity is in fluid communication with the chamber opening and contains a volumetric shape of a polymer derived ceramic precursor, the chamber comprising flowing water;
c. the chamber opening in fluid communication with the delivery port;
d. a temperature control source thermally associated with the forming apparatus; wherein the cavity is maintained at a predetermined temperature sufficient to cure the volumetric shape of the polymer derived ceramic precursor; and,
e. whereby, the system is capable of providing a liquid polymer derived ceramic precursor material into the cavity in a predetermined volumetric shape, and wherein the polymer derived ceramic precursor material is cured in the cavity.

77. The system of claim 76, wherein the liquid polymer derived ceramic precursor is selected from the group consisting of silanes, polysilanes, silazanes, polysilazanes, carbosilanes, polycarbosilanes, siloxanes, and polysiloxanes.

78. The system of claim 76, wherein the liquid polymer derived ceramic precursor is a polysilocarb.

79. The system of claim 76, wherein the liquid polymer derived ceramic precursor is a neat polysilocarb.

80. The system of claim 76, wherein the liquid polymer derived ceramic precursor comprises a polysilocarb and contains hydride groups.

81. The system of claim 76, wherein the liquid polymer derived ceramic precursor comprises a polysilocarb, is solvent free, and contains hydride groups.

82. The system of claim 76, wherein the liquid polymer derived ceramic precursor comprises a polysilocarb and contains vinyl groups.

83. The system of claim 76, wherein the liquid polymer derived ceramic precursor comprises a polysilocarb having hydride and vinyl groups and wherein the molar ratio of hydride groups to vinyl groups is about 1.50 to 1.

84. A system for making small volumetric structures from a polymer derived ceramic precursor, the system comprising:
a. a polymer derived ceramic delivery apparatus, the apparatus comprising a first chamber in fluid communication with a delivery port; wherein the first chamber is capable of holding a liquid polymer derived ceramic precursor;
b. a means for forming a volumetric shaped structure, the forming means comprising a forming chamber having an opening; and the chamber defining a cavity, wherein the cavity is in fluid communication with the chamber opening;
c. the chamber opening in fluid communication with the delivery port, whereby the system is capable of delivering the liquid polymer derived ceramic from the delivery port into the cavity, as a liquid;
d. a temperature control source thermally associated with the forming apparatus, wherein the cavity is maintained at a predetermined temperature; and,
e. whereby, the system is capable of providing a liquid polymer derived ceramic precursor material into the cavity in a predetermined volumetric shape, and wherein the polymer derived ceramic precursor material is cured in the cavity.

85. A system for making small volumetric structures from a polymer derived ceramic precursor, the system comprising:
a. a means for delivering a liquid polymer derived ceramic;
b. a means for forming a volumetric shaped structure, the forming means comprising a forming chamber having an opening; and the chamber defining a cavity, wherein the cavity is in fluid communication with the chamber opening;
c. the chamber opening in fluid communication with the delivery port, whereby the system is capable of delivering the liquid polymer derived ceramic from the delivery port into the cavity, as a liquid;
d. a temperature control source thermally associated with the forming apparatus, wherein the cavity is maintained at a predetermined temperature; and,
e. whereby, the system is capable of providing a liquid polymer derived ceramic precursor material into the cavity in a predetermined volumetric shape, and wherein the polymer derived ceramic precursor material is cured in the cavity.

86. A system for making small volumetric structures from a polymer derived ceramic precursor, the system comprising:
a. a means for forming a small volumetric shaped structure of polymer derived ceramic precursor; and,
b. a means for curing the small volumetric shaped structure of polymer derived ceramic precursor material into a volumetric shaped preform.

87. A system for making small volumetric structures from a polymer derived ceramic precursor, the system comprising:
a. a means for forming a small volumetric shaped structure of polymer derived ceramic precursor;
b. a means for curing the small volumetric shaped structure of polymer derived ceramic precursor material into a volumetric shaped preform; and,
c. a means for pyrolizing the preform.

88. A system for making small volumetric structures from a polymer derived ceramic precursor, the system comprising:
a. a liquid holding receptacle;
b. the liquid holding receptacle containing a forming liquid;
c. a precursor delivery apparatus, comprising a precursor, a channel, and a delivery port, the channel in fluid communication with the delivery port, whereby the precursor can be delivered from the delivery port; and,
d. the delivery port in fluid communication with the liquid holding receptacle.

89. A method for making small volumetric structures from a polymer derived ceramic precursor, the method comprising:
a. providing a liquid polymer derived ceramic precursor to a delivery apparatus, the apparatus comprising a chamber in fluid communication with a delivery port;
b. forming the liquid precursor into a predetermined liquid volumetric shape; and delivering the liquid volumetric shape to a chamber defining a cavity; and,
c. curing the liquid volumetric shape in the cavity to form a polymer derived ceramic preform.

90. A method for making small volumetric structures from a polymer derived ceramic precursor, the system comprising:
a. a step for forming a liquid polymer derived ceramic to a liquid predetermined volumetric shape; and,
b. a step for curing the liquid predetermined volumetric shape into a preform having essentially the same volumetric shape.

91. A method for making small volumetric structures from a polymer derived ceramic precursor, the system comprising:
a. a step for forming a small volumetric shaped structure of polymer derived ceramic precursor by extrusion into a water bath and then cutting the extruded member into an initial shape;
b. a step for curing the small volumetric shaped structure of polymer derived ceramic precursor material in a flowing channel in a die to form an initial volumetric shaped preform;
c. cutting the initial volumetric shaped preform from the die face;
d. further curing and shaping the preform in a water bath; and,
e. a step for pyrolizing the preform.

92. A method for making small volumetric structures from a polymer derived ceramic precursor, the system comprising:
a. forming a neat small volumetric shaped structure of polymer derived ceramic precursor;
b. curing the neat small volumetric shaped structure of polymer derived ceramic precursor material into a volumetric shaped preform; and,
c. pyrolizing the preform.

93. A method for making small volumetric structures from a polymer derived ceramic precursor, the system comprising:
a. providing a polymer derived ceramic precursor to a liquid holding receptacle;
b. the liquid holding receptacle containing a forming liquid;
c. the precursor forming essentially upon contact with the forming liquid a predetermined volumetric shape; and,
d. curing the volumetric shape to form a preform.

94. The method of claim 93, wherein the volumetric shape is a bead.

95. The method of claim 93, comprising pyrolizing the preform.

96. The method of claim 93, wherein the volumetric shape is a sphere and comprising pyrolizing the sphere.

97. A method for making small volumetric shaped polysilocarb preform, the method comprising initially curing a polysilocarb formulation as it is flowing through a chancel in a die; the initially cured preform being extruded into a liquid bath, the extruded preform being cut off adjacent to the die face, and the liquid bath continuing to cure the preform.

98. The method of claim 97, wherein the liquid bath shapes the preform.

99. The system of claim 5, wherein the forming fluid comprises a surfactant.

100. The system of claim 27, wherein the forming fluid comprises a surfactant.

101. The system of claim 43, wherein the forming liquid comprises a surfactant.

102. The method of claim 51, wherein the forming fluid comprises a surfactant.

103. The method of claim 61, wherein the forming fluid comprises a surfactant.
